(19) United States
(12) Patent Application Publication
(10) Pub. No.: US 2011/0149849 A1
(43) Pub. Date: Jun. 23, 2011

(54) WIRELESS BLACK BOX COMMUNICATION SYSTEMS AND METHODS

(76) Inventor: EDWIN BROWNRIG, Roseville, CA (US)

(21) Appl. No.: 12/909,008

(22) Filed: Oct. 21, 2010

Related U.S. Application Data
(63) Continuation-in-part of application No. 11/300,902, filed on Dec. 15, 2005.
Application No. 11/300,902 is a continuation of application No. 10/386,159, filed on Mar. 10, 2003, now Pat. No. 7,054,271.
Application No. 10/386,159 is a continuation of application No. 09/492,933, filed on Jan. 27, 2000, now abandoned.
Application No. 09/492,933 is a continuation of application No. 08/760,895, filed on Dec. 6, 1996, now Pat. No. 6,044,062.

(51) Int. Cl. H04W 4/00

(52) U.S. Cl. 370/328

(57) ABSTRACT

Embodiments of the present invention provide wireless black box communication systems and methods. According to some embodiments, a wireless black-box flight recorder network system can generally comprise an earth-station server and a plurality of aircraft based clients. The earth-station server can be configured to transmit and receive wireless data messages. The earth-station server can be coupled to or comprise a storage medium for storing data recorded about an aircraft. The plurality of aircraft based clients can each comprise a device to receive aircraft data. The clients can also each comprise a client controller configured to implement a client process. The client process of at least one of the aircraft based client can select a transmission path to the earth-station server that is an indirect link to the earth-station server through at least one of the other aircraft based clients. The indirect link can be used to transmit aircraft data to the earth-station server for storing said data in the storage medium. Other aspects, embodiments, and features are also claimed and described.

### CROSS REFERENCE TO RELATED APPLICATIONS & PRIORITY CLAIMS

This application is a continuation-in-part of U.S. patent application Ser. No. 11/300,902, filed 15 Dec. 2005, which is a continuation of U.S. patent application Ser. No. ______, filed 10 Mar. 2003, now U.S. Pat. No. 7,054,271, which is a continuation of U.S. patent application Ser. No. 09/492,933, filed 27 Jan. 2000, now abandoned, which is a continuation of U.S. patent application Ser. No. 08/760,895, filed 6 Dec. 1996, now U.S. Pat. No. 6,044,062.

This patent application also claims priority to and the benefit of U.S. Provisional Application No. 61/254,334, filed 23 Oct. 2009, and entitled Wireless Black Boxes.

All of the patent applications mentioned in this application are incorporated herein by reference as if fully set forth below in their entireties.

### TECHNICAL FIELD

Embodiments of the present invention relate generally to communication technologies and networks, and more particularly to, wireless black box communication systems and methods. Embodiments of the present invention enable and provide enhanced black box data retrieval, air-to-ground communications, and air-to-air communications.

### BACKGROUND

Flight data recorders (FDR or FDRs) are designed to record operating data of planes while in flight. Planes have many systems (e.g., power, communication, operations, etc.) that are used to operate planes during flight. These systems usually incorporate many sensors that are wired from various areas of planes to a flight-data acquisition unit, which is wired to the FDR. When events occur (e.g., switches flipped, flight operation events, power issues, pilot communications, etc.), data regarding the events is recorded/stored by the FDR. The recorded flight data enables users to access the data to assess and study plane operational status.

In the United States, the Federal Aviation Administration (FAA) requires commercial airlines record a minimum of 11 to 29 parameters, depending on the size of the aircraft. Magnetic-tape recorders have the potential to record up to 100 parameters. Solid-state recorders can track more parameters than magnetic tape because they allow for a faster data flow. Solid-state FDRs can store up to 25 hours of flight data. Each additional parameter that is recorded by the FDR gives investigators one more clue about the cause of an accident.

In many commercial aircrafts, there are several microphones disposed in cockpits to track flight crew conversations. These microphones are also designed to track any ambient noise in the cockpit, such as switches being thrown or any knocks or thuds. There may be up to four microphones in the plane's cockpit, each connected to a cockpit voice recorder (CVR).

Sounds in the cockpit are picked up by these microphones and sent to the CVR, where the recordings are digitized and stored. There is sometimes also another device in the cockpit, called an “associated control unit” that provides pre-amplification for audio going to the CVR. Sample positions of microphones include pilot's headset, co-pilot's headset, headset of a third crew member (if there is a third crew member), and clear the center of the cockpit, where it can pick up audio alerts and other sounds. In some instances, the CVR may be integrated with the DVR into a single data storage unit.

Most magnetic tape CVRs store the last 30 minutes of sound. They use continuous loop of tape that completes a cycle every 30 minutes. As new material is recorded, the oldest material is replaced (aka a LIFO operation). CVRs that used solid-state storage can record two hours of audio. Similar to the magnetic tape recorders solid-state recorders also record over old material.

On Jul. 17, 1997, the FAA issued a Code of Federal Regulations that requires the recording of at least 88 parameters on aircraft manufactured after Aug. 19, 2002. Sample monitored parameters can include time, pressure altitude, airspeed, vertical acceleration, magnetic heading, control-column position, rudder-pedal position, control-wheel position, horizontal stabilizer position, and fuel flow.

When tragedy occurs and planes crash, investigators seek out the DVR and CVR data storage units (sometimes generally called the “Black Box”). By analyzing recorded data, investigators seek to learn actions surrounding a tragic plane crash as well as operations of the crew in the moments leading up the tragedy. Sometimes, plane crashes are so tragic that Black Box storage devices do not survive. In the recent Air France Flight 447 tragedy, the plane crashed into the Atlantic Ocean. Given the tragic wreckage and crash location, investigators can not locate the Black Box units. Without this data, investigators can not determine potential causes of the tragedy. To this day, Air France Flight 447's Black Box units rest on the floor of the Atlantic Ocean demonstrating that retrieval of Black Box data needs improvement.

### BRIEF SUMMARY OF EXEMPLARY EMBODIMENTS

In the following description, certain aspects and embodiments will become evident. It should be understood that the aspects and embodiments, in their broadest sense, could be practiced without having one or more features of these aspects and embodiments. It should be understood that these aspects and embodiments are merely exemplary.

Embodiments of the present invention are directed to wireless black box communication systems and methods. Embodiments enable and provide communication systems enable data recorded on a plane's black box to be wirelessly communicated through one or more transceivers. Doing so not only enables communication of flight data in real time arrangements, it also enables sharing of recorded data to take place during flights. In situations where data recorded in a black box can not be accesses, wireless communication of recorded data enables interested parties to receive data recorded during flight.

Broadly speaking, some embodiments include a wireless network system that generally comprises an earth-station server (sometimes denoted as “ESS”) and mobile, airborne communication nodes. The ESS can be configured to receive and transmit data packets to one or more of a plurality of mobile, airborne communication nodes. The plurality of mobile, airborne communication nodes can comprise a first airborne client and a second airborne client. At least one processor can be associated with at least one of the earth-station server, the first airborne client, the second airborne client, and the earth-station server. The at least one processor can be configured to establish one or more temporary communication routes between the first airborne client, the second airborne client, and the earth-station server. As positions of the first airborne client and/or the second airborne client change, the processor and or the ESS can establish other temporary communication routes between the first airborne client, the second airborne client, and the earth-station server.

Embodiments of the present invention can also include additional features. For example, the at least one processor can be configured to determine a first alternative route via the plurality of satellite clients by exchanging in-memory routing tree link information. The at least one processor can be configured to maintain a table of alternate routes comprising at least one newly discovered route. The at least one processor can be configured to analyze at least one of the data packets to determine if the at least one data packet has been sent on a second alternative route unknown to a respective one of the first airborne client, the second airborne client, and the earth-station server. The at least one processor can configured to count a number of hops between a source node associated with the at least one data packet and a respective one of the first airborne client, the second airborne client, and the earth-station server. The at least one processor can configured to sort the table of alternate routes and replace the first alternative route with the second alternative route when a respective one of the first airborne client, the second airborne client, and the earth-station server loses the first alternative route. In some embodiments, the first airborne client and the second airborne client can be airplanes.

Embodiments of the present invention can also include a wireless black-box flight recorder network system. Such a system can generally comprise an ESS and aircraft based clients. An ESS can be configured to transmit and receive wireless data messages, the earth-station server coupled to a storage medium for storing data recorded about an aircraft. The aircraft based clients can each comprise a device to receive aircraft data. The aircraft based clients can also each comprise a client controller configured to implement a client process. The client process of at least one of the aircraft based clients can select a transmission path to the earth-station server that is a direct and/or indirect link to the earth-station server through at least one of the other aircraft based clients. The link can be used to transmit aircraft data to the earth-station server for storing said data in the storage medium. The link can also be used to transmit data or instructions to the aircraft based clients (e.g., flying instructions can be transmitted to a plane for flying the plane in a drone condition due to errant plane operations, crew issues, and/or a plane hijack).

Embodiments of the present invention can also include additional features. For example, an earth-station server comprises a digital controller configured to maintain a map of data packet transmission paths of the plurality of aircraft based clients. Aircraft-based clients and/or an ESS can be configured to perform wireless transmission of data using at least one of WiMAX, 4G, CMDA, and many other communication protocols. A client controller can be associated with at least one of the aircraft-based clients. Client controllers can serve as an in-flight router configured to route data messages to the earth-station server and other of the aircraft-based clients.

Other embodiments of the present invention can include a wireless network system for serving as a system to transmit, receive, and store data associated with aircraft client including data recorded on airplanes indicative of airplane performance and operation. Such wireless network systems can include an ESS and mobile airborne nodes. An ESS can comprise a first node controller and a first node transceiver. A first node controller can implement a first node process. A first node process can include controlling said first node transceiver, and may include receiving and transmitting data packets via said first node radio transceiver. A plurality of mobile-airborne-second nodes can each include a second node controller and a second node radio transceiver. A second node controller can implement a second node process, and may include controlling of said second node radio transceiver. A second node process may include receiving and transmitting data packets via said second node radio transceiver. A second node process of each of said second nodes can include selecting a data transmission path to said earth station server that is direct or through at least one of the remainder of said plurality of mobile-airborne-second nodes. A selected path to said ESS may utilize a least number of other mobile-airborne-second nodes. This may enable the transmission path from each of said mobile-airborne-second nodes to said earth station server to be optimized. The first node controller can approve changes to the selected transmission path.

Embodiments of the present invention can still yet include additional features. Mobile-airborne-second nodes can be disposed within an airplane and comprise a data device configured to receive data about airplane performance and operation and provide the data to the second node radio transceiver. Mobile-airborne-second nodes, when implementing a second node process, can continue to determine whether the mobile-airborne-second node is airborne. An ESS can be located proximate a body of water and comprise a plurality of data servers for storing data or information about a plurality of planes.

Some embodiments of the present invention can be a wireless network system for serving as a system to transmit, receive, and store data associated with aircraft client including data recorded on airplanes indicative of airplane performance and operation. Such a wireless network system can comprise a first server node and one or more second nodes. A first server node can include a first node controller and a first node radio modem. A first node controller can implement a first node process that includes controlling of said first node radio modem, said first node process including receiving and transmitting data packets via said first node radio modem. One or more second nodes can each include a second node controller. Second node controllers can implement a second node process. The second node process can include controlling a second node radio modem. The second node process can also include receiving and transmitting data packets via said second node radio modem. Said second node process of each of said second nodes can also include initiating a radio transmission path to said first node that is a link to said first node through at least one of the remainder of said plurality of second nodes. The first node process can dynamically update a second node link tree. The second node link tree can comprise second node link entries and dynamically modify the second node link tree so that the data packet transmission from the first node is optimized.

Embodiments of the present invention can include additional features. For example, at least one of the second nodes is an airplane communication device and a first node process can comprise logic for comparing a selected link from one of the plurality of said second nodes to said first node to a current second node link entry in said second node link tree; and/or logic for dynamically updating said second node link tree when said comparison meets predetermined conditions. A first node process can also include one or more of logic for determining if one of the plurality of said second nodes is authentic; logic for determining if one of the plurality of said second nodes is already in said second node link tree if one of the plurality of said second nodes is determined to be authentic; and logic for inserting one of the plurality of said second nodes in said second node link tree if one of the plurality of said second nodes is authentic and is not already in said second node link tree.

Embodiments of the present invention can also include a method for receiving and/or recording data about a plurality of airplanes to ensure that airplane operation and performance data is maintained. A method can generally comprise providing an earth-station server node implementing a first node process including receiving and sending data packets via RF transmissions and providing a plurality of second airborne-based nodes. One or more second airborne-based nodes can providing a second node process including sending and receiving data packet via RF transmission, maintaining a send/receive data buffer in digital memory, and selecting a transmission path to said first node that is one of a direct link to said first node and an indirect link to said first node through at least one of the remainder of said plurality of second airborne-based nodes based upon path data determined through a pooning process. Method embodiments can also include maintaining a second node link tree having second node link entries at one of the earth-station server node or second airborne-based node.

Embodiments of the present invention can include still yet additional features. A first node process can be configured to compare a selected link from one of the plurality of said second airborne-based nodes to said earth-station server node to a second node link entry in said second node link tree; and dynamically update said second node link tree when said comparison meets at least one of several predetermined conditions. A method can also include a first node process that determine if one of the plurality of said second airborne-based nodes is authentic; and delete one of the plurality of said second airborne-based nodes from said second node link tree if one of the plurality of said second airborne-based nodes is already in said second node link tree. A method can also include inserting one of the plurality of said second airborne-based nodes in said second node tree if said second node is authentic. In addition, an ESS node can act as a server node and/or a gateway to transmit and receive data messages to another network enabling airplane operation and performance data to be transmitted or received via said another network.

Embodiments of the present invention can be an airplane-client node in a network. The network can include an ESS node having a server radio modem and a server controller. The server controller can implement a server process that includes controlling the server node to receive and transmit data packets via said server node to other nodes in the network. The airplane-client node can comprise a client node radio modem and a client node controller. The client node controller can implement a process that include receiving and transmitting data packets via said client modem. The airplane-client node can select a radio transmission path to said server node that is one of a direct link to said server node and an direct/indirect link to said server node through at least one other client node. The airplane-client node can implement a process to update said radio transmission path in response to transmission path data and authorization to update the path received from said server node. Transmission path can include one or more of data identifying: a path to said server node through the minimum number of client nodes; a path to the server node through the most robust additional client nodes; a path to the server node through the client node with the least amount of traffic; and a path to the server node through the fastest client nodes. An airplane-client node can also comprise components to receive data about an airplane's operation and performance. Components can be coupled to the client node controller to enable the client node radio modem to transmit airplane related data to an intended recipient. An airplane-client node can also be interfaced with a planes operational controls enabling remote control of an airplane if desired.

Embodiments of the present invention can also be configured and equipped to stream data packets for air-to-ground data streaming. Doing so enables an additional precaution of backing up flight data on the ground that can help investigators reconstruct what happened if an in-flight recorder is lost or destroyed. Also, a robust data link would also mean a lot more information than just black-box data could flow, and it could flow both ways. As it is now, aircraft, particularly when flying over oceans, are often incommunicado for long periods. Embodiments of the invention also have clear benefits, including an ability to cope with emergencies. If air-traffic controllers clearing aircraft for takeoff could glean pilot intent from incoming data, for example, they could reduce runway incursions, a leading cause of aircraft mishaps. During a technical emergency, pilots could get critical advice from engineers and other experts on the ground, who would have real-time knowledge of that plane's engine conditions, flight-control positions, and other essential data at their fingertips. During a hijacking, air controllers, government authorities, and other key personnel could make more effective decisions—even warn possible targets. Moreover, during a hijacking, ground personnel could take over control of the aircraft and fly it as a drone. Flight attendants could even better tend to mid-flight medical crises. Sensors attached to a patient, for instance, could give ground-based doctors vital signs and other measurements upon which to base potentially life-saving decisions.

Additional objects and advantages of the disclosure will be set forth in part in the description which follows, and in part will be obvious from the description, or may be learned by practice of the disclosed embodiments. Aside from the structural and procedural arrangements set forth above, embodiments could include a number of other arrangements, such as those explained below. It is to be understood that both the foregoing description and the following description are exemplary only.

Indeed, other aspects and features of embodiments of the present invention will become apparent to those of ordinary skill in the art, upon reviewing the following description of specific, exemplary embodiments of the present invention in concert with the various figures. While features of the present invention may be discussed relative to certain embodiments and figures, all embodiments of the present invention can include one or more of the features discussed in this application. While one or more embodiments may be discussed as having certain advantageous features, one or more of such features may also be used with the other various embodiments of the invention discussed in this application. In similar fashion, while exemplary embodiments may be discussed below as system or method embodiments it is to be understood that such exemplary embodiments can be implemented in various devices, systems, and methods. Thus discussion of one feature with one embodiment does not limit other embodiments from possessing and including that same feature.

### BRIEF DESCRIPTION OF THE DRAWINGS

The accompanying drawings, which are incorporated in and constitute a part of this description, illustrate several exemplary embodiments and together with the description, serve to explain the principles of the embodiments.

FIG. 1 is a pictorial representation of a wireless network system in accordance with some embodiments of the present invention.

FIG. 1a illustrates a first tree structure of the data communication path or “links” of the wireless network system of FIG. 1.

FIG. 1b illustrates a second tree structure illustrating optimized or “stabilized” data communication paths for the wireless network system of FIG. 1.

FIGS. 2a-2g, 2h′-2h″, and 2i-2o are used to describe a prototype of the wireless network system of FIG. 1, illustrating both the path connection and path optimization process.

FIG. 3 is a block diagram of a server, router, the first wireless network and the second network of FIG. 1.

FIG. 4 is a flow diagram of a server process operating on the server of FIG. 3.

FIG. 5 is a flow diagram of the “Process Packets Received From Client” step of FIG. 4.

FIG. 5a illustrates a data packet processed by the process illustrated in FIG. 5.

FIG. 5b is a flow diagram illustrating the process “Am I on Route?” of FIG. 5.

FIG. 5c is a flow diagram illustrating the process “Data?” of FIG. 5.

FIG. 6 is a flow diagram illustrating the “Process Intermodal Information” process of FIG. 5.

FIG. 6a is a flow diagram illustrating the process “Client Authentic?” of FIG. 6.

FIG. 6b is a flow diagram illustrating the process “Put New Client In Tree” of FIG. 6.

FIG. 7 is a flow diagram illustrating the function “ADDSON(P,C)” of FIG. 6b.

FIGS. 7a and 7b are used to illustrate the operation of the ADDSON function of FIG. 7.

FIG. 8 is a flow diagram illustrating the “Delete Client From Tree” process of FIG. 6.

FIGS. 8a-8c illustrate the process of FIG. 8.

FIGS. 9a-9c illustrate the “Place Network Tree In Client Transmit Buffer” of FIG. 6.

FIG. 10 is a pictorial representation of the “Communicate with Network” process of FIG. 4.

FIG. 11 is a flow diagram of the process “Communicate With Network” of FIG. 4.

FIG. 12 is a block diagram of radio packet modem.

FIG. 13 illustrates a client, such as client A, B, C or D of FIG. 1.

FIG. 14 is a flow diagram of a client process running on the client of FIG. 13.

FIG. 15 is a flow diagram of the process “Radio Transmit and Receive Packet” of FIG. 14.

FIG. 16 is a flow diagram of the process “Perform Transmit/Receive Process” of FIG. 15.

FIG. 17 is a flow diagram of the process “Process Computer receive Packets” of FIG. 16.

FIG. 18 is a flow diagram of the process “Process Radio Received Packets” of FIG. 16.

FIGS. 18a and 18b are used to illustrate the process “Is It My Packet?” of FIG. 18.

FIG. 19 is used to illustrate the “Process Per Type Code” of FIG. 18.

FIG. 20 illustrates an initialization routine of the client process.

FIGS. 21a-21d illustrate the process of FIG. 20.

FIG. 22 depicts an exemplary wireless network comprising transmission paths between a series of nodes in which each node implements an exemplary dual wireless interface.

FIG. 23 illustrates a block diagram of one possible configuration of a radio modem implementing an exemplary dual-wireless interface.

FIG. 24 depicts an exemplary LEO constellation.

FIG. 25 depicts an exemplary satellite-based wireless network.

FIG. 26 depicts a LEO satellite-based system operating in an exemplary normal mode.

FIG. 27 illustrates in flow chart form an exemplary overall satellite-based routing scheme.

FIG. 28 depicts an exemplary “Initiation Subprocess.”

FIG. 29 depicts an exemplary “LEO Beacon Subprocess.”

FIG. 30 depicts an exemplary “RTRT Subprocess.”

FIG. 31 depicts an exemplary “Route Discovery Subprocess.”

FIG. 32 depicts an exemplary “Reliable TTL Process.”

FIG. 33 depicts in detail an exemplary “Reliable TTL Handoff Process.”

FIG. 34 depicts an exemplary “Adjacent Plane Links Process.”

FIG. 35 depicts an exemplary “Alternate Remote Route Process.”

FIG. 36 depicts an exemplary network in which an aircraft-based client may serve as a router for a terrestrial client.

FIG. 37 depicts an exemplary network in which aircraft-based clients and LEO clients may form a transmission link to an earth-station.

FIG. 38 depicts an exemplary network in which aircraft-based clients may extend a distressed LEO constellation operating in survival mode.

FIG. 39 graphically depicts data communications between airplanes in accordance with some embodiments of the present invention.

FIG. 40 illustrates a logical flow chart that provides a method of data communications between airplanes in accordance with some embodiments of the present invention.

### DESCRIPTION OF EMBODIMENTS

Reference will be made below to exemplary embodiments. Wherever possible, the same reference numbers are used in the drawings and the description to refer to the same or like parts.

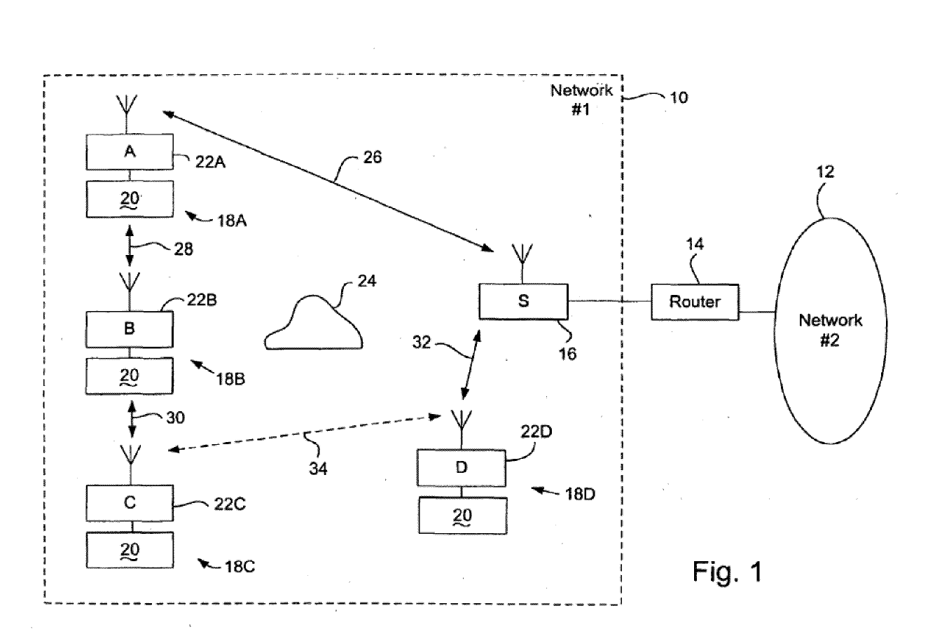

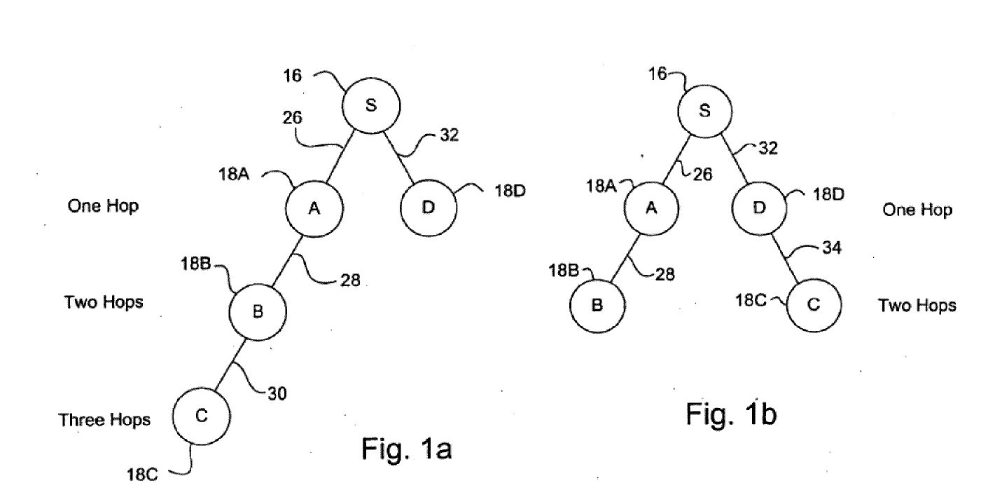

FIG. 1 illustrates an exemplary wireless network system 10. The wireless network system 10, which will also be referred to herein as a “first network”, is preferably in communication with a second network 12 via a digital communication bridge or router 14. The construction and operation of networks, such as second network 12, and bridges or routers, such as router 14, are well-known to those skilled in the art. It is preferred that the second network operates on the aforementioned TCP/IP protocols, i.e. the second network is the Internet or is a private Intranet. At times, herein, the second network will be referred to as simply the Internet, it being that other forms of a second network are also operable with the systems, apparatus, and process described herein. Again, the construction and operation of the Internet and Intranets are well-know to those skilled in the art. Likewise, routers, bridges, and other network devices such as hubs, gateways and Ethernet interfaces are well-known to those skilled in the art, and are available from a variety of sources including Cisco Systems, 3-Com, Farillion, Asante, etc. In general, as a “network interface” may refer to any such device that allows a server of the wireless network system to communicate, directly and indirectly, with the second network.

The exemplary wireless network system 10 may include one or more servers 16, the single example of which is herein labeled S. It should be noted that the server 16, serves as a gateway in that it performs a translation service between the first network and the second network. For example, the data packets on the first network include links and data types that are only applicable to the first network. Therefore, such links and data types are removed from the data packets before they are transmitted to the second network which, as noted previously, preferably operates on a TCP/IP protocol. Conversely, data packets received from the second network are modified to include the links and data types before they are transmitted to the first network. Therefore, the data packets on the first or wireless network can be essentially “packages” or “envelopes” for TCP/IP data packets when they are destined for the Internet or received from the Internet. However, as will be discussed in greater detail subsequently, the data packets of the first network can be of types other than “data” types for TCP/IP formatted data. It should be noted that while only a single server S is shown in this example that, in most cases, multiple servers, each with their own gateway to the internet, will be used in the first network.

The exemplary wireless network system 10 further includes a number of clients 18, each including a client machine 20 and a radio modem 22. The client machine 20 can be any form of digital processor, including a personal computer (PC), a computer workstation, a personal digital assistant (PDA), etc. The client machine may be a personal computer (PC) made to the Microsoft Windows/Intel microprocessor (“Wintel”) standard, or the Apple Macintosh standard. Wintel and Macintosh compatible computers are commercially available from a variety of vendors. Likewise, computer workstations and PDAs are available from a number of vendors. Radio modems, such as the radio modem 22, are further available from a number of vendors. At least some embodiments disclosed herein may be implemented using radio modems produced by GRE America, Inc. which operate on a spread spectrum technology, and which provide good receiver sensitivity and repeater capabilities. These GRE America, Inc. radio modems are commercially available under the Gina trademark and operate in the 2.4 gigahertz or 900 megahertz bands with support for the packetized data transmission. The Gina band radio modems further include error detection and correction, can operate in asynchronous and synchronous modes, and can support data speed from 300 to 64 kbps. Furthermore, the Gina radio modems can operate in a point-to-point or point-to-multipoint mode.

A server process, to be discussed in greater detail subsequently, may be implemented on the server 16, and a client process, also to be discussed in detail subsequently, operates on each of the clients 18. The client process operates, at least in part, on the client machine 20. However, in alternative embodiment, the client process can operate on the controller of the radio modem 22 of the client 18.

In the exemplary wireless network system 10 illustrated in FIG. 1, the client 18A is in “direct” radio communication with the server 16 as indicated by the radio communication link 26. This will be referred to herein as “direct” or “1-hop” or “line-of-sight” connection with server 16. The client 18B, however, does not have a direct path or “link” to the server 16 due to an obstacle 24, such as a hill, large building, etc. Therefore, the client 18 communicates via a radio link 28 with client 22A which relays the data packets from client 18B to server 16. A client 18C has a direct line-of-sight to server 16, but is out of transmission range to the server 16. therefore, the client 18C transmits its data packets by a radio link 30 to client 18B, from where is relayed to client 18A via link 28, for eventual relay to the server S via radio link 26.

As noted in FIG. 1, 18D is in direct communication with server 16 via radio communication link 32. If client 18C detects the transmissions of client 18D, it will note that client 18D has less “hops” to server 16 than does client 18B, and will switch its link from client 18B to client 18D. This process is a part of the “stabilization” or “optimization” process of the network 10.

It will therefore be appreciated that the exemplary wireless network system 10 may be constantly attempting to optimize itself for the “best” data transmission. In the exemplary embodiments described herein, this optimization looks solely to the number of hops between the client and the server for the sake of simplicity. However, other factors can also affect the quality of the data transmission. For example, the traffic, of data packets through a particular client modem may be large, such that is better to route the data from neighboring clients through other clients, even though there may be more hops involved with the alternative routing. Also, some radio links may be less robust or may be slower than other links, such that optimization may result in a routing of data around the less robust or slower links, even though it may increase the number of hops to the server 16. Therefore, although the present embodiment looks at only one single factor in its optimization process, it will be appreciated by those skilled in the art that multiple factors can be used to stabilize or optimize the exemplary wireless network system 10.

It should also be noted that the exemplary wireless network system 10 may be quite robust in that it may survive the loss of one or more clients in the system. For example, if the client 18A is lost due, for example, to a power or system failure, the data packets of client 18C can be routed through the client 18D, and the data packets for the client 18B can be routed through clients 18C. Therefore, the wireless network system 10 may be highly robust and highly survivable under a number of adverse conditions.

In addition, some embodiments described herein may permit mobile communication within the wireless network system 10. For example, if the client 18D is a portable computer and is moved around within the wireless network system 10, it will opportunistically change its data communication path as better links become available. For example, if the client 18D is moved close to the client 18B, it may use the client 18B as its link to server 16. Also, any routing through the client 18D from other clients (such as 18C in this example) will be updated and optimized as the data path for the client 18D changes.

It should be noted that, in general, the network may operate the best and may be the most suitable if the radio modems and their client/controllers are never turned off. It may therefore be desirable to not have and on/off switch on the radio modem, so that the clients are always participating in the network traffic distribution. However, even if a radio modem is turned off, the remaining clients will re-route through other clients, as will be discussed subsequently

In FIGS. 1a and 1b, two “tree” structures are shown illustrating the various links that were discussed, by way of example, with reference to FIG. 1. The tree structure is maintained in the server S, and is transmitted to any client that may request it.

In FIG. 1a, a tree indicates that client 18A is linked to a server 16 by a link 26, client 18B is linked by link 28 to a client 18A and by link 26 to a server, and client 18C is linked by line 30 to client 18B, by link 28 to client 18A. and by line 26 to server 16. The client 18 D is in direct communication with the server 16 via radio link 32. Therefore, clients 18A and 18D are both “1 hop” away from the server 16, client 18B is “2 hops” away from server 16, and client 18C is “3 hops” away from server 16.

In the scenario where client 18C realizes it has a better connection to server 16 through the client 18D, the link 30 to client 18B is no longer used, and a new radio link 34 to client 18D is established. This is illustrated in FIG. 1b. Now clients 18A and 18B remain 1 hop clients, client 18B remains a 2 hop client, but client 18C is upgraded from a 3 hop client to a 2 hop client. Therefore, the data transmission efficiency of the network has been “stabilized” or “optimized.”

It should be noted that the term “link” is used to convey both the connection to an adjacent client as well as the entire path from the client to a server. It will therefore be understood that when speaking of a link to an adjacent client, that this also implicitly includes all necessary links from that adjacent client to the server, i.e. a link is the entire path description from a given client to a given server.

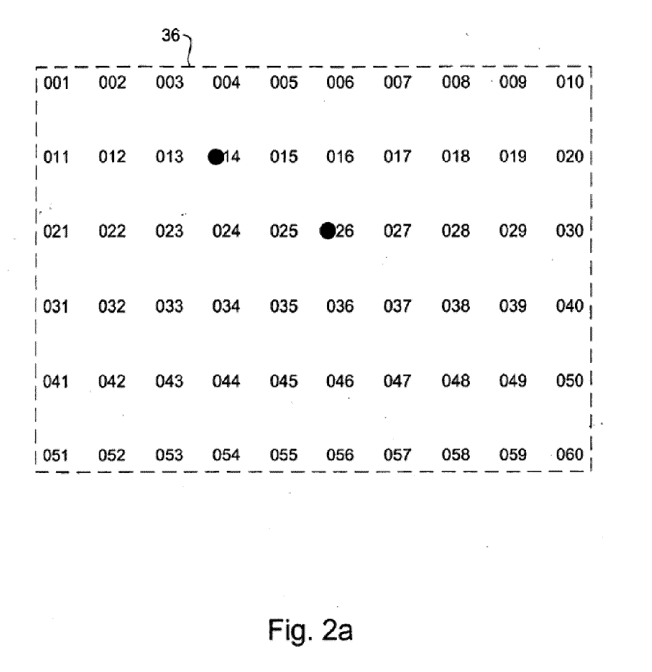

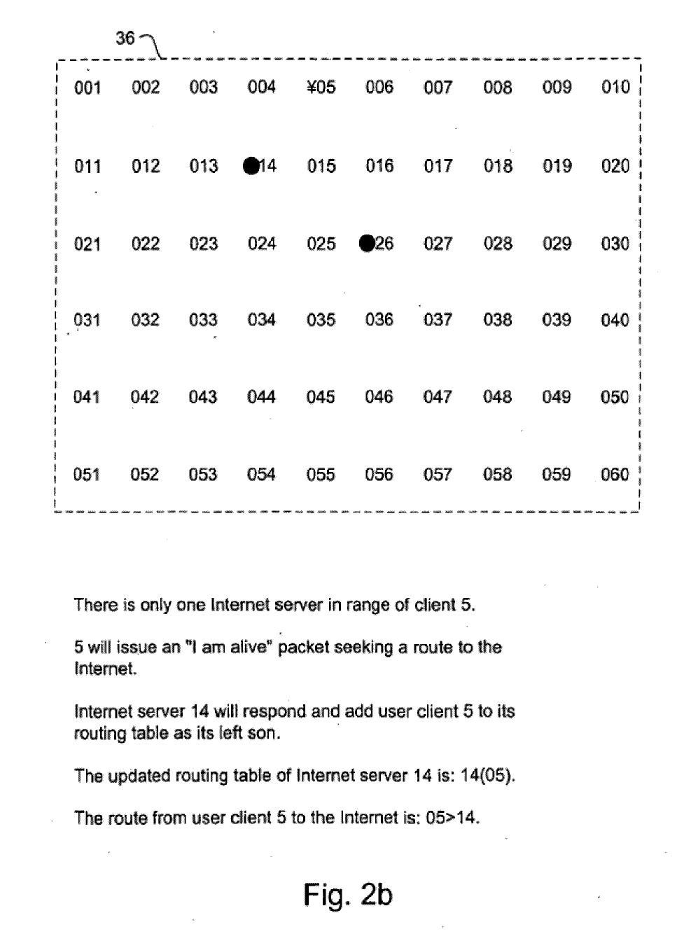

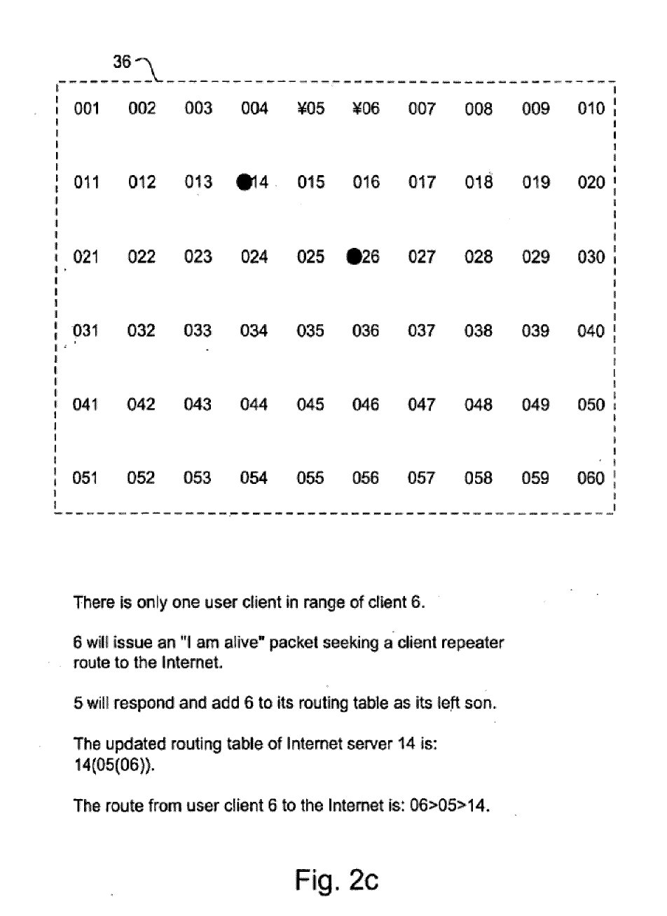

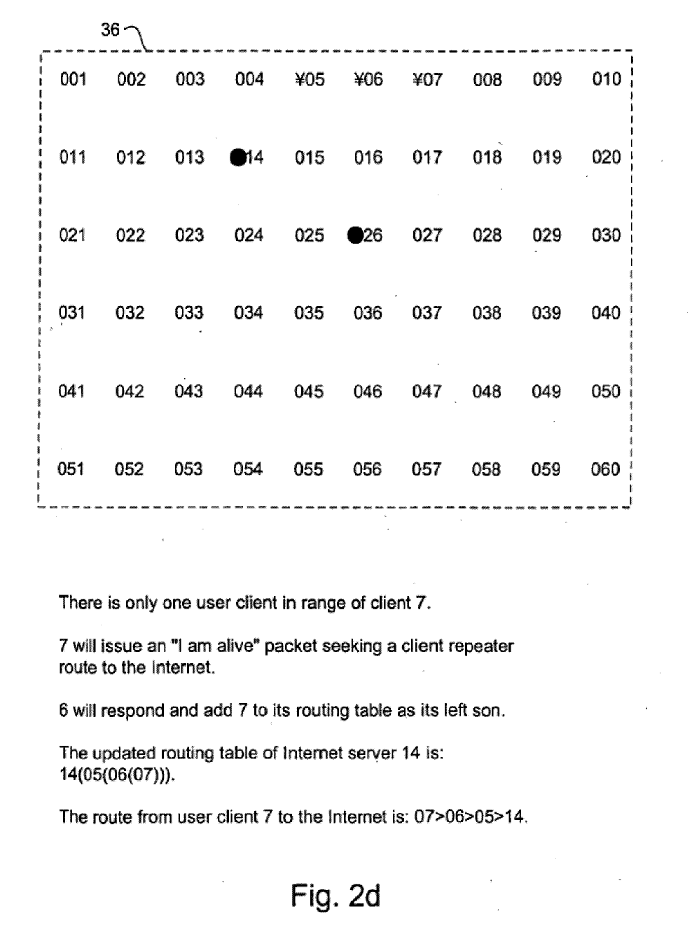

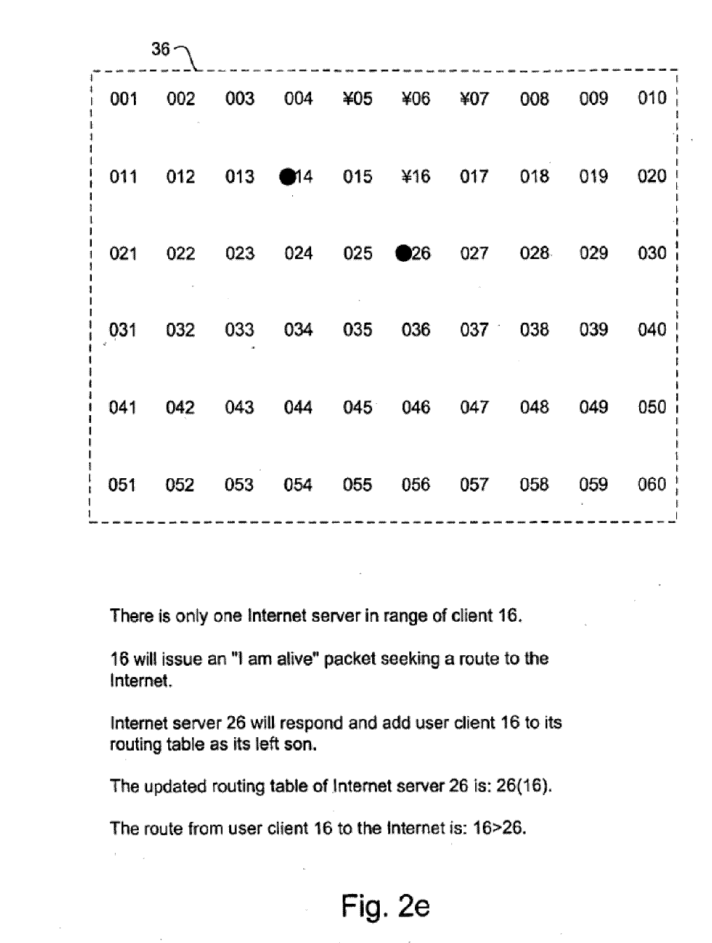

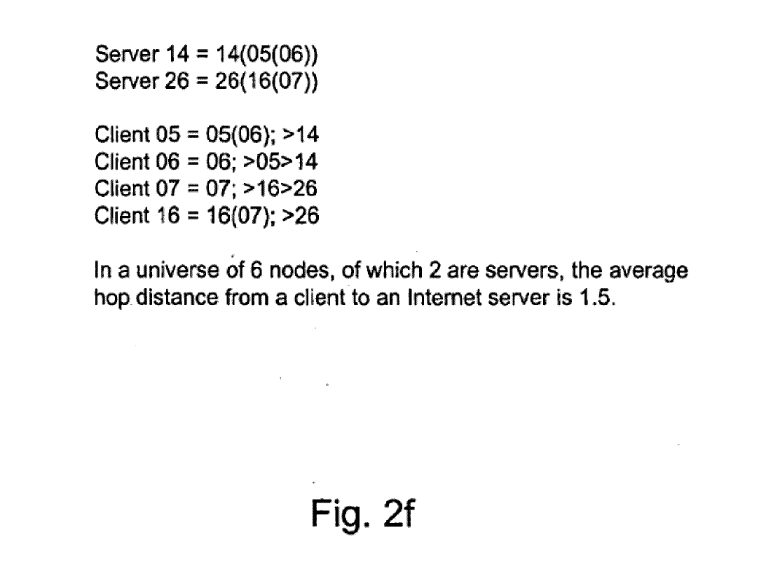

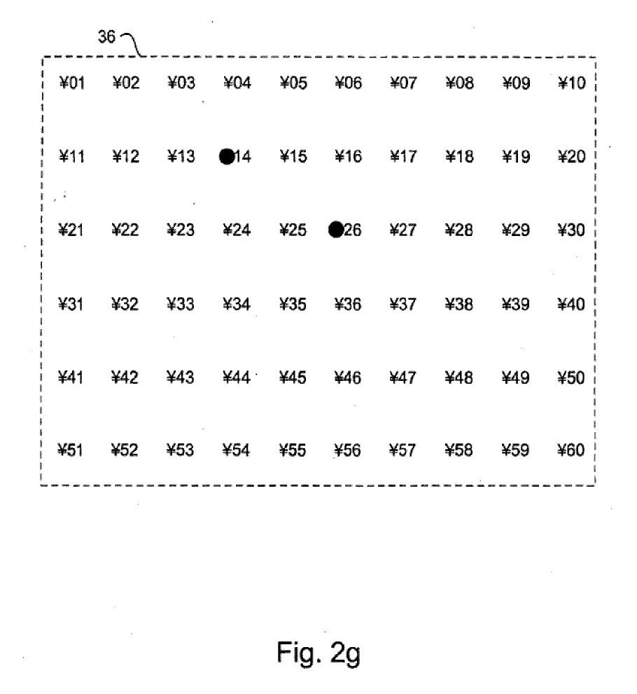

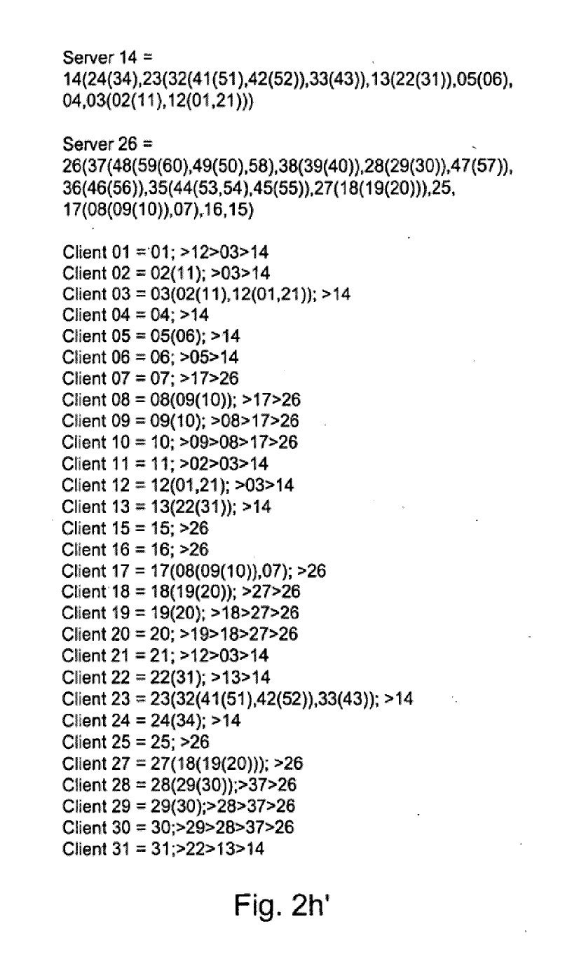

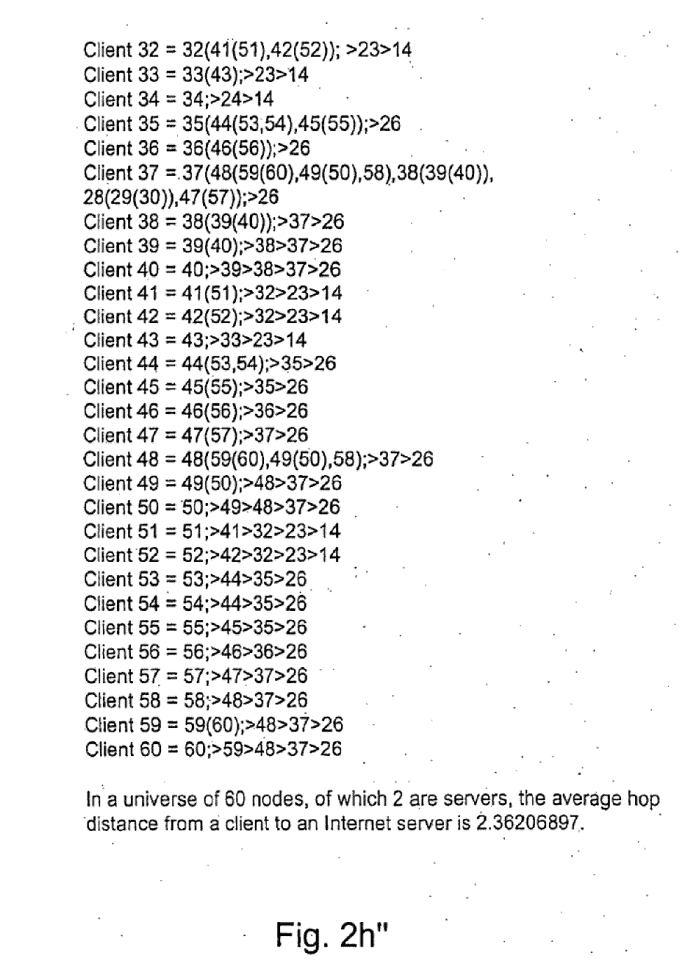

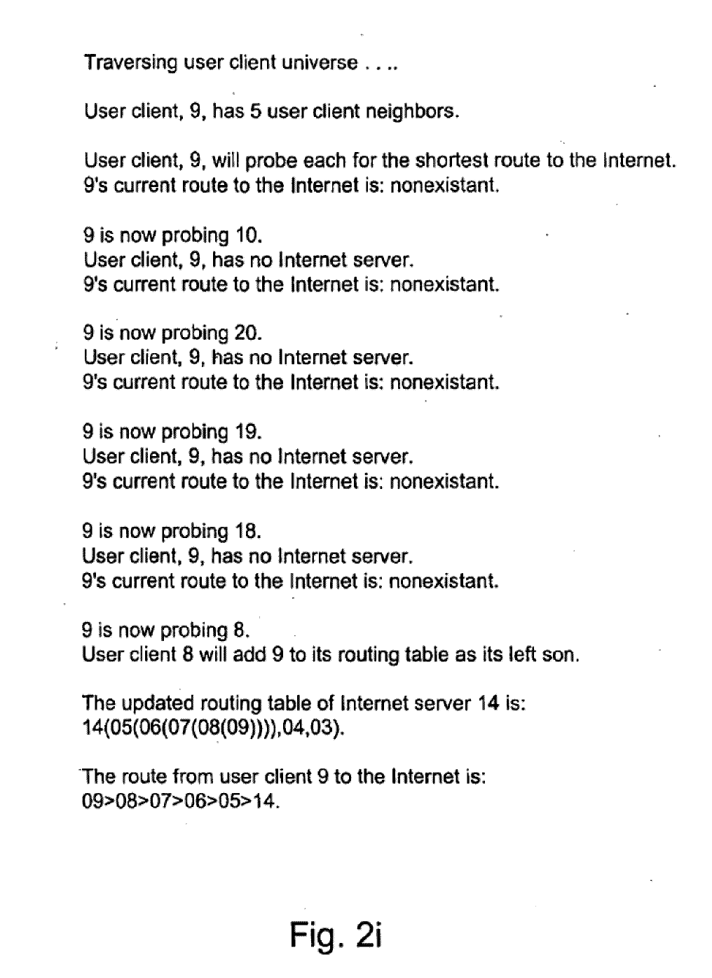

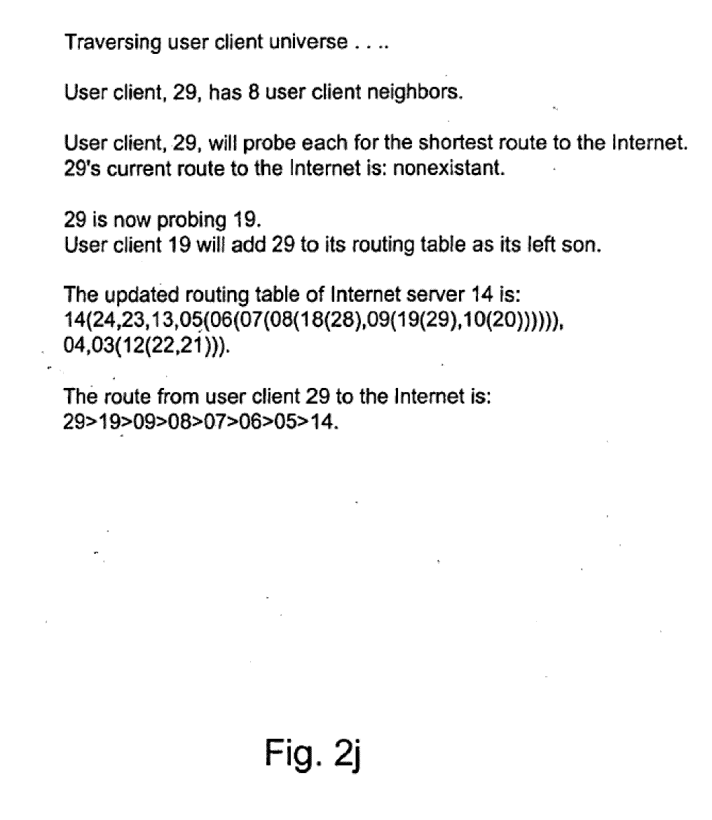

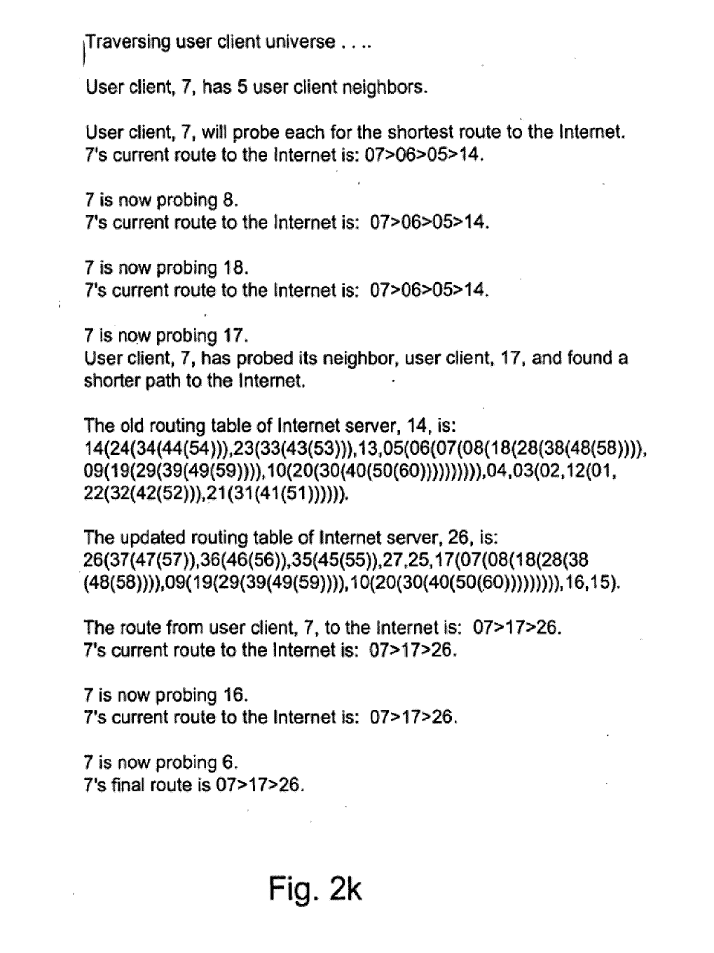

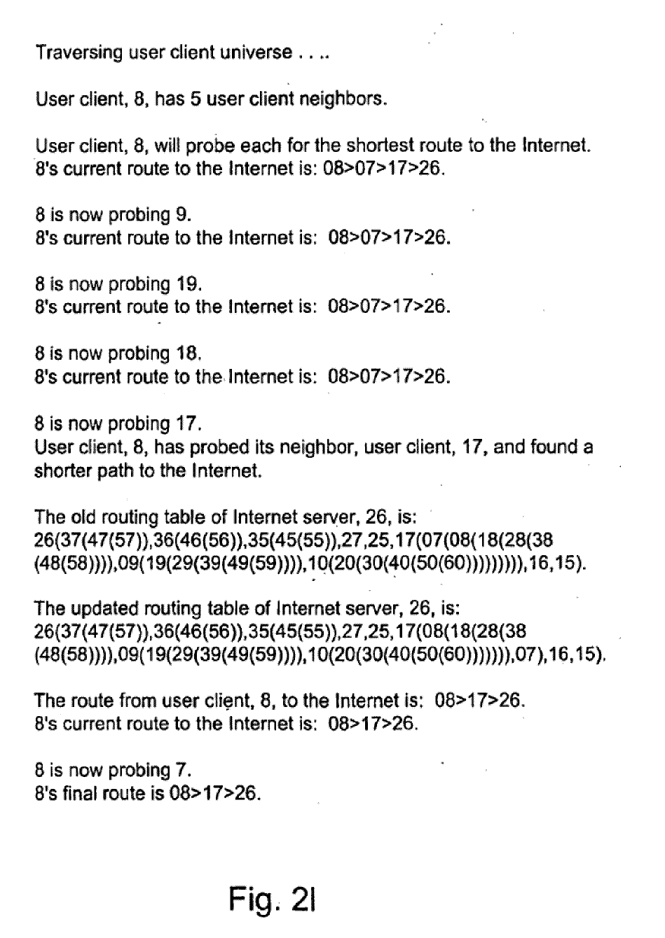

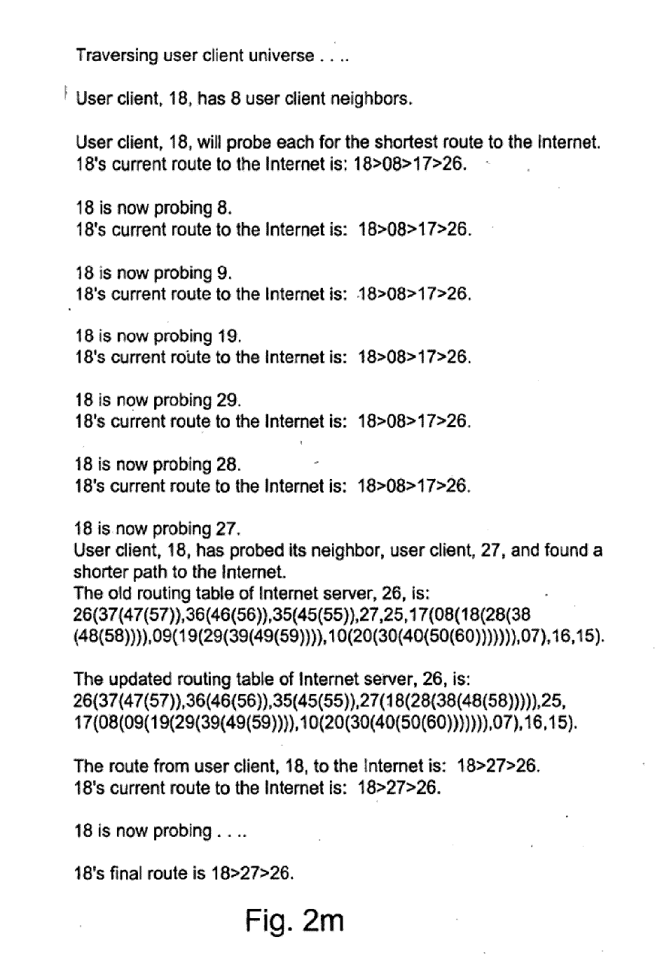

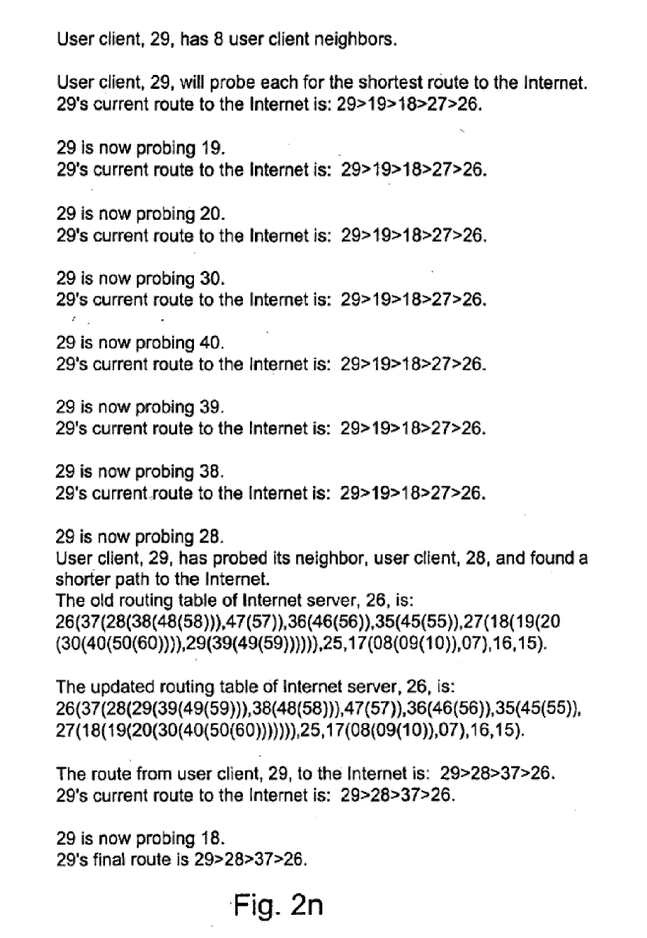

FIGS. 2a-2o, an exemplary wireless point-to-multipoint network is prototyped to facilitate a discussion of the theory and operation of the disclosed embodiments present invention. In FIG. 2a, a network 36 with 60 potential “nodes” 001 through 060 is illustrated. As used herein, a “node” can either be a client or a server. The nodes 014 and 016 have been arbitrarily selected as servers for the purpose of this example. The nodes 014 and 016 are marking servers with the large black dot replacing the leading “0” of those numerals. For the purpose of this example, it is assumed that a node can only communicate with an immediate adjacent node. Of course, in actual operation, nodes may be able to communicate with more distant nodes than its immediate neighbor nodes.

It should be noted, that in the notes incorporated of FIGS. 2b through 2k the leading “0”s have been deleted from client numbers, e.g., client 005 is referred as client 5 in FIG. 2b. This notation is used for clients with respect to clients and servers and the notation should not be confused with any other uses of the reference numerals 1 through 60 in this document.

FIG. 2b, a first client is designated at node 005 (hereafter “client 005”). For the purposes of this example, the Yen or “English Pound.” symbol is positioned next to the client 005. As noted previously, for the purpose of this example, we will assume that any particular node is only in radio communication range of a node that is adjacent in a horizontal, vertical or diagonal direction, i.e., in an immediately adjacent “neighbor”. In this instance, client 005 detects that there is a radio contact with node 014, which is a server (hereafter “server 014”). This server 014 and the client 005 will build a routing path or “link” between each other. This is accomplished by client 0005 transmitting a “I Am Alive” packet seeking a route to a server. The server 014, being within a radio transmission range, will respond and will add the client 005 to its routing table as its “left son.” The meanings of the “routing table” and the “left son” will be described subsequently. The routing table of the server 014 is therefore 014(005), and the route from the client 005 to the server 014 is 005>014. Again, this notation will be discussed in greater detail subsequently.

The network 36 than has a second client 6 added as indicated by the “.English Pound.” symbol next to node 006 in FIG. 2c. Second client 006 makes radio contact with client 005 and builds a routing path or a “link” to a server 014 through the client 005. Server 014 updates its routing table accordingly. This is accomplished by client 006 issuing an “I Am Alive” packet seeking a client repeater route to a server. Client 005 will respond and add client 006 to its routing table as its left son. The updated routing table of the server 014 is therefore 014(005)006)). The route from the user client node 006 to the server 014 is 006>005>014. In FIG. 2d, a third client 007 is added to the network 36 as indicated by the “.English Pound.” symbol next to node 007. Client 007 establishes contact with client 006 and finds a path through clients 006 and 005 to server 014. This is accomplished by client 007 issuing a “I Am Alive” packet seeking a client repeater route to server 014. Client 006 will respond and add client 007 to its routing table as its left son. The updated routing table of the server 014 is then: 014(005(006(007))). The route from client 007 to the server 014 is: 007>006>005>014.

In FIG. 2e, another client 016 has been added at node 016 as indicated by the “.English Pound.” symbol. It should be noted that the client 016 can make radio contact with clients 005, 006, and 007. However, client 016 recognizes node 026 as being a server (hereafter “server 026”) and then connects directly to server 026. This is accomplished by client 016 transmitting a “I Am Alive” packet seeking a route to a server. The server 026 will respond and will add client 016 to its routing table and its left son. The updated routing table of server 026 is then 026(016). The routing from client 016 to the server 026 is 016>026.

In FIG. 2f, a server routing table and a route for each client thus far in the example are illustrated. It should be noted that when client 016 came into existence, a shorter route was created for client 007 to a server, namely via client 016 to server 026. As noted in this figure, client 007 has made the adjustment to connect to server 026, thereby “stabilizing” or “optimizing” the network 26. Also, it should be noted that server 014 has deleted client 007 from its routing table, since client 007 is now using server 026 as its gateway to the Internet. This creates a universe of six nodes, of which two are servers and of which four are clients. The average “hop” distance from a client to a server is 1.5 hops. The remainder FIGS. 2g-2o further illustrate these concepts. In FIG. 2g, the network 36 illustrates an extreme example where 58 clients are connected to the two servers 014 and 026. FIGS. 2h′ and 2h″ show a fully “stabilized” or “optimized” network where the path or “link” from any client any client to a server is as short as possible, i.e. where there is few “hops” as possible. It should be noted that the optimization occurs dynamically during operation and without complex algorithms and look-up tables. As will be discussed in greater detail subsequently, the optimization occurs when clients “hear” transmission from other clients that have a better (i.e. shorter) path to a server.

FIG. 2h′ shows the network as seen from the point of view of servers 014 and 026 and from the point of views of clients 001-client 031. In FIG. 2h″, the network as seen from the point of view of clients 032-060, along with statistics for the overall network, are shown. In brief, in a universe of 60 nodes, of which two are servers and 58 are clients, the average hop distance from a client to a server is 2.36206897 hops. In FIG. 2i, the process of adding a new client 009 to the server is illustrated. The first time the client 009 came “alive” (i.e. became operational) it took five tries before node 009 found a client neighbor with a path to the server. The reason that it may take many tries to find a connection path is that multiple neighbors of client 009 are responding to the client 009 “I Am Alive” message via CSMA/CD (Carrier Sent Multiple Access/Collision Detection) protocol. The likelihood that any particular neighbor of client 009 will respond first is, essentially, random. Once client 009 hear from a neighbor that it does not have a path to a server, client 009 tells that neighbor not to respond to the next “I Am Alive” announcement from client 009. In consequence, client 009 keeps trying to find a path to the server until it succeeds. However, that path may not be the shortest path. In this example, the client 009 finds a path to the Internet server, resulting in updating of the routing table for the Internet server 014, as 014(005(006(007(008(009)))),004,003). The route or “link” from client 009 to the server is: 009>008>009>006>005>014.

In FIG. 2j, a client 029 is finding a route to the server via one of its neighbors. It finds a route through 019, and is added to the routing table a client 019 as its left son. The routing table of server 014 is also updated, and the rout from user client 029 to the server is determined. However, this route is not an optimal route in that it includes a greater number of hops than necessary.

In FIG. 2k, the “stabilization” or “optimization” process is illustrated. It was previously noted that the client 029 has a non-optimal path to a server. In order to improve this path client 029 will receive “help” from its neighbors starting with client 007. Client 007 currently has a route to server 014. Client 007 starts randomly probing its neighbors looking to a short route to a server. Client 007 finds a shorter route to client 026. Client 007 informs server 014 to drop client 007 from server 014's routing table, and client 007 informs server 026 to add client 007 to its routing table. Since client 029 was “downstream” from client 007, client 029 dramatically becomes switched to a route to server 026.

In FIG. 2l, this process is repeated for client 008. Notably, client 008 shortens its route to server 026 by 1 hop. Client 009 cannot improve its route to server 026.

In FIG. 2m, client 018 shortens its route to server 027 to 2 hops. This is despite the fact that the route to client 007 and 008 are a relatively efficient 3 hop links. In FIG. 2n, client 029 is optimizing its path. Client 029 eliminates 018 from its route by “leap frogging” past client 018 with the result of the shortest possible 3 hop route to server. Ultimately, therefore, client 029 route is improved from a 7 hop path to server 014 to the shortest possible 3 hop path to server 026. This result is dramatically accomplished with the efficiencies of clients 007, 008, and 018 also improving, and without the need for complex routing algorithms.

In FIG. 2o, another example of individual dramatic routing is illustrated for client 044. This client node shortens its rout from 3 to 2 hops by switching server destinations. Client 044 drops out of the server 014's routing table and gets added to server 026's routing table.

The advantage of prototyping the system in FIGS. 2a-2o is that further optimizations become apparent. For example, if a great deal of network traffic is going to a particular node, it may be desirable to place a “passive repeater” at that node. A passive repeater is not a client, per se, but, rather, is a transceiver that receives and rebroadcasts packets. The passive repeater therefore effectively extends the range the range of the transmitting clients, and reduces data bottlenecks in the system. A passive repeater is also used for clients with long links to a server in that it can shorten the link by effectively allowing to skip some intermediate links. The prototyping of the system is also useful in that it shows that placing servers near the center of the network reduces the average link length (i.e. reduces the average number of client hops), in the network.

In FIG. 3, a block diagram of the server 16 of FIG. 1 is illustrated. In this instance, the server 16 includes a computer system 38 and a number of peripherals coupled to the computer system. The computer system 38 can be a personal computer system, a computer workstation or a custom data processor capable of implementing the exemplary processes disclosed herein.

By way of example, the computer system 38 includes a microprocessor 42 that is coupled to a memory bus 44 and to an input/output (I/O) bus 46. Typically also coupled to the memory bus 44 are random access memory (RAM) 48 and read only memory (ROM) 50. The RAM 48 is usually volatile (i.e. its contents are lost when power is removed) and is used for temporarily or “scratch pad” memory. The ROM 50 is non-volatile (i.e. its contents are not lost when power is removed), and typically includes the start-up instructions for the computer system 38. A number of peripherals are typically coupled to the I/O bus 46. For example a removable media drive 52 for a removable media 54 (such as a floppy disk, a Zip® disk, or a C/D ROM) is typically coupled to the I/O bus 46, as is a fixed or hard disk 56. Furthermore, a router 14 or bridge can be used to couple the I/O bus 46 to the Internet 12 as previously described. In addition, an RJ45 Ethernet interface 58 can be used to couple the computer system 38 to a local area network 60 and from there to the Internet 12 by a router 14, or the like, Also, a radio modem 62 (including a control section C, a radio section R, and an antenna 64 coupled to the radio section R) can be coupled to the I/O bus 46. The radio modem 62 can communicate with the network 10 including a number of nodes 66 by a wireless transmission of “radio link 68”. The assembly of the hardware of the server illustrate in FIG. 3 will be apparent to those skilled in the art.

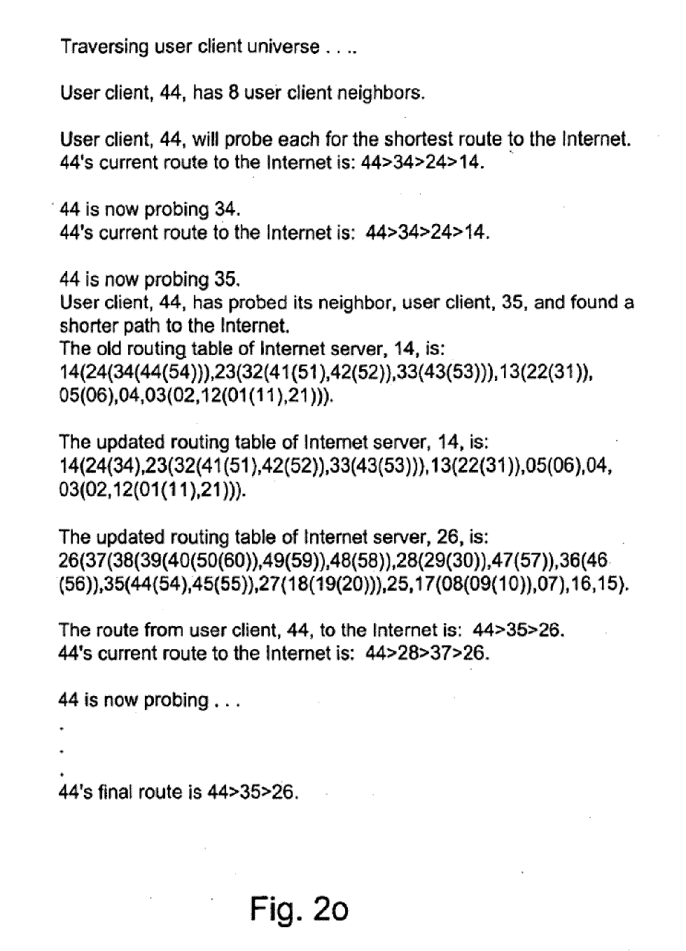

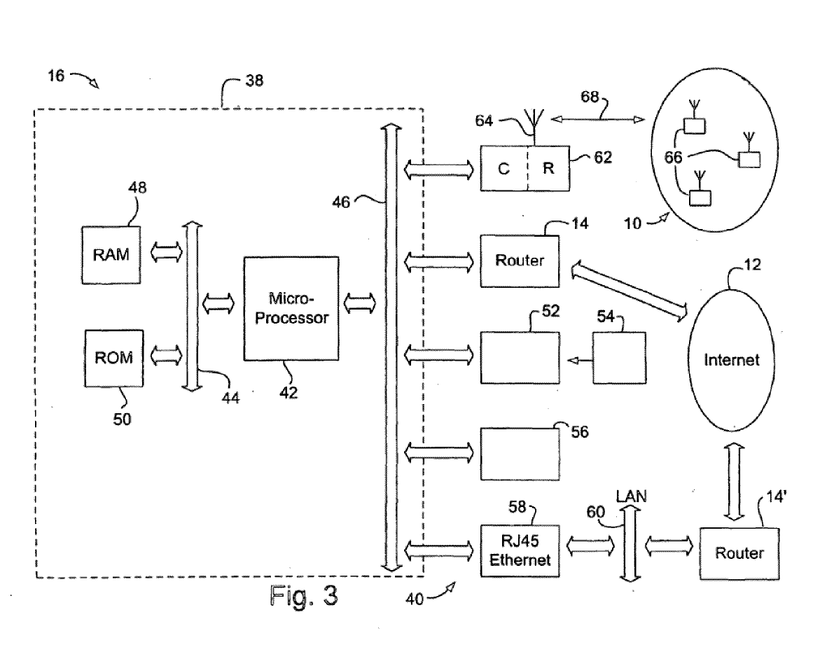

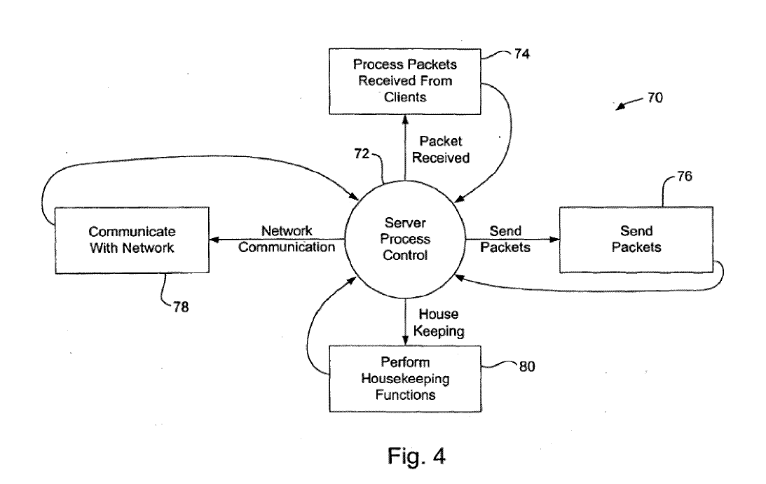

In FIG. 4, an exemplary server process 70 of the present invention is implemented on the server 16. More particularly, the server process 70 can be implemented on computer system 38, within the control section of the radio modem 62, or partially in both of those places. In the embodiment shown, the majority of the server process 70 is implemented on the computer system 38. However it should be noted that the control section C of the radio modem 62 includes a microprocessor and memory and, with proper program instructions, can be made to implement the process 70 of FIG. 4, freeing the personal computer 38 for other tasks.

The server process 70 includes a server process control 72 and four subprocesses. More particularly, the subprocesses include a process 74 which processes received from clients, a process 76 which sends packets, a process 78 which communicates with the network, and a process 80 which performs housekeeping functions. Each of these processes will be discussed in greater detail subsequently.

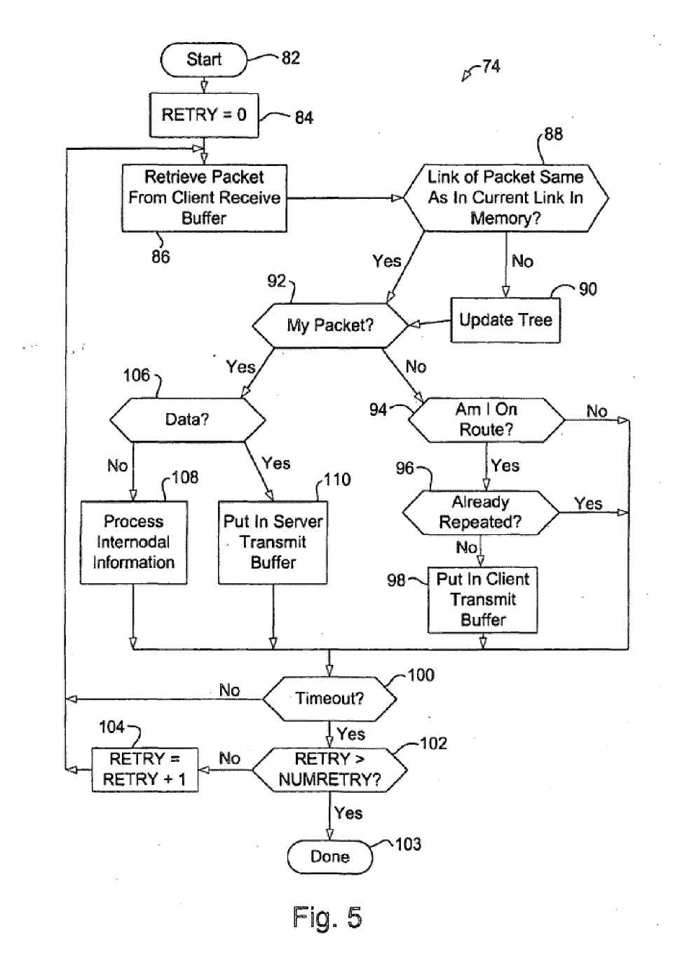

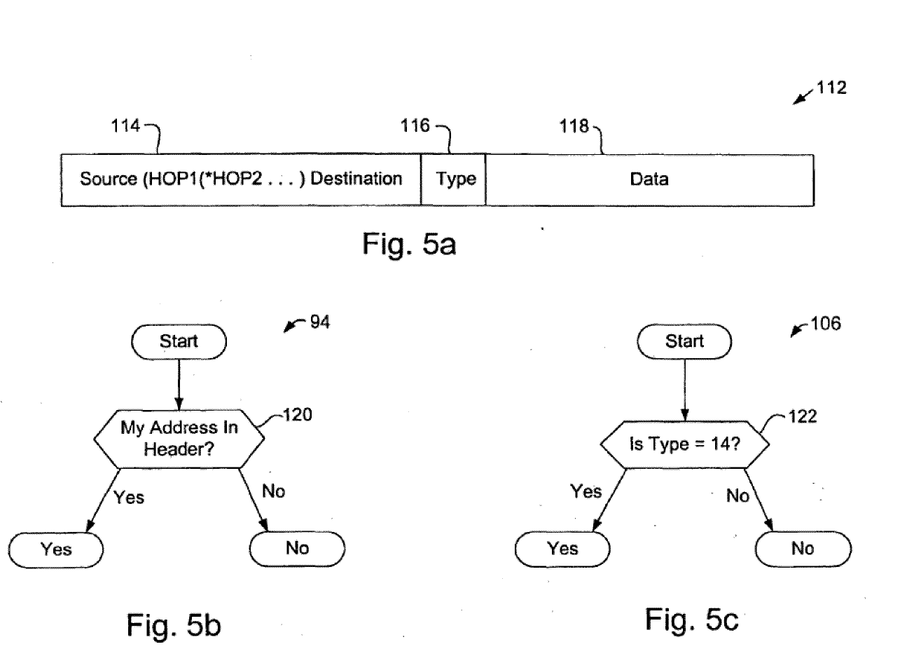

In FIG. 5, the process “Process Packets Received From Clients” 74 of FIG. 4 is illustrated in greater detail. The process 74 begins at 82, and at step 84, the variable RETRY is set to 0. Next, a step 86 retrieves a packet from the client receive buffer, and a decision step 88 determines whether the path or “link” of the packet is same as the currently stored link in memory. If not, a step 90 updates the tree. If so, or after the updating of the tree in step 90, a decision step 92 determines whether it is “My Packet?” In other words, step 92 determines whether the packet being received by the server was intended for that server. If not, a decision step 94 determines whether that server is on route. If that server is on the route, but is not its packet, a decision step 96 determines whether the packet has already been repeated. If, not the packet is placed in the client transmit buffer. If decision step 94 determines that the server is not on the route, or the packet has already been repeated, or upon the completion of step 98, a decision step 100 looks for time-out. The time-out is provided by the server process control 72 such that the computer hardware resources on which process 70 are implemented can be shared among the four processes. More particularly, in most instances, the computer hardware resources are shared among the subprocesses 74-78 in a “round-robin” fashion well-known to those skilled in the art. However, it should be noted that at times the strict round-robin scheduling is not adhered to, as will be discussed subsequently.

If step 100 determines that a time-out has occurred, the decision step 102 determines whether the retry number RETRY is greater than the allowed, namely NUMRETRY. In its preferred embodiment, the number of retries RETRY are set at, perhaps, 2 or 3 so that the server does not tie up its resources with endless retries of process. If RETRY is greater than the NUMRETRY, the process is as indicated at 103. Otherwise, a step 104 increments RETRY by 1. In the absence of a time-out and in the absence of the number of retries being used up, process control returns to step 86.

If step 92 determines that the packet is for that server, a step 106 determines whether the packet is a data type. If not, a step 108 process “internodal information.” If so, a step 110 places the data in a server transmit buffer. After the completion of steps 108 or 110, process control is returned to step 100 to determine if there is a time-out.

In FIG. 5a, an exemplary “data packet” 112 is illustrated. As it will be appreciated by those skilled in the art, a data packet is an associated string of digital information that is transferred and processed as a unit. The data packet 112 shown includes a header 114, a type 116 and data 118. The data 118 can be standard TCP/IP data. The header 114 includes the source address, the address of all hops along the way (i.e. the “link” of the data packet), and the destination address. Hops (i.e. clients and servers) that already have been traversed (i.e. have already forwarded the data packet) are indicated with an asterisk (“*”) symbol. The type 116 is, in this implementation, a two-digit code indicating the type of the data packet 112, as well as will be discussed in greater detail subsequently. The data section 118 of the data packet 112 includes the data associated with that packet. The data according to some embodiments is in the range of 128-1024 bytes in length.

In FIGS. 5b and 5c, respectively, the decision steps 94 and 106, respectively, are illustrated with respect to the data packet architecture of FIG. 5a. The decision step 94 (“Am I on Route?”) of FIG. 5 is simply determined by process 120 “My Address In The Header?”. If yes, the process of FIG. 5 branches to step 96, and if no, the process of FIG. 5 branches to step 100. In FIG. 5c, the decision step 106 “Data?” simplifies to a process 122 “Is the Type Equal to 14?”. This is because, in the present invention, a type 14 has been arbitrarily chosen to indicate a data type. If yes, the process of FIG. 5 branches to step 100, and if no, the process of FIG. 5 branches to step 108.

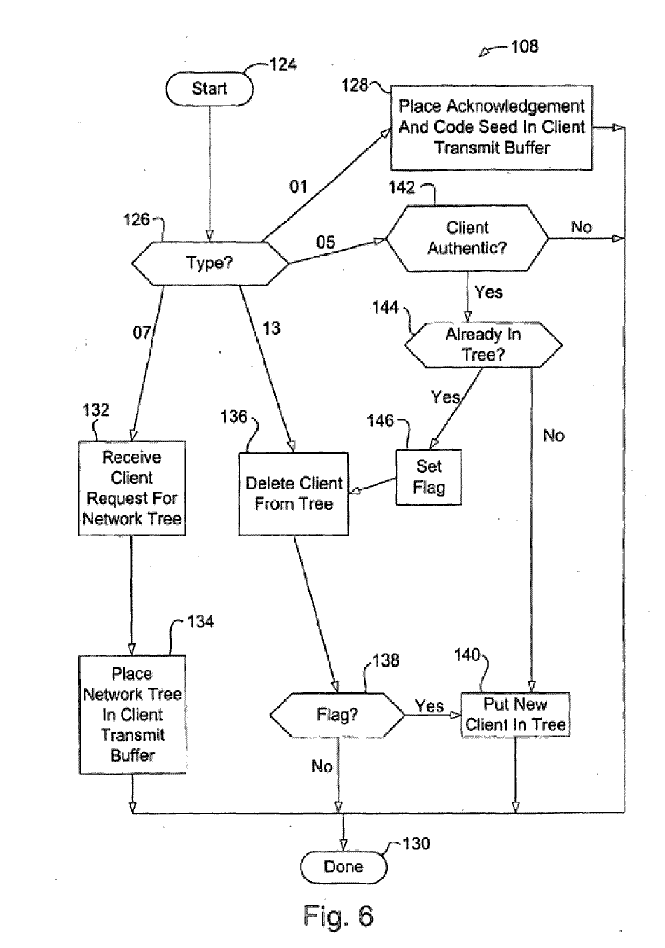

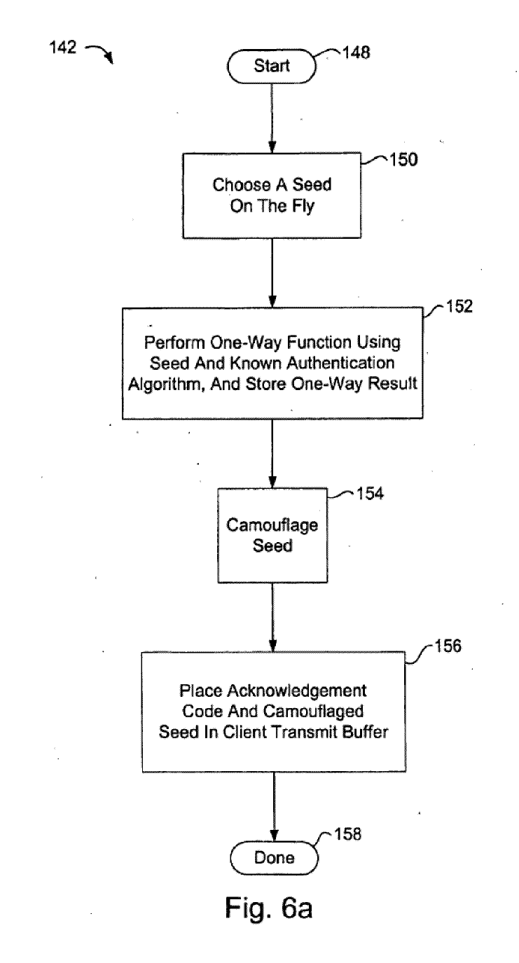

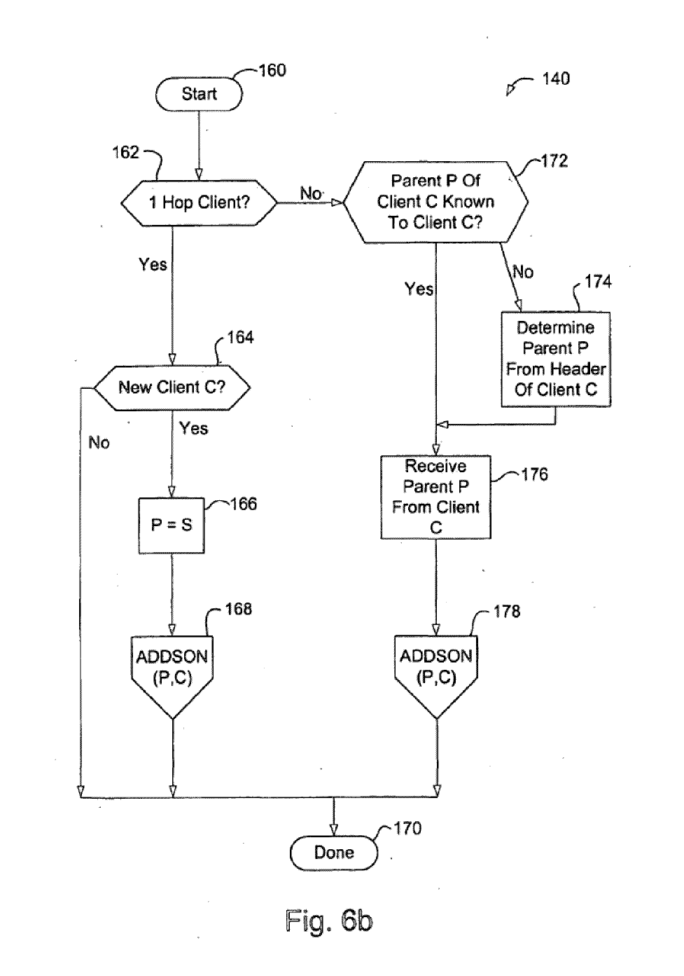

In FIG. 6, the step 108 “Process Internodal Information” of FIG. 5 is explained in greater detail. The process 108 begins at 124 and, in a multi-branch decision step 126, the type of the data packet is determined. If the type is a “01”, a step 128 places an acknowledgement and a “code seed” in the client transmit buffer, and the process is completed at 130. Acknowledgements and “code seeds” will be discussed subsequently. If the type is a “07”, a step 132 receives the client request for the network tree, and the process places the network tree in the client transmit buffer in a step 134. The process is then completed at 130. If, however, the type is “13”, a step 136 deletes the client from the tree and a step 138 determines whether a flag has been set. If not, the process is completed at 130. If, the flag has been set as determined by step 138, a step 140 puts a new client in the tree and the process is then completed at 130.

If decision step 126 determines that the “type is “05” a step 142 determines whether the client is authentic. The authentication process, which will be discussed subsequently, keeps unauthorized clients from being added to the network. If the client is not authentic, the process is completed at 130 and the client is not allowed to connect to the server. If a step 142 determines that the client is authentic, a step 144 determines whether the client is already in the server tree. If yes, the flag is set in a step 146 and process control is turned over to step 136 to delete the client from the tree. Since the flag has been set, step 138 branches the process control to step 140 and the new client is placed in the tree, after which the process is completed at 130.

The addition and removal of nodes from trees are well known in those skilled in the art. For example, in the book, incorporated herein by reference, SNOBOL 4: Techniques and Applications, by Ralph E. Griswald, Department of Computer Science, University of Arizona, Prentiss-Hall, Inc.,® 1975, ISBN″0-13-853010-6, algorithms for placing and removing clients from trees are discussed.

FIG. 6a illustrates the process 142 of FIG. 6 in greater detail. More particularly, the process 142 begins at 148 and, in a step 150, a “seed” is chosen on the fly. Next, in step 152, a “one way” function is performed using the seed and a known authentication algorithm, and a one-way result is stored. Next, found in step 154, the seed is “camouflaged” and in a step 156, places an acknowledgement code and camouflaged seed in the client transmit buffer. The process is then completed at 158.

The purpose of the process 142 is to prevent unauthorized “clients” from accessing the network. For example, hackers may be prevented from accessing the network unless they can crack the authentication process, which is nearly impossible.

Authentication techniques are well known to those skilled in the art. For example, the book, incorporated herein by reference, Algorithms in SNOBOL 4, by James F. Gimpel, Bell Telephone Laboratories, John Wiley & Sons, a Wiley Interscience Publication,® 1976 by Bell Telephone Labs, Inc., ISBN 0-471-30213-9, describes authentication techniques using one-way seeds. See, in particular pp. 348-349 with back references. In brief, a “seed” is chosen “on the fly” such as by reading the system clock. The one-way function modifies the seed using an algorithm known to both the server and the clients. The one-way result, which in this instance is 4 bytes in length, is stored. The step 154 then “camouflages” the seed by dispersing the 4 bytes among perhaps 26 other bytes prior to transmitting the camouflaged seed. The receiving clients know which of the four bytes to use for their one-way function.

The process 140 “Place New Client In Tree” of FIG. 6 is illustrated in greater detail in FIG. 6b. The process 140 begins at 160 and in a step 162, it is determined whether this is a “1 hop” client. If so, a decision step 164 determines whether it is a new client C. If so, the variable P is set to S in step 166 and the function “ADDSON” with the variables (P, C) is evoked in step 168. S, of course is the server or root of the tree. If step 164 determines that is not a new client C, or after the completion of the ADDSON function, the process ends at 170.

If step 162 determines that it is not a 1 hop client (i.e. C is a multi-hop client) a step 162 determines whether the parent P of client C is known to client C. If not, a step 174 determines the parent P from the header of client C. If the client C does know its parent, or after the completion of step 174, a step 176 receives parent P from client C. Next, in a step 178, the function ADDSON(P, C) is evoked, and the process is completed at 170.

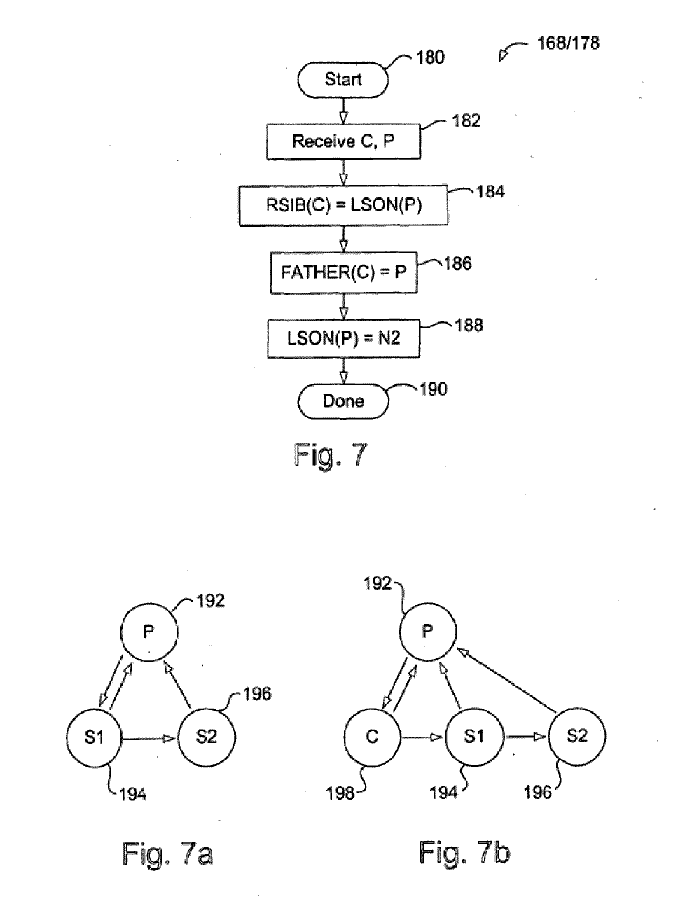

In FIG. 7, the ADDSON(P,C) function is explained in greater detail. More particularly, function steps 168-178 begin at 180 and, in a step 182, the variables C, P are received. In this notation, the sting RSIB ( ) refers to a string of right siblings, and the notation LSON( ) refers to a string of left sons. A step 184 sets RISB(C)=LSON(P). A step 186 sets a string FATHER(C)=P and a step 188 sets the string LSON (P)=N2 is an in-memory pointer that points to the memory location of nodes. The string FATHER provides a pointer from a child C to its father, which in this case is P. The process is then completed as indicated at 190.

In FIGS. 7a and 7b, the ADDSON function is graphically illustrated. In FIG. 7a, a parent 192 has left a son 194 and a right sibling 196. The parent 192 and left son 194 have mutual pointers to each other, while the right sibling 196 has only a pointer to the parent 192. The left son 194 also has a pointer to the right sibling 196. When ADDSON function is evoked with the argument (P, C) C is added as the left son 198 and the pointer in the parent 192 is updated to point to the left son 198. The left son 198 has pointers to the parent and to the new right sibling 194. The new right sibling 194 still has a point to the older right sibling 196, and both siblings 194 and 196 have pointers to the parent 192. It should be noted, under all circumstances, that the parent is only directly aware of the left son, in that it only has a pointer to the left son.

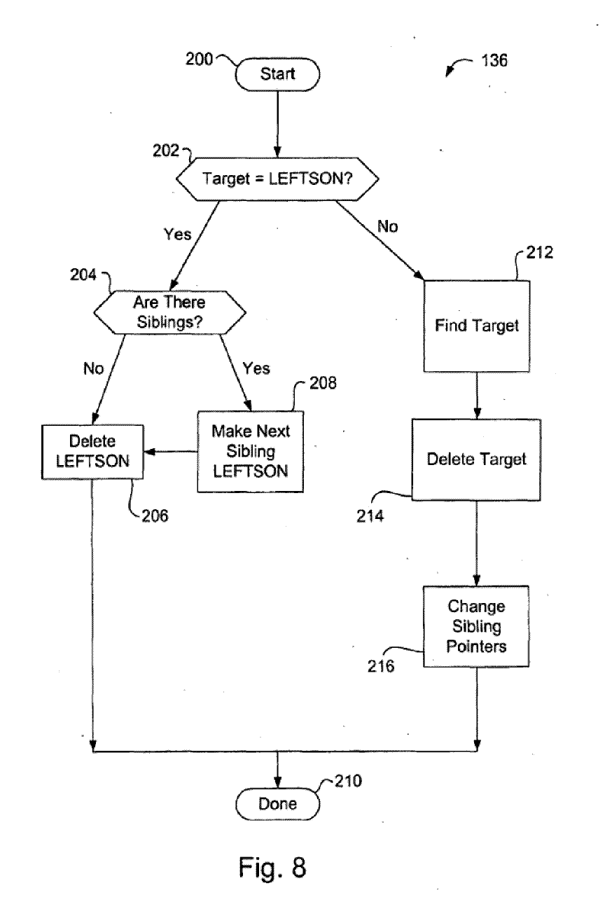

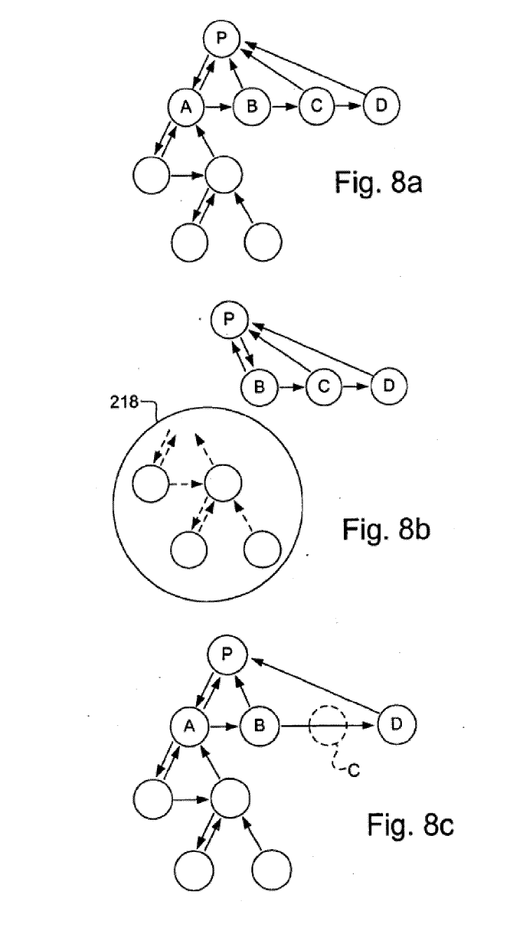

In FIG. 8, the process 136 “Delete Client From Tree” is illustrated in flow-diagram form. The process 136 begins at 200 and in a step 202, it is determined whether the target is equal to the left son. The “target” is, of course, the client to be deleted. If the target is the left son, a step 204 determines if there are other siblings. If not, the left son is deleted in a step 206. If there are other siblings, a step 208 makes the next sibling the left son, and then the left son is deleted by step 206. The process is then completed at 210. If step 202 determines that the left target is not equal to the left son, the target is found in a step 212, and is then deleted in a step 214. A step 216 then changes the sibling pointers, and the process is completed at 210.

FIGS. 8a-8c are several scenarios used to illustrate the process of FIG. 8. Assume that there is a tree structure as illustrated in FIG. 8a. If a node “A” (i.e. a client A) of FIG. 8a “s=disappears” all nodes (clients) 218 that used client A as a path to the server P are dropped from the network as illustrated in FIG. 8b. With reference again to FIG. 8a, if the node C disappears, the sibling B will simply reset its pointer to point to sibling D without any loss of service to any of the nodes. The lost nodes 218 of FIG. 8b will need to re-establish themselves into the network as previously described.

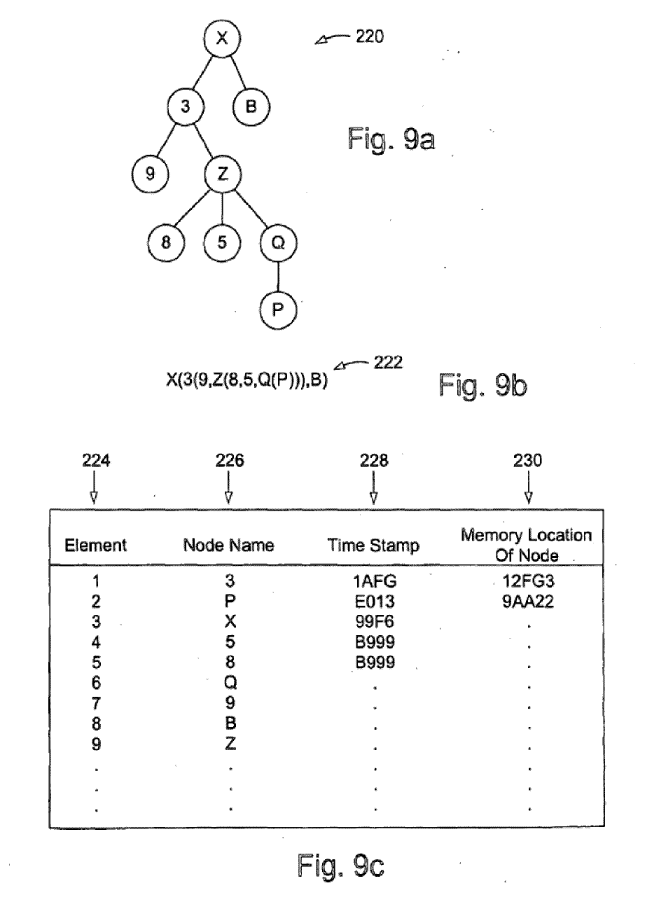

FIG. 9a is a tree structure that will be used to illustrate the step 134 “Place Network Tree In Client Transmit Buffer” of FIG. 6. Since the tree structure 220 is a logical construct, it must be represented in a form suitable for digital transmission. This form is illustrated in FIG. 9b as a string 222. With reference to both FIGS. 9a and 9b, the string 222 represents the tree on a top-to-bottom, left-to-right basis. Therefore the string 222 indicates for the parent X that its left son is 3 with a right sibling B. For the parent 3, there is a left son 9 with a right sibling Z. For the parent Z, there is a left son 8, a right sibling 5, and another right sibling Q. For the parent Q, there is a left son R. Therefore, the tree structure 220 has been completely and compactly represented by the notation of the string 222.

The converting of the trees to strings and the reverse is well known to those skilled in the art. In short, a left parenthesis in the string indicates that a left son follows, and a comma in the string indicates that a right sibling follows. For example, the aforementioned book SNOBOL 4: Techniques and Applications describe the process for converting trees to “prefix form” as described above, and vice versa. The aforementioned book ALGORITHMS IN SNOBOL 4 likewise describes the process.

While the tree structure 9a is useful for representing and traversing a tree data structure, it is not well-adapted for rapid searching for particular nodes. For this purpose, the table of FIG. 9c is created to implement fast searching and other housekeeping functions. In this illustration, the table of FIG. 9c includes four columns. The first column is the sequential element or “node” number, a second column 226 is the node name, the third column 228 includes the time stamp of the creation of the node, and the fourth column includes the actual physical memory location of the node. In this way, a particular node can be searched by element number, node name, time stamp, or memory location without resorting to the time consuming recursive search algorithms otherwise typically used to search tree structures.

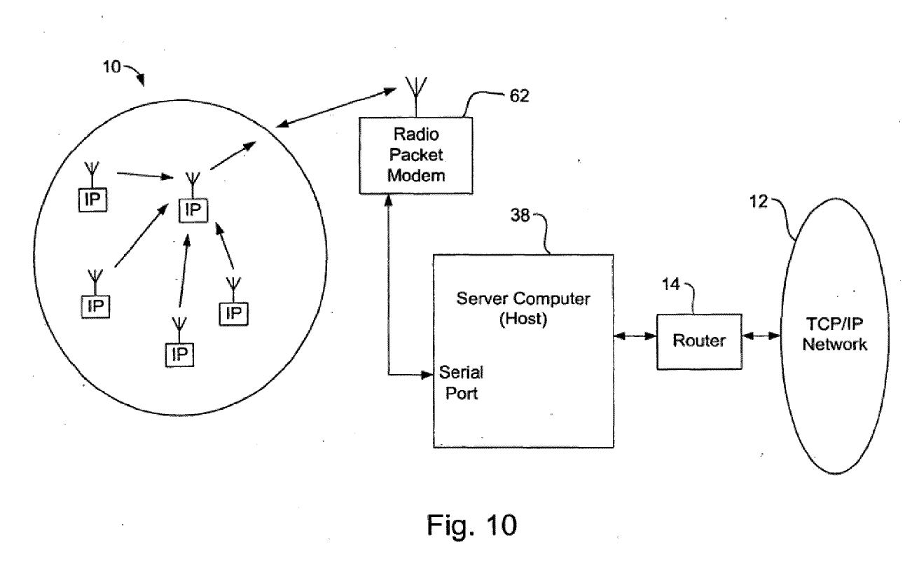

FIG. 10 is a pictorial representation of a portion of the server of FIG. 3 that has been simplified to explain steps 78 of FIG. 4 “Communicate With Network.” The exemplary wireless network system 10 may include a number of clients and, perhaps, other servers, each of which has its own IP address. The radio modems of those clients and servers communicate with radio modem 62 of the server which provides digital data to the serial port of a server computer or host 38. A router, bridge or other device is used to connect the server to a network, such as TCP/IP network 12. Of course the radio packet modem 62 and the server computer 38 can be considered part of the exemplary wireless network system 10 as described previously. The combination of the server and the router or the like performs a “gateway” function, in that it provides translation services between the two networks 10 and 12.

Referring back to FIG. 4 the step 76 “Send Packets” simply involves sending the data packets stored in the client transmit buffer to the network 10 through the radio modem 62. Likewise, and in a straightforward matter, the step 78 “Communicate With Network” simply forwards the data stored in the network transmit buffer to the network through the router 14 or through another route, such as the Ethernet interface 58. The “Send Packets” and “Communicate With Network” processes will be easily understood by those skilled in the art. Again, the server process control 72 allocates system resources among the processes 74-80 on a round-robin basis.

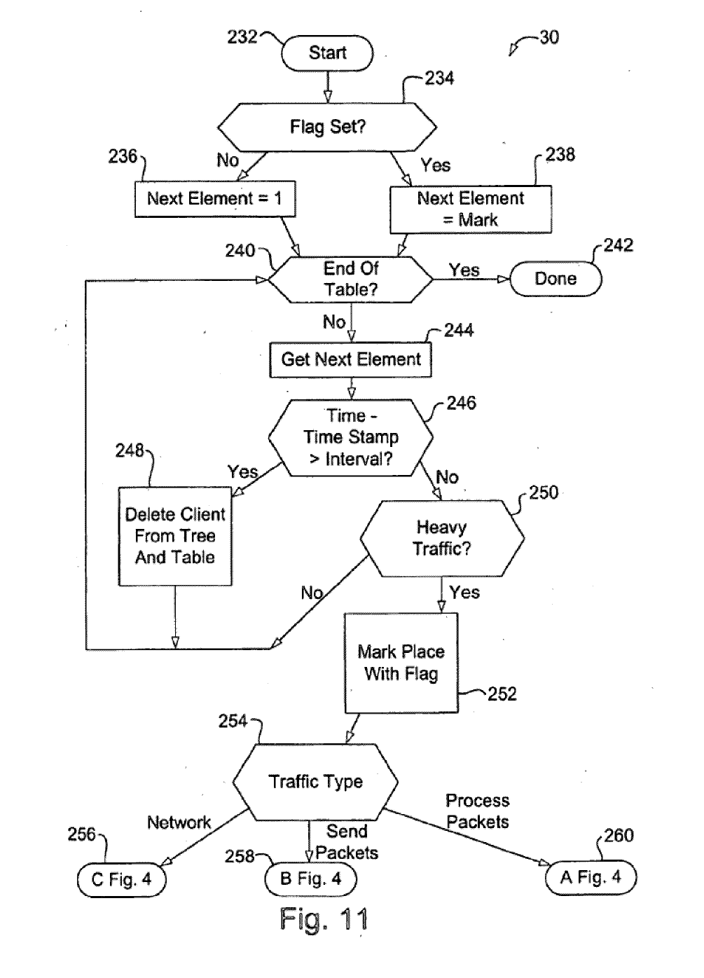

In FIG. 11, the exemplary housekeeping process 80 of FIG. 4 is illustrated in greater detail. Since the housekeeping function 80 is of generally less importance than the other function of process 70, it is possible that housekeeping function will be interrupted with a branch to one of function s 74, 76 and 78 of FIG. 4.

More particularly, in FIG. 11, the housekeeping function 80 of FIG. 4 is illustrated in greater detail. The process 80 begins at 232 and, in a decision step 234, it is determined whether a flag is set. If not, at step 236, the next element is equal to 1, i.e. it is picking the first element on the list. If step 234 determines that a flag is set, the process 80 knows that the housekeeping has been interrupted in the middle of the list and therefore the next element is set equal to the stored mark point as indicated in step 238. Next, a step 240 determines whether if the end of the table has been reached. If so, the process is completed at 242. If the of the end table has not been reached, the element retrieved in a step 244, and then in a step 246, it is determined whether the current time minus the time stamp is greater than a predetermined interval. If it is, a step 248 deletes the client from the tree and from the table. This step 248 is performed to ensure that a client node that has dropped out the network 10 without informing the server is deleted from the server tree at some point in time. A suitable interval may be 15 minutes, or any interval set by a network manager. Process control then returns to step 240.

If step 246 determines that a node (i.e., a client) corresponding to the next element has cheeked-in within the time INTERVAL, a step 250 determines whether there is a heavy traffic on the server. If not, process control is returned to step 240. If there is a heavy traffic, a step 252 marks the place in the table corresponding to the current element (i.e., the marked point in the list is stored in memory) and then a step 254 determines the traffic type. Process control then branches to process 256 if it is heavy network traffic, 258 if it is heavy outgoing packet traffic, and process 2600 if it is heavy incoming packet traffic.

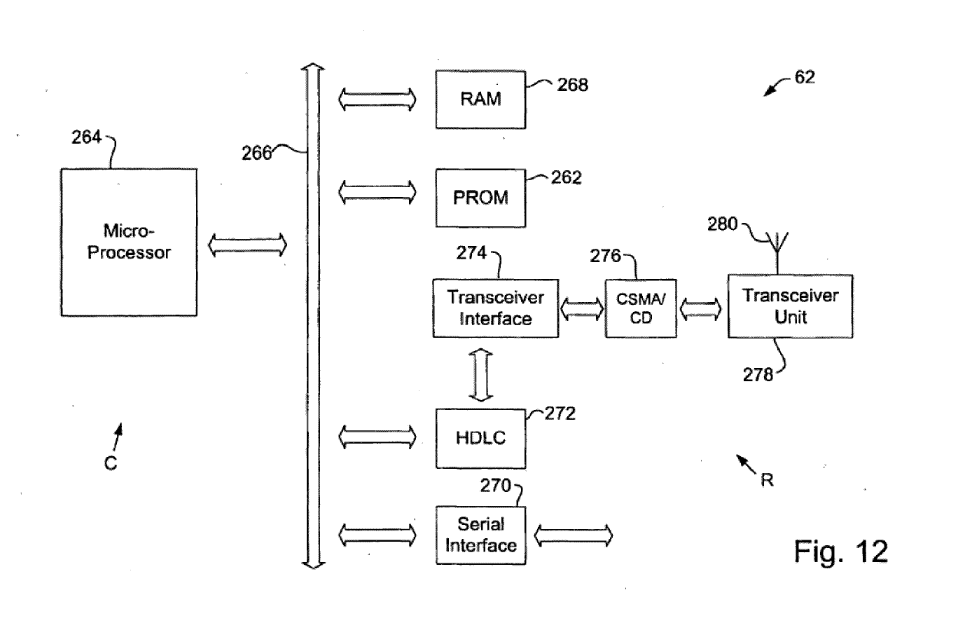

In FIG. 12, a radio modem 62 (which can be similar to all of the radio modems described herein) is illustrated in block diagram form. Again, the radio modem 62 is commercially available from GRE America, Inc. as the Gina spread spectrum radio modem, models 6000N-5 or 8000N-5. Spread spectrum technology gives good reliability and some transmission security in that a 127-bit cyclical code must be known by both the transmitting and receiving node. However, for true data security, encryption techniques, well known to those skilled in the art, should be used. Gina modems do include the option of 64-bit built-in encryption as an option.

It should be further noted that the Gina radio modem hardware can be modified to incorporate the server process (or the client process for the client radio modem) of the present invention by storing program steps implementing those processes into a ROM or programmable ROM (PROM) 262 of the radio modem 62.

The radio modem 62 includes a microprocessor 264 coupled to a bus 268. The microprocessor is an Intel 80C188 microprocessor in the present example. The PROM 262 (which currently stores 512 Kbytes of code) is coupled to the bus, as in RAM 268, a serial interface 270 and an HDLC converter 272. Coupled to the HDLC 272 interface is a transceiver interface 274, and coupled to the transceiver interface 274 is a CSMA/CD unit 276. A transceiver unit 278 with an antenna 280 is coupled to the CSMA/CD unit 276.

The devices 272 and 276 are used for error correction and noise cancellation, as will be appreciated by those skilled in the art. The CSMA/CD detects if two packets have “collided” producing indecipherable noise. If so, no acknowledgement of the packets is sent by radio modem 62 and the senders of the two packets will wait a short random period before resending their packets. Since the waiting period is random, there is little likelihood that the packets will collide a second time. The HDLC performs a checksum on the received packets and, if the checksum fails, this prevents the sending of the acknowledgement. This will cause the sending node to resend the packet after a random waiting period.

The currently used radio modems operate in the 902-908 MHZ frequency range at about 725 mW, and have an outdoor range of up to 12 miles, line-of-sight. These characteristics are a good compromise for a light to moderately dense network. If the network becomes very dense, it may be preferable to reduce the power, since this will reduce the number of clients that hear a given packet. Also, other frequency ranges are also suitable, such as the 2.404 to 2.478 GHz range.

The currently sold Gina spread spectrum radio models have their transmission (“baud”) rate artificially limited to 38.4 kHz. However, this artificial limit can be easily removed by a simple change to the program in PROM 262 to allow the modems to operate at 115.2 kHz, or nearly at full ISDN baud rates. At these baud rates, a single server can reasonably support three simultaneous WWW browser sessions and a dozen e-mail sessions. This compares very favorably to cellular networks which, as noted previously, can only support one user at the time.

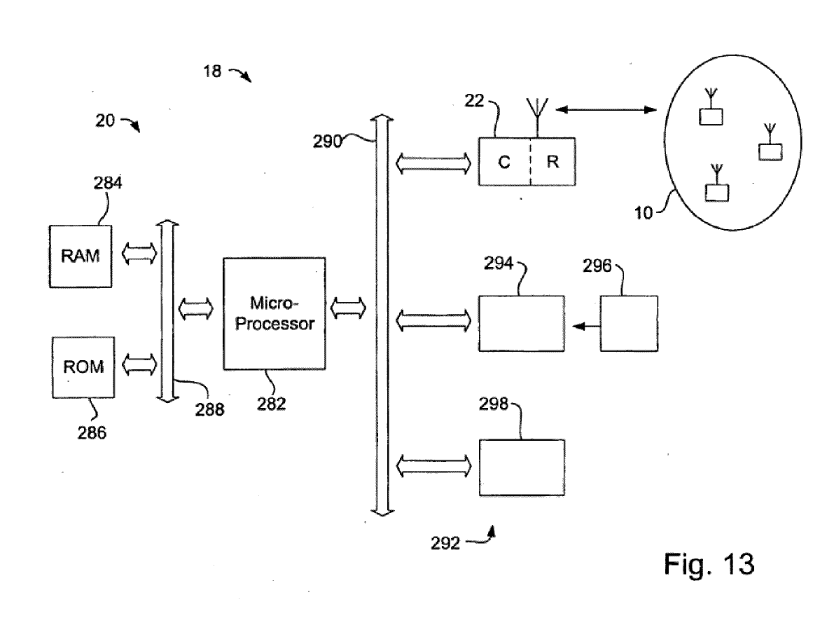

In FIG. 13, an exemplary client 18 including a computer 20 and a radio modem 22 of FIG. 1 is illustrated in greater detail. Again, the client computer 20 can be any suitable form of digital processor including personal compute, work station, PDA, etc. A computer 20 includes a microprocessor 282, RAM 284, and ROM 286. The microprocessor is coupled to the RAM 284 and the ROM 286 by a memory bus 288. The microprocessor 282 is also coupled to an input/output (I/O) bus 290 to which a number of peripherals 292 may be attached, including the radio modem 22. As before, the radio modem 22 includes a control C portion and a radio R portion, where the control portion of the radio modem 22 is coupled to the I/O bus 290. With brief reference to FIG. 12, the control portion C is everything but the transceiver unit 278 and the antenna 280, and the radio portion R corresponds to the transceiver unit 278. Also, as before, the client process running on the client 18 can run on the computer 20, in the control C portion of the modem 22, or partially on both processors. The client 18 typically includes other peripherals 292 such as a removable media drive 294 receptive to removable media 296, (such as a floppy disk or a CD ROM) and to a hard disk drive 298. Those skilled in the design of computer system will readily understand how the hardware of client 18 is assembled and used.

In some embodiments, uninterruptible power supplies and Global Positioning Systems (GPS) may be added to the client 18. The uninterruptible power supplies ensure that the clients stay on the network, and the GPS can be used in conjunction with directional antennas (such as phased array antennas) attached to the radio modem 22 to direct the transmission to the desired next node in the link. This increases the efficiency of the system, and reduces “packet pollution” of the network. The GPS unit can be coupled to I/O bus 290, or can be incorporated into the radio modem 22.

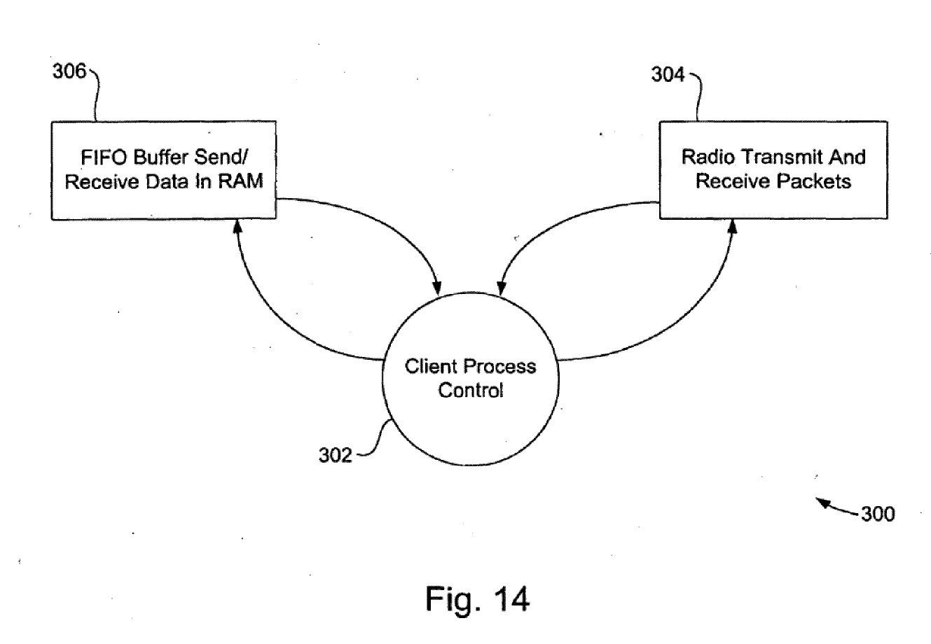

In FIG. 14, an exemplary client process 300 is implemented in the hardware of client 18. Again, this process can run on the microprocessor 282, or it can be partially or wholly run on the microprocessor of the controller C of the radio modem 22. In this exemplary embodiment, the process 300 runs on the computer portion 20 of the client 18. The client process 30 includes a client process control 302, a process 304 for radio transmitting and receiving data packet, and a process 306 for maintaining a first-in-first-out (FIFO) buffer for send and receive data packets in RAM 284 for the computer 20.

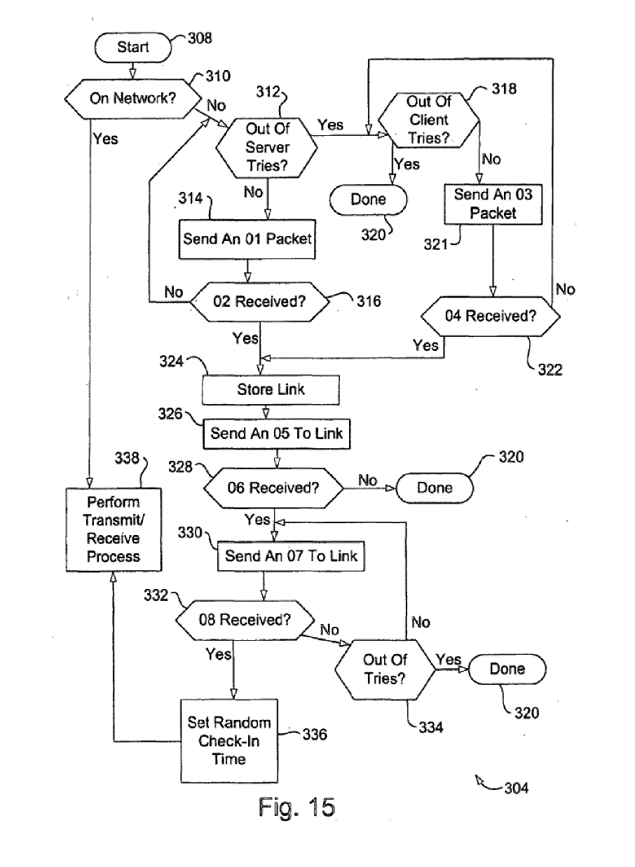

In FIG. 15, the exemplary process 304 of FIG. 14 is described in greater detail. The process 304 begins at 308 and, in a step 310; it is determined whether the client is on the network. If not, the client needs to get on the network before it can send data to the server. This connection process begins at 312 to determine whether it is out of tries in trying to reach the server. If not, it sends a 01 packet in a step 314 and waits to receive a 02 packet from the server or another client in a step 316. If it does not receive a 02 packet in response to 01 packet process control is returned to step 312 until it runs out of server tries. When it does run out of server tries, process control is turned over to step 318 which determines whether it is out of client tries. If yes, this particular client cannot reach either a server or another client and the process terminates at 320 with a failure. If it is not out of client tries in step 318, a 03 packet is sent in a step 321 and the client waits to receive a 04 from another client in a step 322. If a 04 is not received, the process control is returned to a step 318 until they are out of client tries.

If a 02 is received in a step 316 or a 04 is received in a step 322, then the client is in communication with the server or a client, respectively. In either instance, a step 324 stores the “link”, i.e., the path to a server, whether it is direct to the server or through one or more intermediate clients. Next, in a step 326, a 05 is sent to the link and a step 328 determines whether a 06 is returned. If not, the process is terminated as indicated at 320. If a 06 has been received, then a 07 is sent to the link in a step 330, and a step 332 determines whether a 08 is returned. If not, a step 334 determines if they are out of tries, and if not, process control is returned to step 330 to send another 07 to the link. If after a certain number of tries, e.g., 3 tries, a 08 is received in response to 07 transmitted by the client, the process terminates with a failure at step 320. If a 08 is received as determined by step 332, a random check-in time is set in a step 336. A random check-in time is set so that not all clients will try to check in with the server at the same time. Preferably, the random times will equally distribute the check-in times for the various clients equally within the aforementioned period INTERVAL. Finally, at this point, the client is connected into the network and the transmit/receive process is accomplished in a step 338. Of course, if the client was on the network as determined by step 310, the step 338 can be performed directly. The step 338 will be performed until there is a time-out of the transmit/receive process due to the round-robin scheduling by the client process control 302 (see FIG. 14).

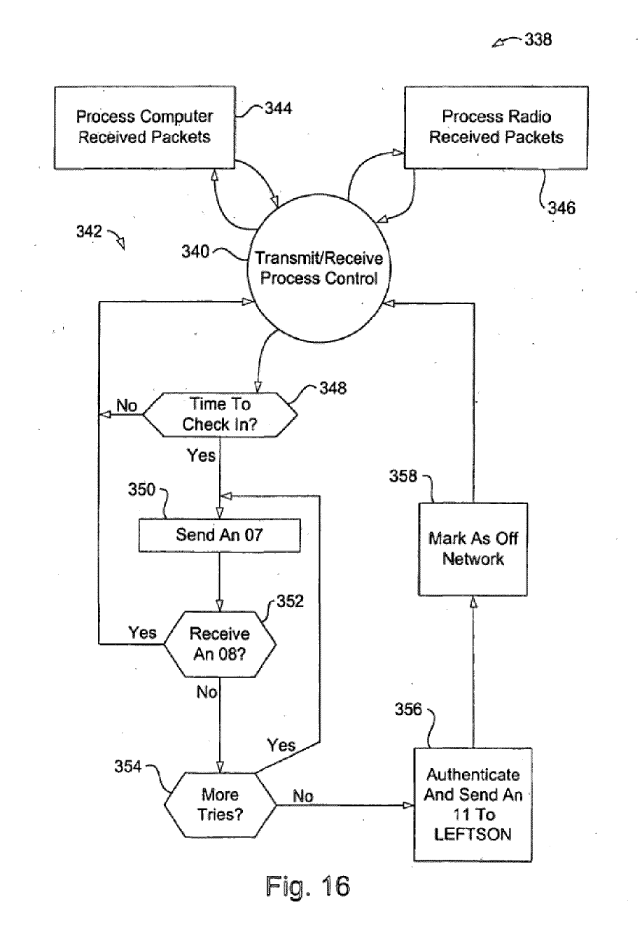

In FIG. 16, the process 338 “Perfom/Transmit/Receive” is illustrated in greater detail. The process 338 has a transmit/receive process control 340 and the three subprocesses 342, 344 and 346. Again, the time allocated to the various subprocesses on a round-robin basis.

The subprocess 342 is the check-in routine where the client is required to check in on a periodic basis with the server to avoid being dropped from the server's routing list. As noted previously, the check-in start time is essentially random, and is within a given period INTERVAL. More particularly, the subprocess 342 begins with a decision 348 as to whether it is the proper time to check-in. If not, process control is immediately returned to process control 340. If it is check-in time, a 07 is sent to the server. If a 08 is received from the server, all is well and process control is returned to process control 340. If the expected 08 is not received, decision step 354 determines if there are any more tries. Typically, at least three tries will be allowed. If there are more tries, process control is returned to step 350. If there aren't any more tries, a step 356 will authenticate and send an 11 to the left son of the client that the client is removing itself from the network. Authentication prevents the situation where a “promiscuous” spooler could masquerade as a client and transmit an “11” packet with downstream client addresses, thereby disconnecting those downstream clients from the network. The client then marks itself as being disconnected or “off” of the network in a step 358, and a process control is returned to process control 340.

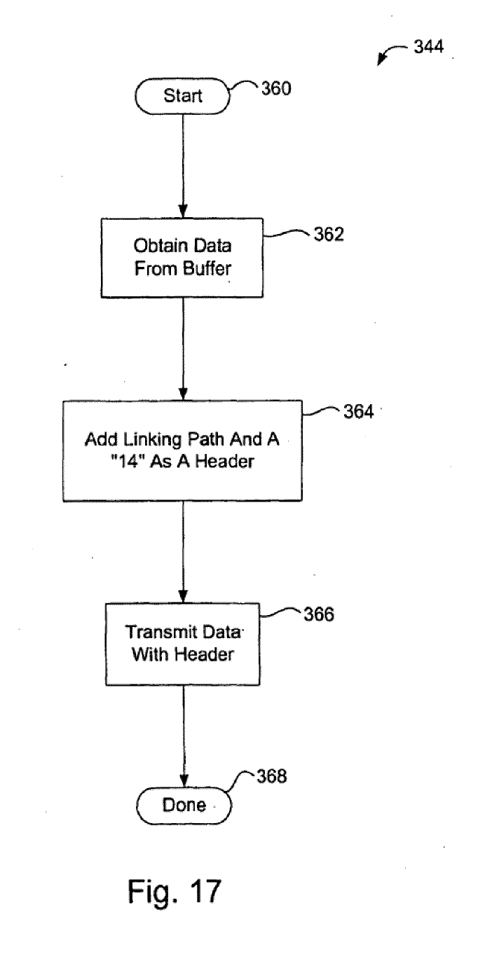

In FIG. 17, an exemplary process 344 “Computer Received Packets” is shown in flow diagram form. The process 344 begins at 360 and, in a step 362, the data is obtained from a buffer. Next, in a step 364, the header is added to the data including the link and the packet type “14” to indicate that this is a data-type data packet. Next, the data packet, complete with header, is transmitted in a step 366 and the process is completed at step 368.

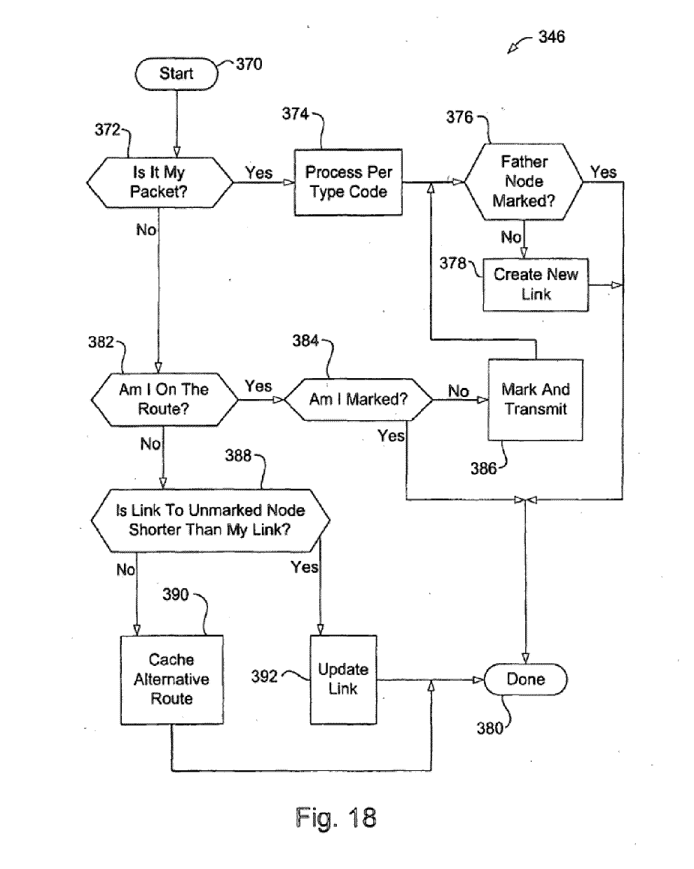

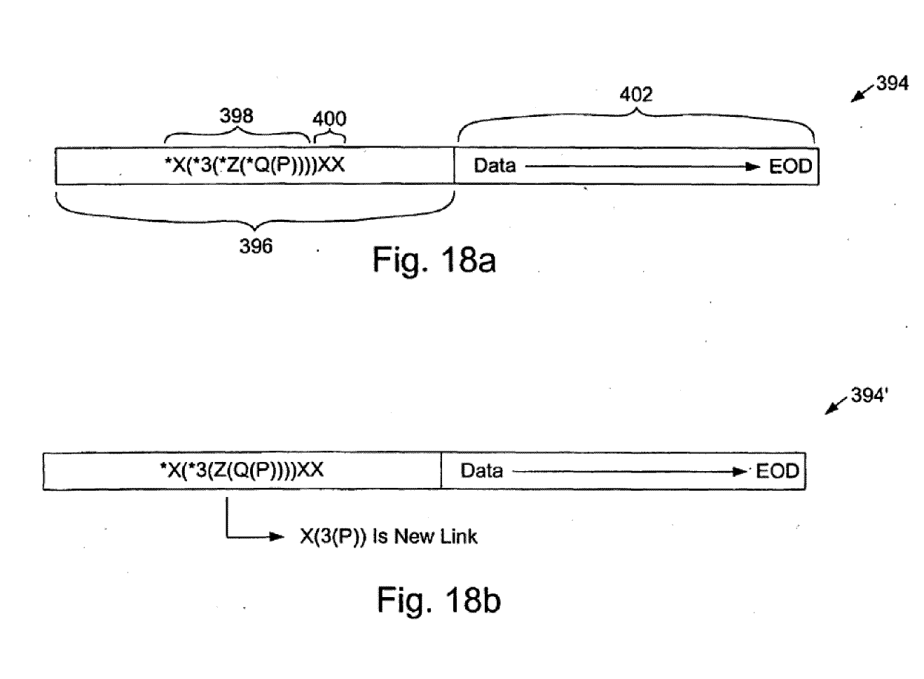

FIG. 18 illustrates an exemplary process 346 “Process Radio Packets” of FIG. 16 in greater detail. The process 346 begins at 370 and, in a step 372, determines if the received packet is for it. If yes, a step 374 will process the packet per the code type, as will be discussed in greater detail subsequently. Then, a step 376 determines if the father node of the client has been marked. If not, a new, shorter link is created, since the packet was received without being relayed by the father node. If the father node has been marked, or after a new link has been created, the process terminates at 380.

If step 372 determines that it is not that client's packet, a step 382 determines if that client is on the route for the packet. If yes, a step 384 tests to see if the client is marked. If it is marked, it has already sent that packet and the process is completed at 380. If the client hasn't been marked, it marks itself in the header of the data packet and transmits the packet in a step 386. Process control is then given to step 376 to see if the client's link can be upgraded as discussed previously.

If step 382 determines that the packet is not for that client, and that the client is not part of the link, steps 388-392 still analyze the packet in process known as “pooning”. Since this client can hear this packet, there is an opportunity to upgrade its link. Step 388 determines whether the link to the last marked node plus one (i.e. the distance to the first unmarked node) is shorter than its own link. This is because this client is listening to the last marked node, and the number of hops through that last marked node is the number of hops of that last marked node plus one. If it is, the client's link is updated in a step 392 to this shorter link. If not, the alternative route is cached in case the client's current link becomes inoperative. Therefore, in the pooning process, the client listens to all packets to continuously and dynamically update its link to the best possible path.

In FIG. 18a, an exemplary data packet 394 may include a header portion 396 including a link section 398 and a data type section 400, and a data portion 402. The link 398 indicates that the destination of this data packet is the node P. The two digit data type 400 indicates what type of data is being sent, and the data field 402 includes the actual data and is terminated within EOD (end of data) marker. This packet corresponds to the tree of FIG. 9a. Since all upstream nodes (i.e. nodes Q, Z, 3, and X) are marked with asterisk (“*”), it is known that the data packet has passed through and has been marked by each of these nodes before reaching the node P. If, however, the data packet 394′ of FIG. 18b is received where in only nodes X and 3 are marked, this means that the node 3 can hear the transmission of node (client) 3 directly. In this instance, there is no need to go through nodes Q and Z to reach server X. As a result, the new, upgraded link is from node P to node 3 to the server X. This is represented by the notation: X(3((P)).

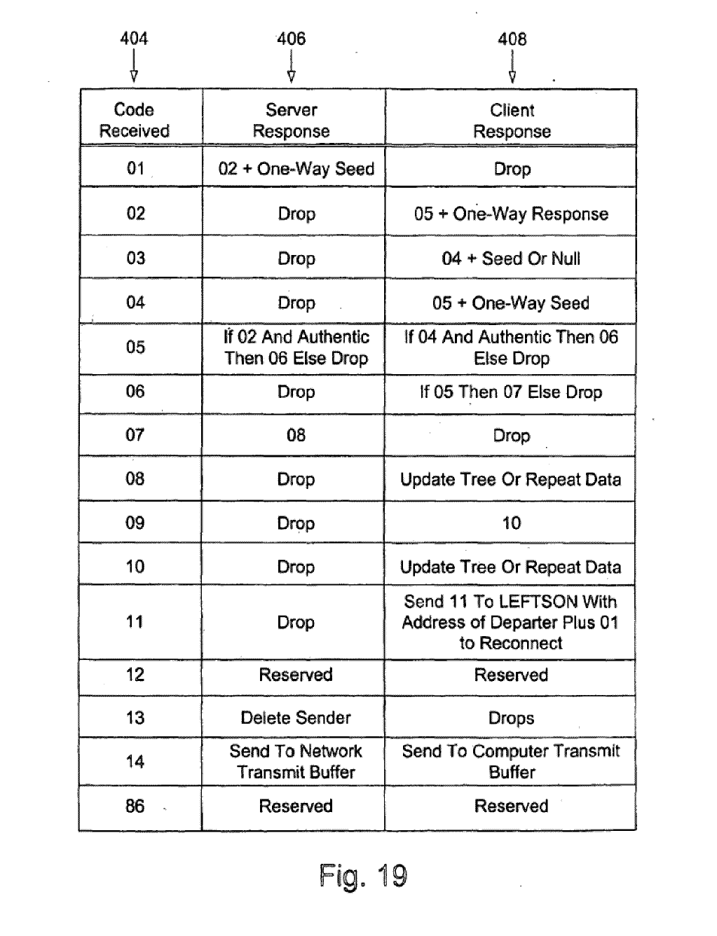

The table of FIG. 19 is used to illustrate an exemplary process “Process Per type Code” step 384 of FIG. 18. The table of FIG. 19 includes tree columns 404, 406, and 408. The first column 404, lists the codes that can be received. These codes correspond to the 2 byte code 400 of the data packet 394 of FIG. 18a. The second column 406 corresponds to the server responses to receiving such codes, and the third column 408 are the client responses to receiving the codes. We will now discuss each of the codes, in sequence.

When the server receives a 01 code its response is 02 code plus a one-way seed as discussed previously. Since 01 code is never intended for a client, it will ignore or “drop” the 01 coded data packets.

For the 02, 03 and 04 codes, the server will ignore or drop those data packets because these data packets are only intended for clients. If a client receives a 02, it responds with a 05 and a one-way response. In response to a 03, a client will send a 04 and a seed or a null. In response to a 04, the client will send a 05 and a one-way seed. Again, one-way seeds and responses to one-way seeds were discussed previously.

When a server receives a 05, if it has previously sent a 02 and if the 05 is authentic, then it will send a 06. Otherwise, it will drop the packet. When a client receives a 05, if it had previously sent a 04, and if the 05 is authentic, then it sends a 06. Otherwise, the client will drop the data packet. If the server receives a 06, it will drop the data packet. If a client receives a 06 after it sent a 05, then it will send a 07. Otherwise, it will drop the packet as well.

When a 07 is received from the server, it will immediately respond with a 08. Since 07 coded packets are never intended for clients, it will be dropped.

Data packets coded with an 08, 09, 10 or 11 are all dropped if received by a server. If a client receives a 08, it will update the tree or repeat the data. In response to a 09, a client will send a 10. In response to a 10, a client will update the tremor repeat the data. In response to a type 11, it sends an 11 to the left son with the address the departing node plus a 01 to reconnect to the network.

Data packets of type 12 and 86 are currently reserved. In response to a data packet type 13, a server will delete the sender. Since this is a server destination data packet only, if a client receives a data packet of type 13, it will drop the data packet.

Finally, if a server receives a data packet of type 14, it will send it to the network transmit buffer. If a client receives a data packet of type 14, it will send it to the computer transmit buffer.

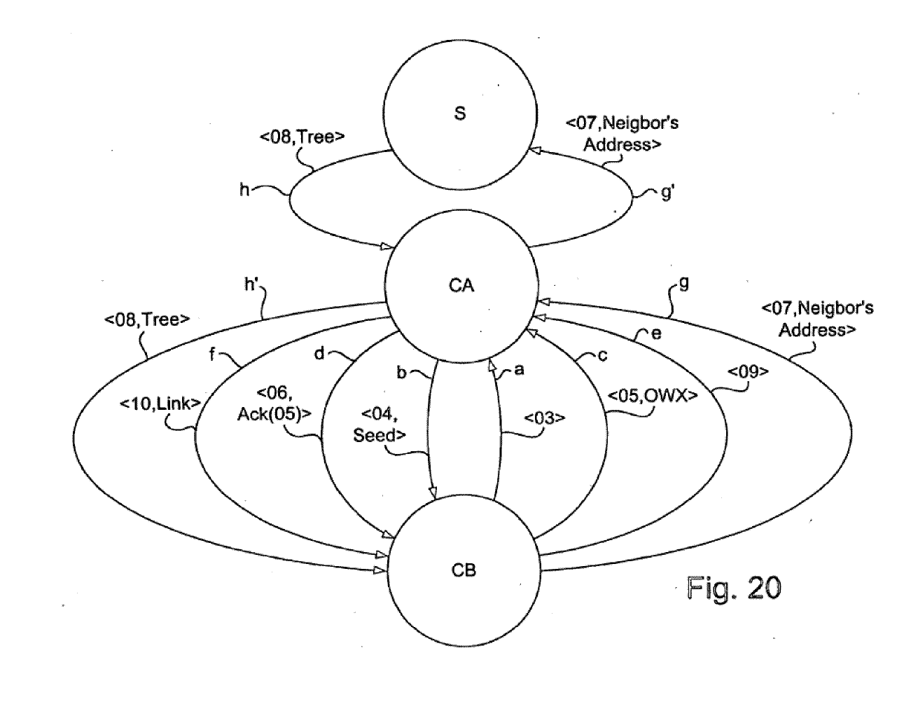

FIG. 20 illustrates an initialization routine which connects the client CB to a server S through another client CA. The sequence is a s follows. As indicated by arrow a, client CB sends a 03 to client CA. In return, the client CA sends a 04 and a seed back to client CB as indicated by arrow b. Client CB then sends a 05 and a one-way response as indicated by arrow c to client CA, and client CA sends a 06 and an acknowledgement with a 05 to a client CD as indicated by arrow d. Then, client CB sends a 09 to client CA as indicated by arrow d. Then, client CB sends a 09 to a client CA as indicated by arrow e, and client CA sends a 10 and the link to the client CB as indicated by arrow f. Client CB then sends a 07 and the neighbor's addresses to the client CA as indicated by arrow g, and client CA relays the 07 and the neighbor's address to the server S as indicated by arrow g′. The server S, then sends a 08 and the tree to the client CA as indicated by arrow h, and the client CA relays the 08 and the tree to the client CB as indicated by arrow h′. At this point, the client CB has the link tree to the server S and the complete tree of the network in its memory.

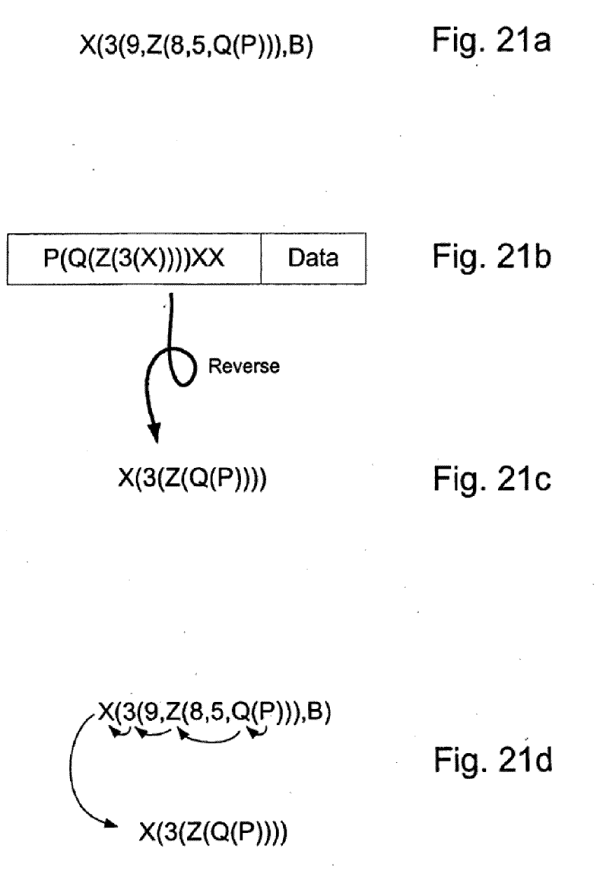

FIGS. 21a-21d illustrate a portion of the server process which deals with determining a return path from a received data packet at a server. Assume, for example, the tree is known to the server is as illustrated in FIG. 21a. this is the same tree as was illustrated in an example of FIGS. 9a and 9b. Then, assume that the server X receives the data packet from a client P as illustrated in FIG. 21b. The simplest way of determining the reverse address is simply reverse the link section of the header portion of the data packet of FIG. 21b to provide a return address of 21c. However, if the part of the address of the header of the data packet of FIG. 21b has been lost of corrupted during the transition process, the tree of FIG. 21a can be used to reconstruct the return path. This is accomplished by jumping from parent to parent in reverse order as indicated to determine the return path. In this example, the reverse order parent jumping indicates that the original path to the server X was P>Q>Z>3>X, which, when reversed, gives us the proper reverse path, namely X(3(Z(Q(P)))). As will be appreciated by those skilled in the art, this type of reverse tree transversal is easily accomplished with a recursive function.

According to some exemplary embodiments, clients and servers may implement dual wireless interfaces to increase throughput between a source node and destination node. As described thus far, the client nodes and server nodes implement a single transceiver and interface, or a single-wireless interface. One inherent disadvantage of the single wireless interface may be a significant reduction in bandwidth per node in a transmission link. Specifically, transmitting data packets from a source node through one or more repeater nodes to a destination node may effectively reduce the bandwidth by one-half per node. As a consequence, for example, as applied to the widely used 802.11b interface, no more than three repeater nodes may be able to operate between a source node and a destination node without noticeable throughput loss to the destination node.

To minimize this possible limitation, servers and clients may, in some embodiments, implement dual wireless interfaces. Accordingly, at least some nodes may include a first source wireless interface and a second source wireless interface, one for receiving data packets and the other for simultaneously transmitting data packets. As indicated previously, a “node” as used herein refers to either to a client or a server. Where these nodes implement a hardware or software control that operates according to the conventions described below, this arrangement may allow a wireless network to achieve near 100% bandwidth through each repeater node. Accordingly, at least some examples of dual-wireless interfaces described herein may significantly reduce practical limits on the number of repeater nodes and, consequently, the number of hops between a source node and a destination node.

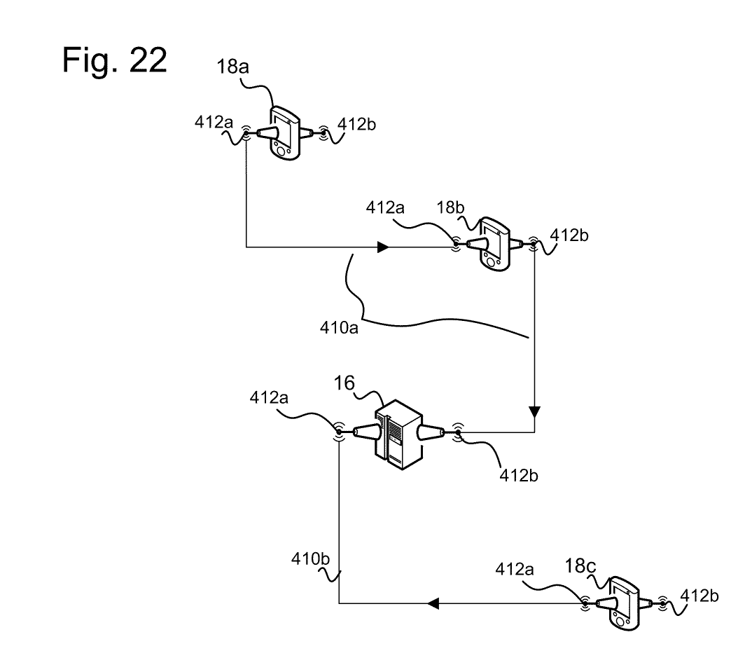

For example, FIG. 22 depicts an exemplary wireless network including transmission paths between a series of nodes in which at least some of the nodes (e.g., each node) implements a dual wireless interface. This exemplary system includes three clients 18a, 18b, and 18c; a server 16; and two transmission paths 410a and 410b. Path 410a carries data initiated at client 18a and destined for server 16, while path 410b carries data initiated at client 18c and destined for server 16. Accordingly, with respect to the illustrated paths, 410a and 410b, clients 18a and 18b act as source nodes. And in each path, server 16 acts as a destination node. In addition, the first transmission path 410a contains a repeater node, client 18b, between the source and destination. Therefore, data packets traversing the path 410a between source client 18a and the destination server 16 have a two-hop route. And data packets traversing the path 410b between client 18c and the destination server 16 have a one-hop route.

To achieve near 100% throughput, for example, the network nodes may implement a controller configured to serve as a dispatcher in each node. To that end, the dispatcher may, in some embodiments, operate to route data packets according to the conventions described herein. One should note that any node in a wireless network system may, at times, act as a source, a repeater, and/or a destination node, depending on its function within a given transmission path. Thus, as used herein, a node acting as a source at a given time operates in “source mode,” a node acting as a repeater operates in “repeater mode,” and a node acting as a destination operates in “destination mode.” Further, because nodes may undergo frequent mode changes as data transmissions flow to and from network nodes, the control conventions described with reference to the example network of FIG. 22 should be viewed as applying to a particular “snapshot” in time.

In the case of a source node, for example, the controller may be configured, so that the dispatcher designates one of a node's wireless interfaces as the source from which it initiates all data transmissions. For example, in FIG. 22, source node 18a has designated wireless interface 412a as the source wireless interface. Accordingly, all data transmissions originating from the client 18a, when acting in source mode, transmit from wireless interface 412a of client 18a. In this example, client 18a initiates a data transmission from wireless interface 412a to repeater client 18b over the first hop along transmission path 410a. Moreover, according to this convention, the dispatcher operates to ensure that all other data transmissions from client 18a initiate from the same wireless interface 412a, and the dispatcher correspondingly operates to ensure data transmissions do not initiate from the client's other wireless interface 412b.

In the case of a repeater node, the controller may be configured so that the dispatcher allows the node to receive data packets on either of its two wireless interfaces and retransmit the data on the other of its two wireless interfaces. With reference again to FIG. 22, client 18b acts as a repeater node, receiving incoming data packets from source client 18a over the first hop of transmission path 410a and retransmitting them to the destination node, server 16, on the second hop along transmission path 410a. In this case, because repeater node, client 18b, received data packets on its wireless interface 412a, the dispatcher operates to retransmit the data packets on the other of client 18b's wireless interfaces 412b. It is important to note that the dispatcher routes the data in this manner, regardless of any designation the dispatcher has otherwise assigned to client 18b's wireless interfaces 412a and 412b. In other words, as described above, the client 18b's dispatcher may have assigned interface 412b as the source wireless interface. That designation, however, applies only when the client 18b acts in source mode. As a result, when wireless client 18b operates in repeater mode, it repeats data transmissions on either of its wireless interfaces, which interface is determined as the wireless interface other than that on which the client received the transmission.

In the case of a destination node, the controller may be configured to allow a node to receive transmissions on either of a node's two wireless interfaces. Thus, the dispatcher may operate to allow a node acting in destination mode to receive data packets continuously on both of its wireless interfaces. For example, in FIG. 22, server 16 acts in destination mode, receiving two simultaneous and continuous data transmissions from two sources, client 18b and client 18c. On server 16's wireless interface 412a, it receives a transmission initiated at client 18c and transmitted along the one-hop path 410b. Simultaneously, server 16 receives on its wireless interface 412b a transmission from client 18b along the second hop of path 410a. In this manner, the destination node may maintain near 100% throughput.

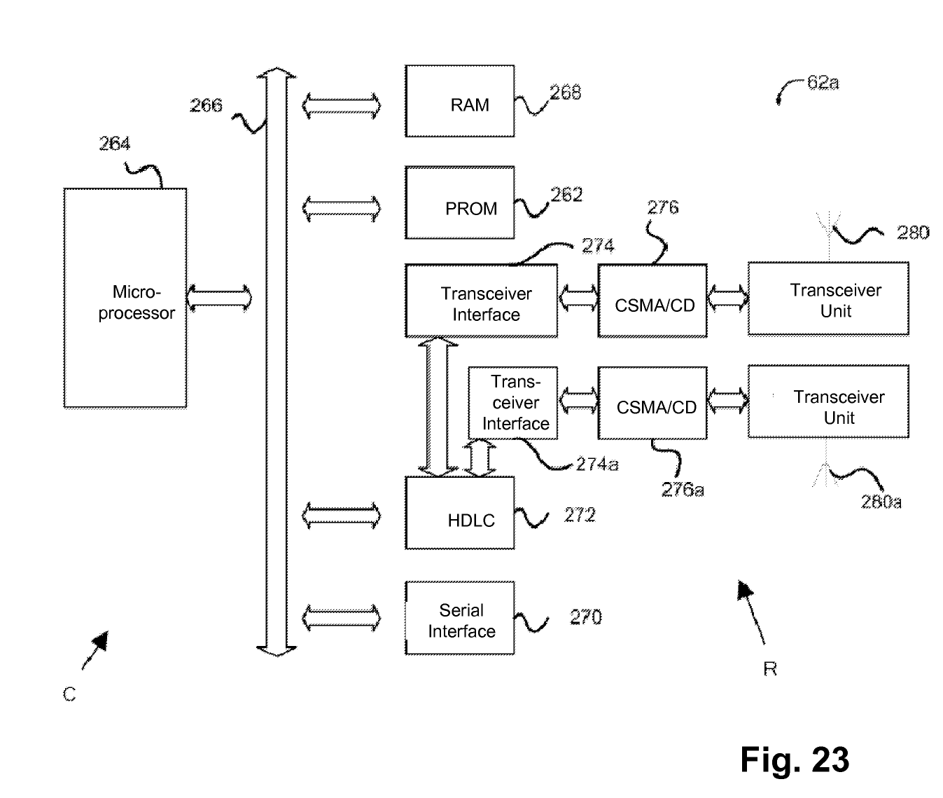

FIG. 23 illustrates a block diagram of one possible configuration of a radio modem implementing a dual-wireless interface. This may be accomplished, in one respect, by modifying a radio modem at least similar to the radio modem 62 of the previously described client of FIG. 13 to resemble radio modem 62a as shown in FIG. 23. The radio modem 62a, illustrated in block diagram form, may incorporate a second transceiver unit 280a, CSMA/CD 276a, and transceiver interface 274a. In this manner, the hardware may support the simultaneous receipt and transmission of data packets as described, by receiving incoming packets at a first transceiver unit 280 and retransmitting outgoing packets on a second transceiver unit 280a. Further, the radio modem hardware may incorporate the controller by storing the logic of the above-described conventions into a ROM or programmable ROM (PROM) 262 of the radio modem.

In yet another aspect, the wireless network may comprise a satellite constellation in order to extend a wireless network and/or facilitate access to the Internet to remote users. As described herein, such an embodiment is referred to as a “satellite-based wireless network.” Such a system may be viewed as an extension into three dimensions of the terrestrial wireless network described above. In the described exemplary satellite-based system, data transmissions initiated on earth route through one or more satellites before making their way to a server located at earth (an “earth station server” or “ESS”) and passing into a secondary network, such as the Internet. Therefore, in the satellite-based system, satellites may operate in a client mode and may serve as repeater nodes of a transmission link. A satellite may be any communications device in the earth's atmosphere or orbit including, but not limited to, for example, a low-earth orbit satellite (LEO), mid-earth orbit satellites (MEO), a geosynchronous satellite (GEO), a zeppelin (e.g., a stationary zeppelin), a blimp, or a high-altitude balloon.

Extending the routing scheme described above for a terrestrial network, however, may require additional control due to the possible complications introduced by extending the network into three dimensions, e.g., by adding satellite clients to the network. These complications have made achieving, for example, TCP/IP capable routers on board satellites a significant hurdle for extending broadband wireless internet through the use of orbiting satellite routers and/or other conventional technologies. In one respect, using a constellation of LEO satellites to route data packets may advantageously avoid many latency-associated difficulties that arise in satellite implementations employing other types of satellites such as GEO satellites and MEO satellites, which require data packets to travel relatively greater distances. MEOs, for example, orbit between approximately 5,000 km and 10,000 km, and GEOs orbit at approximately 35,786 km above the earth's surface. While LEOs avoid many latency-related problems, however, they may introduce a host of other problems due to their orbital proximity to the earth's surface. Namely, LEOs' orbital proximity (within approximately 2,000 km of the earth's surface) causes them to travel with a greater degree of motion'relative to clients located at the earth's surface (terrestrial clients). Therefore, wireless networks employing LEOs may need to account for additional mobility-related challenges to successfully implement a satellite-based broadband network using, for example, TCP/IP.

Accordingly, one practical challenge of achieving TCP/IP routing in a LEO constellation may be acquiring and maintaining a virtual circuit among, for example, a terrestrial client (“TC”), a LEO satellite, and earth station server (ESS). Significantly, the routing strategies implemented by the wireless network may greatly affect the overall performance of TCP communications carried across a satellite-based network. Accordingly, it may be desirable to provide a novel handoff scheme that enables TCP/IP routing on board a LEO satellite by providing a method that mitigates or overcomes at least some of the complexities of maintaining a virtual circuit from a TC and ESS through one or more LEO satellites.

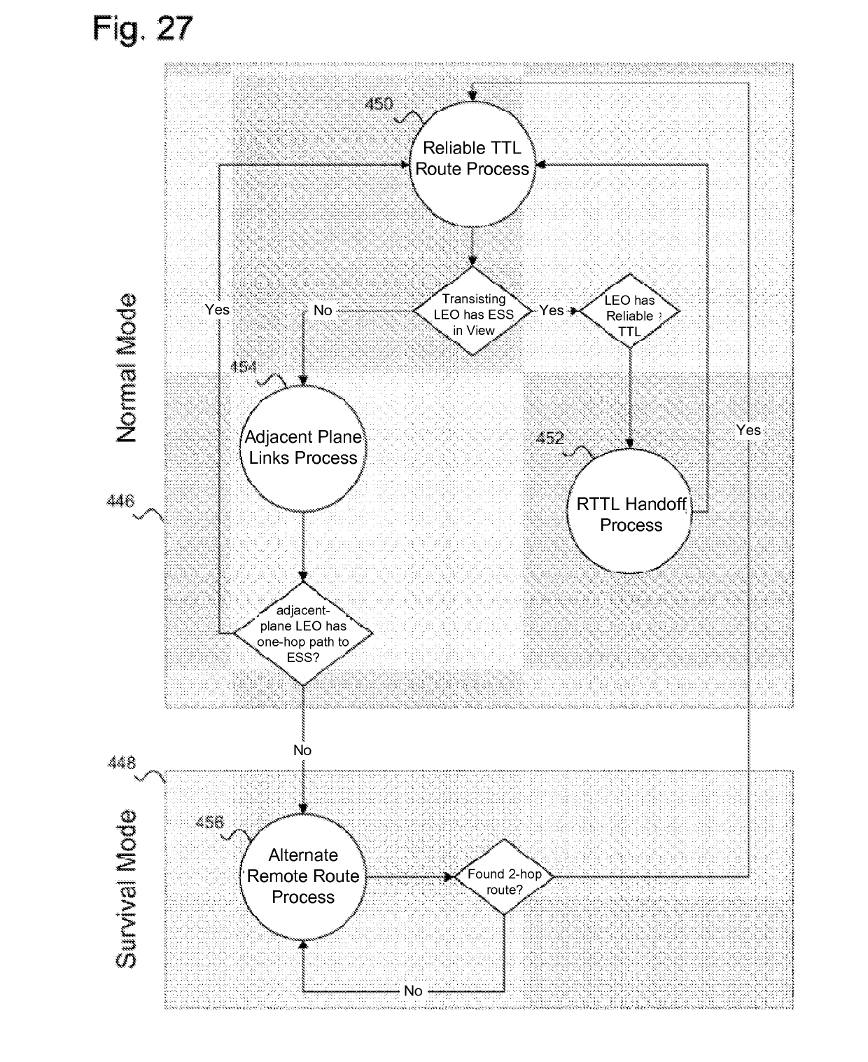

The exemplary methods outlined below may accomplish this routing scheme via two operational modes, which are illustrated in FIG. 27: normal mode 446 and survival mode 448. Normal mode 446 may include a set of network processes that perform a data packet routing scheme when a requisite number of satellite-clients and earth station servers are operable, so that each of the TCs in the wireless network is able to build an optimal two-hop route to an ESS through an in-view LEO. Survival Mode 488, on the other hand, describes an optimal routing scheme adopted when, for example, a TC cannot find an optimal two-hop route to an ESS through an overhead LEO, but instead must revert to a constellation-wide mesh routing scheme to find an alternative optimal route through a plurality of LEO satellites. Several exemplary processes that may be implemented to achieve this desired operation are described in more detail below.

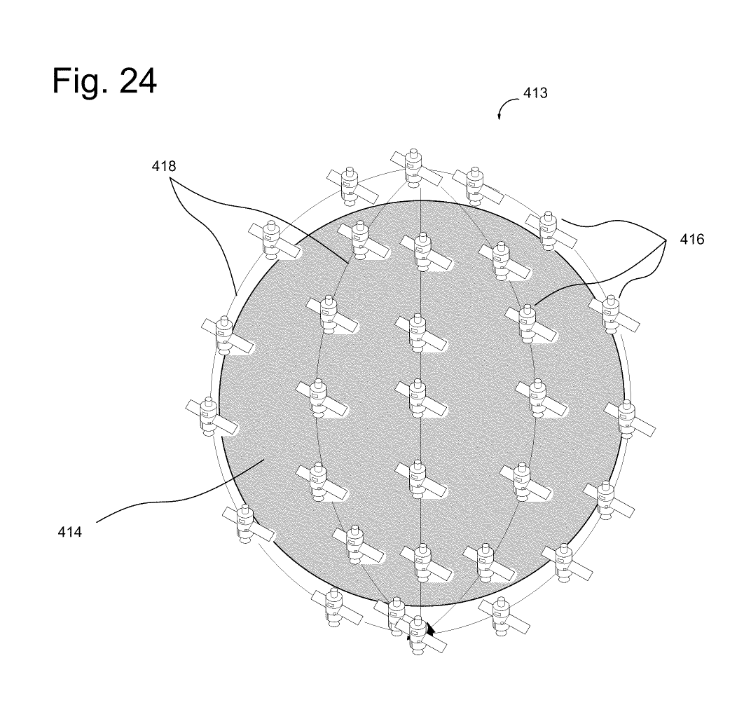

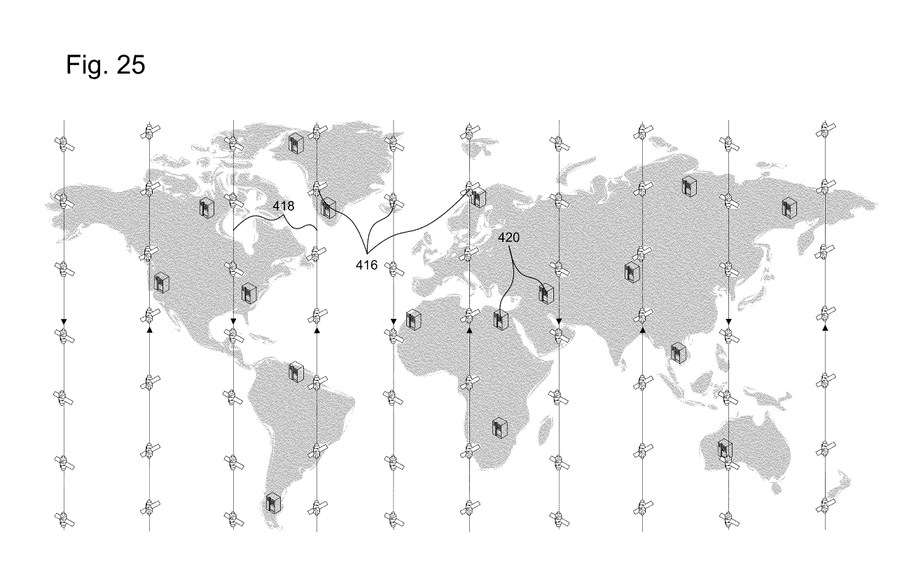

FIG. 24 and FIG. 25 depict an exemplary. LEO constellation 413 that represents one possible arrangement for use in the described wireless network system. The illustrated constellation 413 may include, for example, seventy LEO satellites 416 traveling in polar orbit of the earth 414 at an escape velocity of approximately 17,000 miles per hour. The seventy satellites may be distributed among five orbital paths 418 collocated approximately five thousand miles apart at the equator. Accordingly, there are fourteen, approximately evenly distributed, satellites per orbital plane. Satellites travel along these planes in a longitudinal trajectory, moving from north to south over the horizon in one half orbit and from south to north in the other.

As illustrated in FIG. 25, the network may further include a number of ESSs 420 distributed on the earth's surface. As used herein, terms such as “earth,” “earth's surface,” “terrestrial,” “earth-based,” and similar terms, are used in a relative manner. For example, these terms are used to distinguish from altitudes associated with the satellites. Thus, these terms may not necessarily imply being attached to the ground or in a fixed position.

In the exemplary embodiment shown in FIG. 25, earth station servers may be collocated some five thousand miles apart. With this arrangement, the LEOs of this exemplary constellation have statistically three ESSs 420 in view at any given time. As used herein, a client or server is said to be “in view” when it is in communication range of another given client or server. Further, because each transition path consists of a single ESS 420, which serves as a destination node, second and third in-view ESSs 420 provide redundancy.

The following paragraphs explain in greater detail some exemplary systems and methods that may be used to support the above-described LEO handoffs while maintaining a substantially stable virtual circuit between the TC and ESS. These methods may comprise two operational modes: normal mode and survival mode. (See, e.g., FIG. 27.) In one aspect, a normal mode provides a novel handoff scheme that may be employed in an operational satellite-based wireless network. And, in another aspect, a survival mode provides countermeasures that may be desirable for maintaining a survivable network in the event that one or more clients or earth station servers is rendered inoperable, such as in the event of a global, catastrophic event. Together, these methods may address at least some of the complexities of extending a terrestrial network to a satellite-based wireless network.

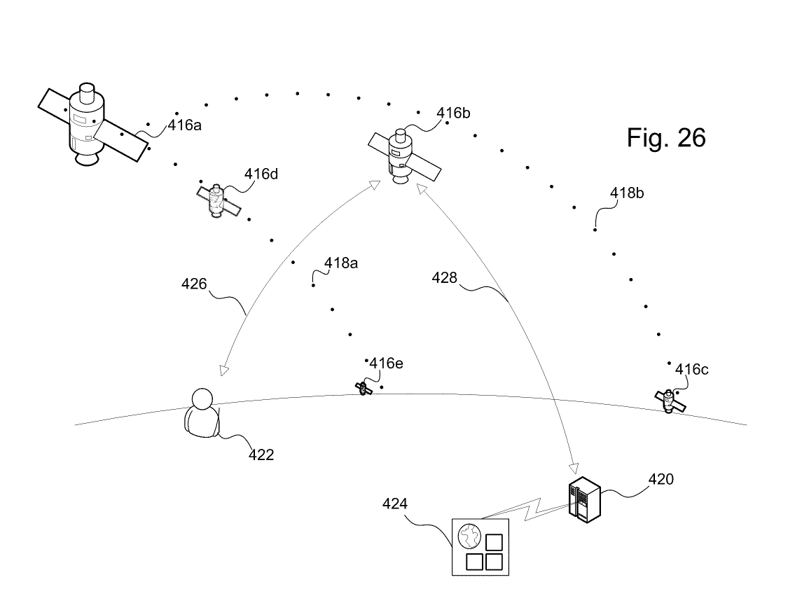

FIG. 26 illustrates a LEO satellite-based system operating in an exemplary normal mode. According to this operational mode, the transmission path between the source node and destination node may contain a total of two hops and only one “satellite hop” through a satellite client. As shown in FIG. 26, an exemplary data communication initiates at a TC 422 acting in source mode. TC 422 may be a client located at earth and may be mobile or stationary. Data packets transmitted from TC 422 may ultimately seek a destination on a second network 424, such as the Internet. The second network may interface to the wireless network at a gateway of an ESS 420. For this reason, the ESS 420 may serve as the destination node in the transmission path from the TC 422. LEOs 416 travel overhead relative to the TC 422 in polar orbit. LEOs 416a, 416b, and 416c orbit in a “local plane,” and LEOs 416d and 416e orbit in an “adjacent,” “remote” plane. Assuming an operational satellite constellation, such as the described exemplary LEO constellation, the TC 422 statistically will have three LEOs in view at any given time. For example, as shown in FIG. 26, local-plane LEOs 416a and 416b, and adjacent-plane LEO 416d are located most proximately overhead the TC 422.

By the exemplary process described in detail below, the TC 422 will therefore build a route to the ESS 420 along a two-hop route comprising a first-hop 426 and a second-hop 428. For reasons described in more detail below, the TC will advantageously favor a route through a local-plane LEO over a remote-plane LEO due to the reliability and predictability of the local-plane LEO's time-to-live overhead. Accordingly, LEO 416b receives data transmissions from the TC 422 on its uplink frequency over the first hop 426 in the transmission path and repeats it on its downlink frequency to the earth station server over the second link in transmission path 428. Because it may be assumed that the transmitted data packets contain TCP/IP structure, the earth station server need not perform any translation before passing the data packets on to a secondary network, for example, the Internet 424.

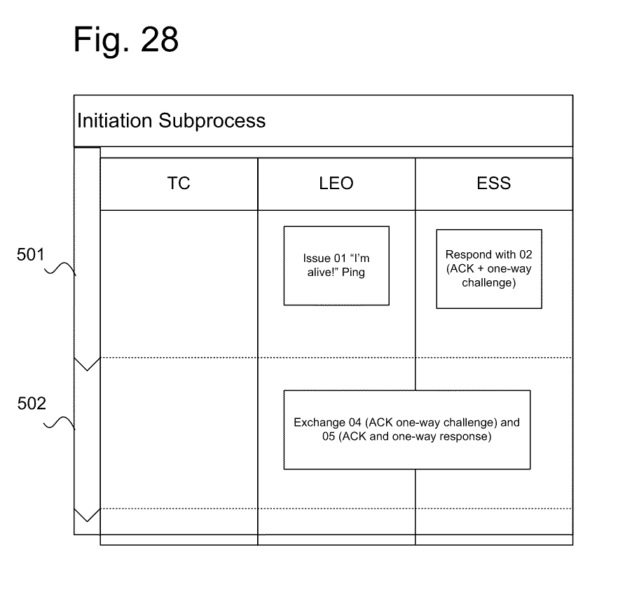

FIGS. 28-34 illustrate the described exemplary processes in chart form as a series of steps that take place in vertical, sequential order from top-to-bottom and execute at one or more TC, LEO, and ESS, as designated by vertical columns and according to the following description.

As used herein, a “mesh network” refers to a network that may allow for continuous connections and reconfiguration around broken or blocked paths by “hopping” from node to node until the destination is reached. In a terrestrial mesh network such as the exemplary ones described previously herein, for example, a route between a client and server and passing through one or more other clients will likely persist. In that case, alternative routes merely serve as an option to resolve the unlikely contingency that one or more nodes in the link between a source and destination becomes unavailable.

In contrast, LEO clients travel a great degree more with respect to the earth and, consequently, to terrestrial clients. As a result, each LEO remains overhead and in range of a terrestrial client for a limited time as it rises above the horizon and a short time later, falls below the opposite horizon, for example. This limited time a LEO spends in view above the horizon is hereafter referred to as a LEO's “time-to-live” (TTL). Because a satellite-based mesh contains routes through at least one LEO client, the TTL of each LEO repeater along the route introduces a necessary handoff. In this sense, a “handoff” refers to replacing a LEO client in an existing route with another LEO client in order to maintain a virtual circuit between the source and destination nodes. Due to the frequency of such handoffs, route maintenance in a satellite-based mesh may be a relatively more complex process than the process associated with a terrestrial network.

In one aspect, therefore, meshing in a satellite-based wireless system may result in implementing a route discovery and maintenance process that differs from a routing scheme associated with a terrestrial mesh network. For example, if route discovery in a satellite-based network were to begin as with a terrestrial network, as described in the exemplary embodiments above, the satellite-based route discovery process might be much less stable than the terrestrial route discovery process. Assuming, as before, an ESS maintains an in-memory tree of all of the clients that it is serving, once a TC has discovered a LEO through which to route, via an exchange of 03 and 06 packets, respectively, the TC and LEO would exchange 09 and 10 packets. Upon receiving the 10 packet, the TC (a) converts the payload data string of said 10 packet into its own in-memory tree, (b) finds its own address in said tree, and (c) counts the number of hops between it and the address of the server at the top of said tree. At this point in time, however, the route through the LEO would be unreliable due to the uncertainty of the new LEO's TTL. Moreover, randomly discovering other LEOs as potential alternate routes as in a terrestrial network may exacerbate the problem by forcing handoffs to other LEOs with unpredictable TTLs, thus making the network functional, but possibly unstable—requiring an unpredictable number of handoffs.

Accordingly, the Initiation Subprocess of FIG. 28, begins a slower, but more stable, route discovery process initiated by a LEO. This exemplary subprocess is one of four underlying sub-processes that may be performed at particular steps within the major exemplary processes described below. By this subprocess, a LEO constantly searches and identifies in-view ESSs.

Table 1 below provides a description of the exemplary data packet types referred to in the following description. At a step 501, a LEO issues a 01 (I′m Alive!, ping) packet at short random intervals and receives in return a 02 (Server ACK from 01 followed by one-way challenge) from an in-view ESS. And, in a step 502, the ESS and LEO exchange 04 (Client ACK from 03 followed by one-way challenge) and 05 (ACK followed by one-way response to 04) packets for authentication.

TABLE 1

| Packet | Description |
|---|---|
| 00 | A beacon packet for a roll call from neighbor |
| | clients |
| 01 | “I'm alive!” Ping to server |
| 02 | Server ACK from 01 followed by one-way |
| | challenge |
| 03 | “I'm Alive!” Ping to client(s) |
| 04 | Client ACK from 03 followed by one-way |
| | challenge |
| 05 | ACK followed by one-way response to Server |
| | or Client 04 |
| 06 | One-way confirmation ACK from 05 from |
| | Server or Client |
| 07 | Ping to Server for route |
| 08 | ACK from 07 followed by route data |
| 09 | Ping to Client for route |
| 10 | ACK from 09 followed by route data |
| 11 | Signals 271 mode to clients |
| 12 | Signal to upstream clients to update routing |
| | table to add network of the client |
| 13 | Delete request from clients |
| 14 | Pseudo data packet |
| 15 | ACK from 14 |
| 16 | End of Freeze |

According to the CSMA/CA protocol, multiple ESSs may receive the LEO-issued 01 packet, while only one ESS will respond with a 02 packet. In this respect, the ESSs may implement a variant of multi-homing by maintaining multiple potential routes, yet without transporting any payload data. These multiple routes would in that case respectively correspond to each LEO the ESS has sent a 02 packet. Therefore, after initiation, each one-hop route between a given LEO and ESS has exchanged no payload data (actual packet data that follows the packet header and identifies the source and destination of the packet) with a TC.

In another aspect, TCs in the wireless network may maintain a table of known LEOs including several fields of information relating to each LEO it identifies overhead. First among these fields, the array of known LEOs may store each known LEO's network IP address. According to some embodiments, these addresses correspond to static IP, IPv4, or IPv6 addresses assigned to each node (TC, LEO, and ESS). Other possible embodiments, however, may assign addresses using non-static protocols such as, e.g., network address translation (NAT) or dynamic host control protocol (DHCP). The TC may maintain these addresses in a table of known satellite clients located in transient or non-volatile memory using any of a variety of possible data structures well known in the art, including, for example, a stack, a queue, an array, or a hash table. In addition, the table of known LEOs may further comprise a time stamp field, which specifies the moment in time that the TC first identified and obtained the address of a LEO passing overhead, and a response latency time field, a measure indicative of a LEO's overhead proximity to the TC. The response latency of a satellite client may be, for example, a measured round trip response time (RTRT).

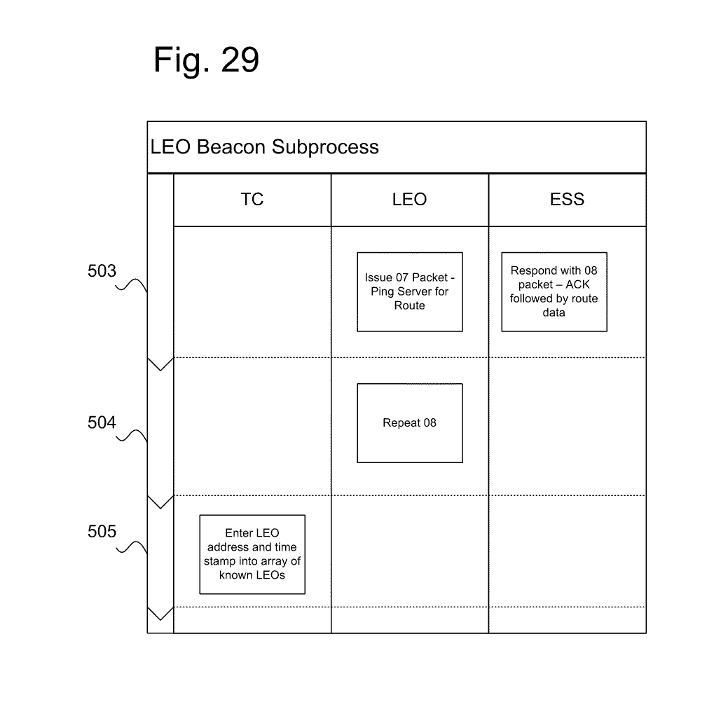

FIG. 29 illustrates an exemplary “LEO Beacon Subprocess,” another subprocess that may be implemented as part of the satellite-based route discovery process. By this subprocess, a TC discovers a LEO that has a one-hop route to an ESS and stores that LEO's address into its table of known LEOs. First, at a step 503, a LEO issues a 07 (ping to server for route) packet at short, random intervals. In response, an ESS with which the pinging LEO has a route responds with an 08 (ACK from 07 followed by route data). At a step 504, the LEO repeats the received 08 packet. And, finally, at a step 505, upon receiving the 08 packet, the TC reads the address contained in the 08 packet's payload data and enters the address in the TC's table of known LEOs along with a time stamp.

Accordingly, each execution of the LEO Beacon Subprocess creates an entry in a TC's table of known LEOs. When a TC's table of known LEO's is statistically full, the TC may then determine which, if any, address in the table represents a reliable temporary route through a LEO to an ESS. In this regard, a TC may treat its table of known LEOs as “statistically full” when, for example, it has identified a predetermined number of overhead, in-view LEDs. In the presently described exemplary embodiment operating in normal mode, a given TC expects three in-view LEOs during any given twenty-minute interval. Referring again to FIG. 26, for example, the TC 422 has three in-view LEOs 416a and 416b in its local plane, and 416d, in its adjacent, remote plane. It should be noted, however, that the predetermined number of LEOs that renders the table of known LEOs as statistically full, serves primarily as a trigger for a TC to check whether any of its known LEOs has a reliable TTL. Accordingly, the TC may be configured, in the alternative, to treat its table of known LEOs as being statistically full at a lesser or greater number, as desired.

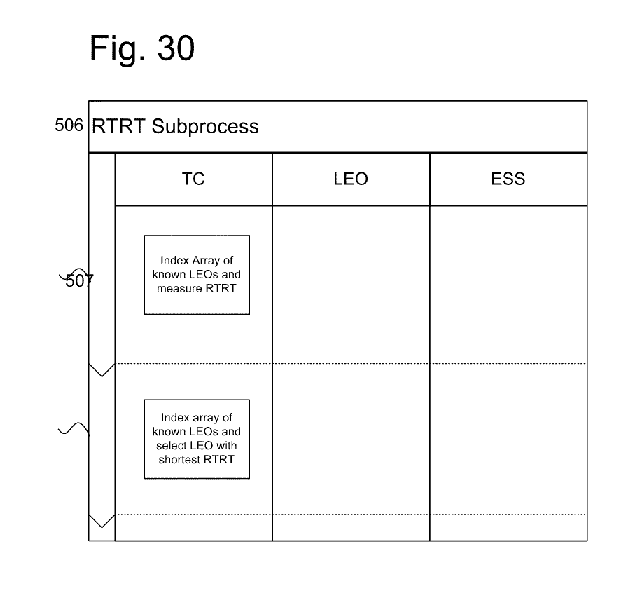

As described above, a TC will advantageously establish a two-hop route through a local-plane LEO for its property of having a predetermined, predictable reliable TTL. A TC may make this determination, in one aspect by performing the exemplary RTRT subprocess of FIG. 30. As illustrated in FIG. 30, at a step 506, the TC indexes its table of known LEOs and successively pings the address of each respective LEO, adding the round trip response time (RTRT) to the table of known LEOs for said LEO. In one aspect, the RTRT may be defined by the equation

$${T}_{RTRT} = \frac{2 D}{c} ,$$

wherein T_{RTRT} represents round-trip-response time, D represents a distance between the first satellite and the terrestrial client, and c represents the speed of light. It is noted, however, that RTRT may represent only one appropriate measure. Other embodiments may employ other, equally appropriate measures that correspond to the transmission latency between a TC and LEO. Subsequently, at a step 507, the TC indexes its table of known LEOs and selects the address of the LEO with the shortest RTRT based on the assumption, for example, that the LEO is most proximate overhead among all LEOs known to the TC. In the event that multiple LEOs register the same RTRT value, the TC may simply select the address of the LEO most recently indexed.

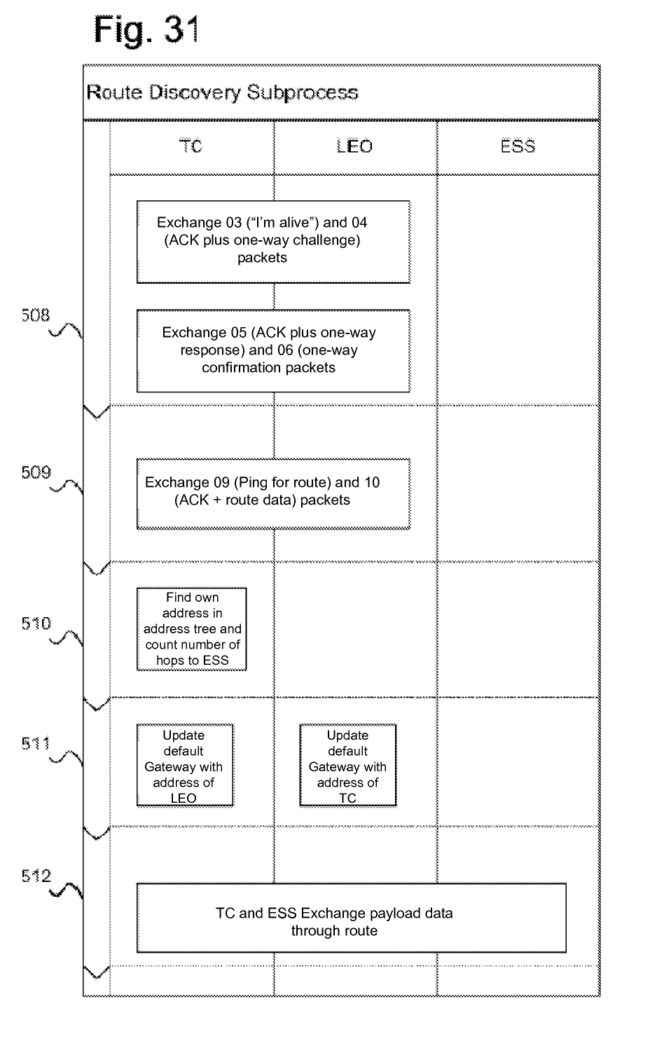

Having selected the LEO most proximately overhead, the TC may next perform a Route Discovery subprocess to build a temporary route to the ESS with which the selected LEO has a one-hop route. For example, FIG. 31 illustrates an exemplary Route Discovery Subprocess in more detail. The subprocess begins at step 508, in which the TC and LEO build a route between each other by exchanging 03 (I′m Alive! ping to client) and 04 packets and 05 and 06 (One-way confirmation ACK from 05) packets, respectively, where, for the purpose of authentication, the 04 packet from the LEO contains a seed that prompts the TC to perform a one-way transformation, which it returns in the 05 packet. At step 509, the TC and LEO then exchange 09 (ping to client for route) and 10 (ACK from 09 followed by route data) packets, respectively. As previously described, this route data contains a string representation of the tree maintained in the router memory of the ESS associated with the LEO.

Upon receiving the 10 packet, the TC converts the payload data string of the route to the discovered ESS into its own in-memory tree; at step 510, finds its own address in the tree; and counts the number of hops between its address and the address of the ESS at the top of the tree. Having obtained a temporary route to the LEO, at step 512, the TC then updates the default gateway in its routing table with the address of the LEO. Immediately thereafter, the TC may issue a 12 packet with its address as the payload data to the address of the LEO. Upon receiving the 12 packet, the LEO may add the network of the address of the TC as a new network in its TCP/IP routing table. Finally, the TC and ESS then exchange payload data through the route at step 512.

It should be noted that in at least the satellite-based wireless and sub-orbital aircraft (see description below) embodiments, the TC, LEO, and/or ESS may employ an on-board operating system operable to manage packet routing by maintaining routing tables. In some embodiments, for example, a Linux operating system may be used by configuring the system to maintain and manage Linux routing tables. In such embodiments, therefore, maintaining routing tables may obviate the need to include routing information within a packet header, as was described with respect other embodiments herein (see e.g., header 114 in FIG. 5a).

With a temporary route established, a TC may next attempt to discover a route through a LEO with a reliable TTL. When a newly-discovered LEO rises above the horizon, the TC does not know the LEO's longitude (whether said LEO is in a local orbital plane or a remote orbital plane). Referring back once again to FIG. 26, for example, LEOs 416a, 416b, and 416d, each represent an in-view LEO, but only LEOs 416a and 416b, liowever, travel in TC 422's local plane. The “local plane” refers to the orbital path most closely aligned relative to the longitude associated with a given TC, while “remote plane” refers to all other orbital paths within the constellation. The significance of a LEO's traveling in a local plane follows from the fact that a LEO in a TC's local plane has a predetermined, reliable TTL. As a result, once a TC has established a route through a local-plane LEO, it may preemptively execute a handoff as the LEO's TTL approaches expiration.

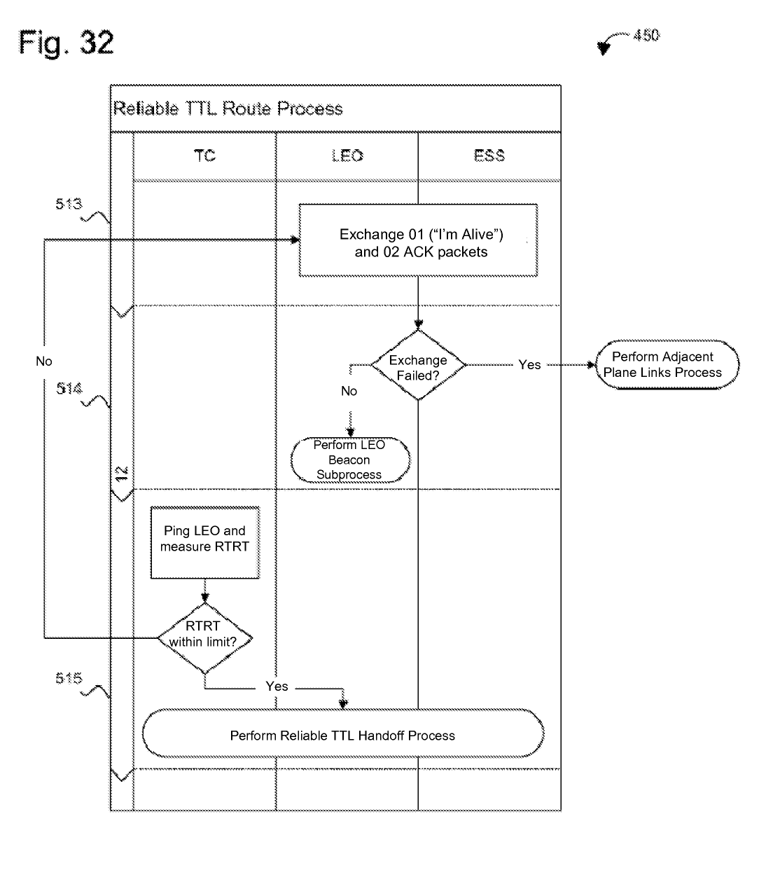

FIG. 32 depicts an exemplary Reliable TTL Process, which describes the procedure for determining whether a given LEO has a reliable TTL. For example, beginning at step 513, a new LEO rises above the horizon and issues a 01 packet, thereafter receiving in return 02 packet from an in-view ESS. At a step 514, the LEO then determines whether it received a 02 packet from an ESS. If not, the LEO has no ESS in view and the system may execute an Adjacent Plane Links Process, for example, as shown at 454 of FIG. 27 and described in more detail below. Otherwise, the LEO has a reliable route through which it may seek to obtain the address of a LEO by performing the LEO Beacon Subprocess.

Still referring to FIG. 32, at step 515, the TC may issue a ping to the newly discovered LEO during the RTRT subprocess, thereby measuring the LEO's RTRT. If the measured RTRT falls within a defined RTTL time limit, then the TC knows the LEO is within the TC's local plane, and the system may perform an RTTL Handoff Process, for example, as shown at 452 of FIG. 27. Alternatively, if the RTRT exceeds the defined RTTL time limit, then the LEO is in a remote plane and the TC may restart the process, for example, beginning at step 513.

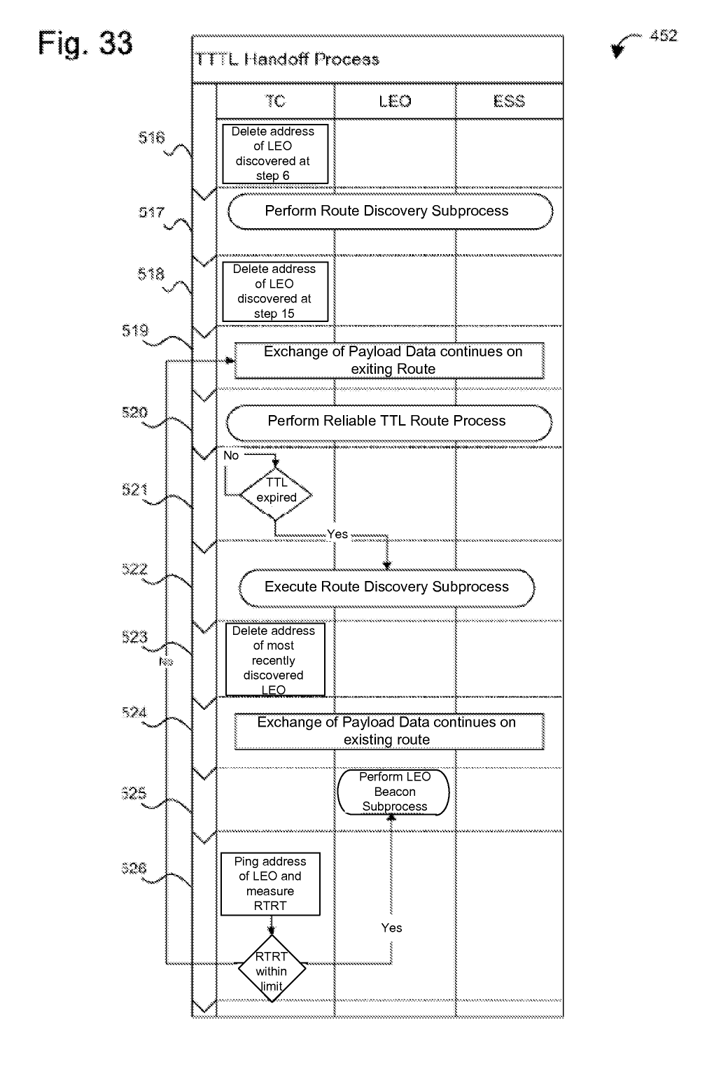

FIG. 33 depicts an exemplary Reliable TTL Handoff process, for example, as shown at 452 of FIG. 27. At this point, the TC has found a LEO transiting the horizon along a local orbital plane. Because the TC reliably knows the TTL of this LEO, it attempts to obtain a two-hop route through this LEO to an ESS and maintain the route until the predetermined reliable TTL approaches expiration, at which time the LEO will attempt to preemptively initiate a handoff to the next LEO rising above the horizon. Accordingly, at step 516, the TC may delete from its TC's table of known LEOs the address of the LEO discovered during the route discovery process at step 508. Next, at step 517, the TC may attempt to find the route to an ESS through the address of the LEO discovered at step 515 by, for example, executing the above-described exemplary Route Discovery Subprocess.

With the route through the TTL LEO established, the TC may then prepare for the next handoff, which the TC may preemptively initiate based on the approaching expiration of the predetermined reliable TTL. To prepare for the handoff, at step 518, the TC may delete from its table of known LEOs the address of the LEO discovered at step 517. Then, at step 519, exchange of payload data continues on the existing route and, at step 520, the TC performs the exemplary Reliable TTL Route Process 450.

When, at step 521, the TC determines the TTL of the existing route is approaching expiration, the TC executes, in step 522, a Route Discovery Subprocess to determine the address of the most recently discovered LEO. At step 523, the TC may then delete from its table of known LEOs the address of the LEO discovered most recently and, at a step 524, the exchange of payload data continues on the route discovered at step 520.

Still referring to FIG. 33 and with continuing reference to FIG. 27, at step 525, a new LEO rises above the horizon and performs a LEO beacon process. The TC then buffers the address of the newly transiting LEO and pings the address of the LEO and measures the RTRT at step 526. As before, if the measured RTRT falls within the RTTL time limit, the transiting LEO is within a local plane, and the TC may preemptively initiate a handoff when the TTL approaches expiration. If the RTRT exceeds the defined RTTL time limit, however, the LEO is not in a local plane and the system returns to step 525 and waits for the next LEO to rise above the horizon.

When operating in normal mode, a newly active TC joining the network acquires a route through a local-plane LEO. In this case, because the LEO has a one-hop route to an ESS, the route from TC to ESS contains a total of two hops. Furthermore, assuming all ESSs are operational, any given LEO has three ESSs in view: one to the north, to below it, and one to the south. A second and third ESS provide redundancy. In the unlikely event that all in-view ESSs of a LEO are inoperative, as may occur during a global, catastrophic event, for example, the LEO client may attempt repeatedly to route to a neighboring LEO in an adjacent plane until it acquires a route to an ESS. To accomplish this, the TC, the LEOs, and the ESSs may, according to some embodiments, perform the exemplary steps outline below. Meanwhile, the TC may continuously seek a two-hop route by performing step 510 of the exemplary route discovery subprocess.

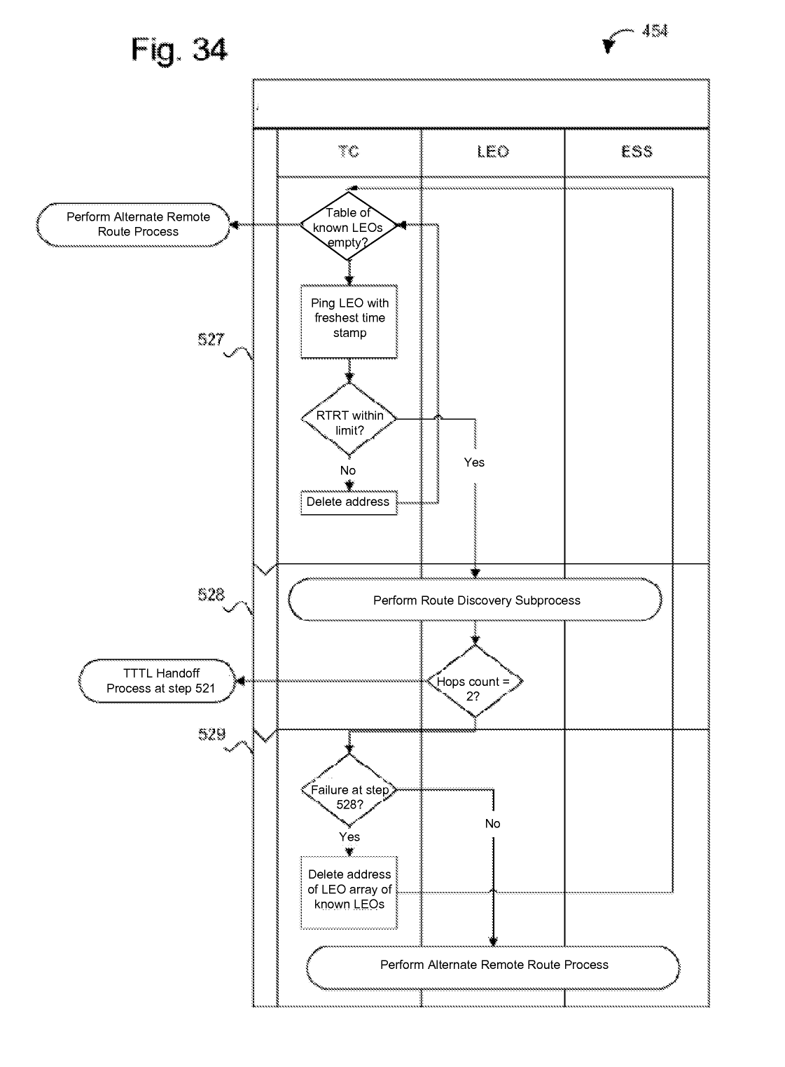

FIG. 34 outlines exemplary steps of an exemplary Adjacent Plane Links Process, for example, as shown at 454 of FIG. 27. Beginning at step 527, the TC selects from its table of known LEOs the address of the LEO with the freshest time stamp then pings the address and measures the RTRT. If the measured RTRT falls within a defined “adjacent link time limit,” then the TC deletes the address from the table and repeats step 527. If, on the other hand, the TC finds the table of known LEOs maximally indexed and therefore empty, then it may be an indication that a network breakdown has occurred (e.g., some LEOs in the constellation are not functioning properly). In such case, the TC may exit the Adjacent Plane Links Process, and the system may switch to survival mode, for example, by performing an alternate remote route process, for example as shown at 456 of FIG. 27.

Otherwise, at step 528, the TC has found an acceptable route through an adjacent-plane LEO, and the network may remain in normal mode. In such case, the TC may execute a Route Discovery Subprocess and build a route to an ESS through the LEO of the selected address. Then, if during the Route Discovery Subprocess the TC determines that the number of hops to the ESS equals 2, the TC has discovered a local-plane ESS. In that event, the TC then stops looking for a route through an adjacent plane and instead branches to step 521 of the TTTL handoff process. If the TC does not determine that the number of hops equals 2, however, then at step 529, the TC determines whether there was a failure during the Route Discovery Subprocess. If so, it is possible that the network breakdown remains unresolved, and the system may enter survival mode by performing an Alternate Remote Route Process 456.

In still another, the wireless network system may be configured to implement a survival mode, which may implement the following exemplary logic to maintain a virtual circuit in the event that some LEOs and some ESSs become unavailable, such as in a global catastrophic event.

For example, when the network enters survival mode by reaching an Alternate Remote Route Process, for example, as shown at 456 of FIG. 27, it may operate according to a routing scheme at least somewhat similar to that as described above for a terrestrial network. In survival mode, the TC may not know the TTL of a given current route. As a result, a TC may not be able to predictably determine how long a route will persist and therefore may not be able to preemptively initiate LEO handoffs. Moreover, survival mode may be further defined by the fact that some LEOs and/or some ESSs are not operational. If, however, as few as a single, surviving ESS on earth remains operational, and a critical number of surviving LEOs remain operational, then the TC may obtain a multi-hop route through the surviving LEOs to the operational ESS by performing the exemplary Alternate Remote Route Process 456 of FIG. 27.

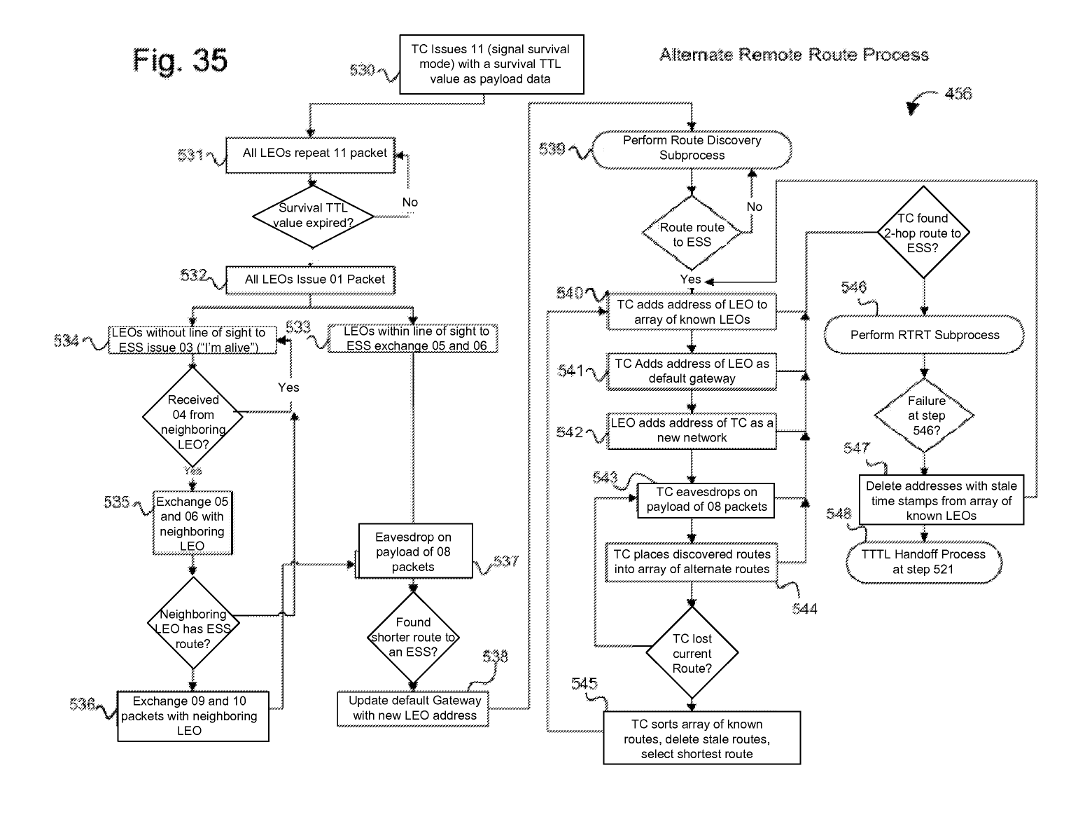

The exemplary Alternate Remote Route Process shown at 456 of FIG. 27, for example, illustrated in detail in FIG. 35, for example, beginning at step 530, the TC issues an 11 (signal survival mode) packet containing a survival TTL value as payload data. Next, at step 531, each LEO to receive the 11 packet repeats the packet recursively to neighboring LEOs until the TTL value expires. Upon expiration, all surviving LEOs in the constellation will have received the 11 packet. Accordingly, the survival TTL value should be set with a long enough duration to allow the packet to traverse the entire constellation. Then, at step 532, each surviving LEO issues a 01 packet. In response, at step 533, LEOs with line-of-sight to an ESS will receive from the ESS a 02 packet and then exchange with the ESS 05 and 06 packets for authentication. With this accomplished, these LEOs have established a one-hop path to an ESS.

Simultaneously, for example, each LEO that did not receive a responsive 02 packet (those without line of sight to an ESS) looks to find a route through a neighboring LEO. Accordingly, at step 534, each such LEO may issue a 03 packet repeatedly until it receives an 04 packet from a neighboring LEO. Upon receiving a responsive 04 packet from a neighboring LEO, at step 535, the LEO exchanges 05 and 06 packets with the neighboring LEO for authentication. If the neighboring LEO has an established multi-hop route to an ESS, then, at step 536, the LEO adds itself to the neighboring LEO's multi-hop route by exchanging 09 and 10 packets with the neighboring LEO at step 537. Otherwise, the LEO may loop back to step 534 and may retry, continuing to look for a route through a neighboring LEO.

At this point, the constellation of surviving LEOs and ESSs may approach a mesh. Meanwhile, at step 537, each LEO continually eavesdrops on the payload data of successive 08 packets from ESSs, which are repeated by LEOs above the ESSs. And, at step 538, if a LEO may find a shorter route to an ESS, the LEO may opportunistically adopt the shorter route from the payload data of the 08 packet to an ESS by updating its default gateway with the newly discovered LEO address. In this case, the LEO having just discovered a shorter route to an ESS may issue a 12 packet with its address as the payload data to the address of the newly discovered LEO. Upon receiving the 12 packet, the newly discovered LEO, which presents a shorter route to an ESS, may add the network of the address of the discovering LEO as a new network in its TCP/IP routing table.

Still referring to FIG. 35, in addition to all surviving LEOs receiving the 11 packet, which signals the network has entered survival mode, other TCs in the network receive the packet as well. Accordingly, all TCs in the network may perform the following steps to establish a first optimal route to an ESS. At step 539, the TC iteratively executes a Route Discovery Subprocess until discovering and building a multi-LEO-hop route to a surviving ESS. Once the TC finds a LEO with a route to an ESS, the TC at step 540, adds the address of the LEO to its table of known LEDs. Then, at step 541, the TC adds the address of said LEO to its TCP/IP routing table as its default gateway. Thereafter, the TC may issue a 12 packet with its address as its payload data to the address of the newly discovered LEO. Upon receiving the 12 packet at a step 542, the newly discovered LEO may then add the network of the address of said TC as a new network in its TCP/IP routing table. The TC then exchange payload data with the ESS. At step 543, the TC eavesdrops on payload data of successively received 08 packets from ESSs (repeated by LEOs overhead) and attempts to discover a second optimal route—a shorter route through one of the LEOs to the address of an ESS. When the entire constellation of LEOs temporarily has optimized to the shortest routes to ESSs, the TC, at step 544, places other discovered routes of equal or greater number of hops (compared to the current route), along with an accompanying time stamp in a table of alternate routes. For example, the TC may in one aspect maintain the table of alternate routes as an ordered stack.

When a TC suddenly loses its route, for example, as a result of a LEO dropping below the horizon, the TC, at step 545, indexes its table and deletes routes with stale time stamps. The TC may also sort the array of alternate routes in ascending order, according to the number of hops. When implemented as an ordered stack, for example, the TC may “pop” the “next best” route from the top of the stack. As noted before, the best route, in some embodiments, may be defined with consideration of additional factors. As referred to herein, however, the best route may correspond to the path with the fewest hops. At step 545, the TC may then select the alternate route from the array and then return to step 540.

If, at any of steps 539 through 545, the TC receives a 08 packet with payload data indicating a two-hop route to an in-plane or adjacent-plane ESS, the TC at step 545 may perform the exemplary RTRT Subprocess. If the TC successively executes the RTRT subprocess, then, at step 547, it indexes its array of known LEOs and deletes any address of a LEO in the array with a stale time stamp and then, at step 548, branches to step 521 of the Reliable TTL Handoff Process 452 of FIG. 27 and waits. Alternatively, if the RTRT subprocess fails, then the TC returns to step 540. Because a LEO may function as a repeater node in the network, it may in one aspect, advantageously implement the above-described dual wireless interface. The satellite 416 may receive uplink data transmissions from a terrestrial client on a repeater wireless interface, either of two satellite antennas. Preferably, the uplink and downlink frequencies may fall within the Ka-band, which is allocated internationally and capable of accommodating global broadband systems ranging from about 18 to about 40 GHz. For example, the satellite downlink frequencies may range from about 18.3 to about 18.8 GHz or from about 19.7 to about 20.2 GHz, while the uplink frequencies may transmit at about 30 GHz. By the exemplary methods described above, the client process may determine whether a packet is routed to an earth station server or to a neighboring satellite.

According to some embodiments processor on-board the LEO may run the Linux operating system, which maintains routing tables as described above. The software server program implemented on the earth station server and the client programs located on the LEO satellite and the terrestrial clients may be operable together via parallel processing to determine optimal routes by exchanging in-memory routing tree link information.

Transmissions to neighboring satellites may proceed over radio or laser intersatellite links (ISLs) 426. Further, each LEO may include of two RF interfaces, one on an uplink frequency and one on a downlink frequency-non-overlapping. The satellite required power output may range from, for example, about 50 to about 60 dbW, or from about 100 to about 1000 kW, for example, to overcome rain-induced attenuation associated with the high-frequencies transmissions in the Ka Band.

In still other embodiments, one or more mobile clients of a wireless network may be located on-board sub-orbital aircraft. For example, an aircraft may be equipped with a transceiver configured according to, for example, some embodiments of the present disclosure, and they may serve several desirable functions for facilitating broadband Internet access. For example, according to some embodiments, aircraft-based clients may serve as client routers for terrestrial clients, thereby permitting broadband Internet access to clients in locations where such service may not be otherwise available. In some embodiments, a wireless network path may include links between aircraft-based clients and LEO clients in order, for example, to reach an earth-station server. And, according to some embodiments, aircraft-based clients may serve as an extension of a LEO constellation by participating in a constellation-wide mesh, for example, when clients of a LEO constellation operate in survival mode.

According to a first exemplary embodiment, an aircraft-based transceiver may serve as a client router for a terrestrial client. This may be desirable because such example may make additional use of networking hardware in an aircraft equipped to provide passengers and/or crew with in-flight broadband Internet access (e.g., in-flight Wi-Fi access). In such embodiments, an aircraft may be outfitted with a transceiver and router to serve as a gateway to the Internet through an earth-station server. Possible transmission technologies for providing such wireless transmission between the aircraft and a server on the ground may include, for example, WiMAX (e.g., based on the IEEE 802.16 standard), 4G (also known as 3GPP Long Term Evolution), and CDMA (EV-DO RevA and EV-DO RevC).

To make additional use of the hardware in place for air-to-ground communications, a terrestrial client may route communications through an overhead aircraft configured as a client repeater to the Internet through an earth-station server. This may be accomplished by additionally configuring the aircraft's on-board transceivers to operate in client mode, for example, as described above with reference to FIGS. 14-21. Correspondingly, earth-station servers may be configured according to server processes, for example, as described above with reference to FIGS. 4-11. In this manner, a transceiver on board the aircraft may act as a client router on behalf of terrestrial clients, for example, in rural areas where high-speed Internet access may not be available through cable or DSL (Digital Subscriber Line).

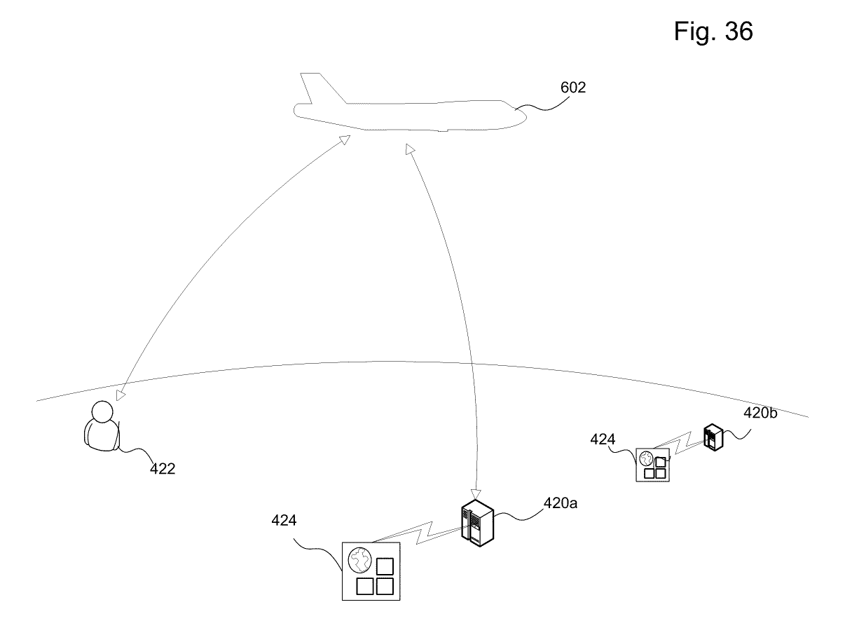

FIG. 36 illustrates an exemplary embodiment in which an aircraft-based client may serve as a router for a terrestrial client. As shown, a terrestrial client 422 may acquire a two-hop path to an earth-station server 420a through client network hardware located on board an aircraft 602. By, for example, the exemplary processes described herein, earth-station servers 420a and 420b may maintain in-memory tree link information about the known clients in the network. As the network topology changes due to, for example, an aircraft-based client moving out of range of a terrestrial client and/or an earth-station server, the route may adapt (e.g., automatically) in order to maintain a virtual circuit between both the terrestrial client and earth-station server.

As shown in FIG. 36, for example, as aircraft-based client 602 loses line of sight of earth station server 420a, it may come into range of earth-station server 420b and replace its air-to-ground transmission link with a link to server 420b. Similarly, by the same client and server processes, for example, client 422 may establish a two-hop transmission path through another aircraft-based client (not shown) as it passes within line of sight of overhead.

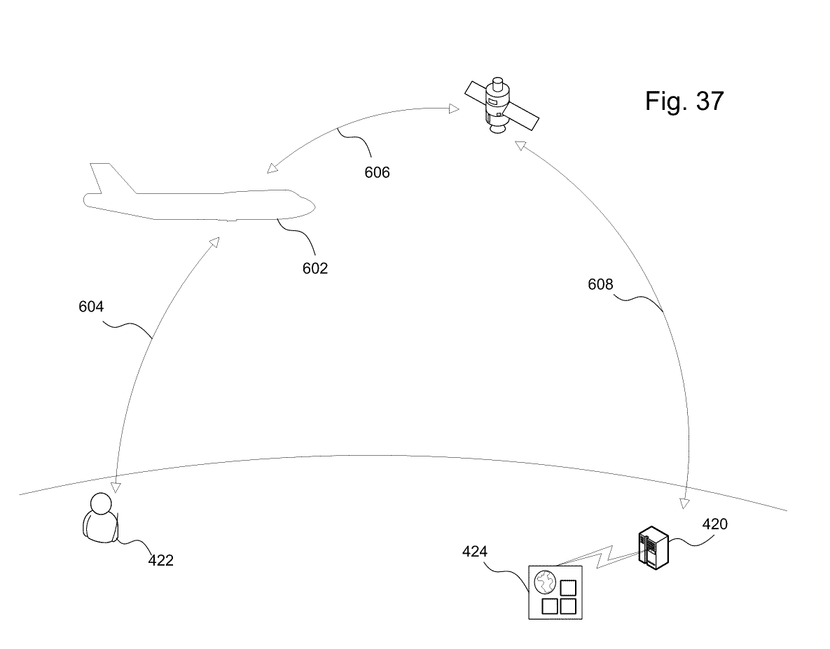

According to some embodiments, for example, the exemplary embodiment shown in FIG. 37, aircraft-based clients and LEO clients may together form a transmission link to an earth-station. For example, LEO clients, aircraft-based clients, and/or terrestrial clients may each be configured to operate in client mode according to, for example, the exemplary client processes described herein with reference to FIGS. 14-21. Accordingly, an aircraft-based client and a LEO client each may serve as nodes through which data transmissions may pass to reach an earth-station server. Moreover, data transmissions may be initiated from either terrestrial clients or from subscribers on-board an aircraft.

As shown in this example, a terrestrial client 422 may exchange data packets with an earth-station server 420 along the three-hop route comprising, for example, links 604 (terrestrial client 422 to aircraft-based client at 602), 606 (aircraft-based client at 602 to LEO), and 608 (LEO to earth station server 420). Such an exemplary transmission link may arise, for example, when an aircraft-based client does not have line of sight to an earth-station server, but is able to route indirectly through a LEO. Similarly, a subscriber on board an aircraft may exchange data packets with an earth station server along the two-hop route comprising, for example, links 606 (aircraft-based client at 602 to LEO) and 608 (LEO to earth station server 420).

According to some embodiments, aircraft-based clients may extend a distressed LEO constellation operating in survival mode. For example, an aircraft-based client router may be configured to operate as a client in survival mode, as described in FIGS. 27 and 35. By serving as one or more links along a transmission path between a terrestrial client and an earth station server, aircraft-based clients may participate in a constellation-wide mesh, for example, when one of the LEOs or earth station servers becomes inoperable, such that a reliable two-hop link through one LEO is not available or is unreliable.

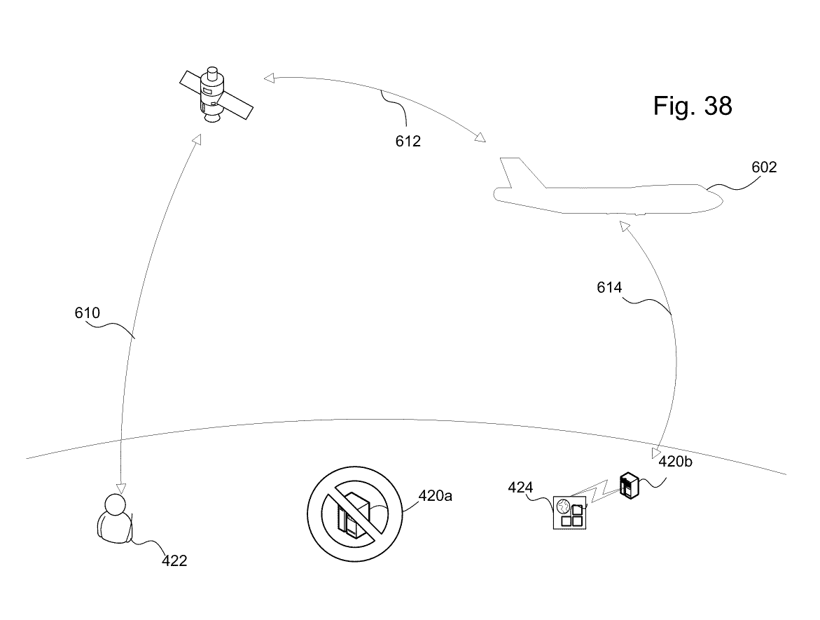

Referring to FIG. 38, for example, a two-hop link from terrestrial client 422 to earth station server 420a is unavailable or unreliable. As described above with regard to survival mode in a LEO constellation, for example, clients receiving packets signaling survival mode may cause a large portion of the network (e.g., the entire network) to approach a mesh. In this exemplary case, aircraft-based client 602, configured to operate in the same manner as a LEO client, may participate in the constellation-wide mesh by acting as a node between a second and third hop, 612 and 614 respectively, thereby forming a complete transmission path between the terrestrial client 422 and earth station server 420b.

It should be noted that providing broadband Internet access to aircraft passengers and/or crew is not a necessary component of the aircraft-based routing embodiments. Rather, it is mentioned merely for the possibility of simultaneously providing broadband access to subscribers on-board an aircraft and to terrestrial clients using pre-existing aircraft-based networking transmission and routing hardware.

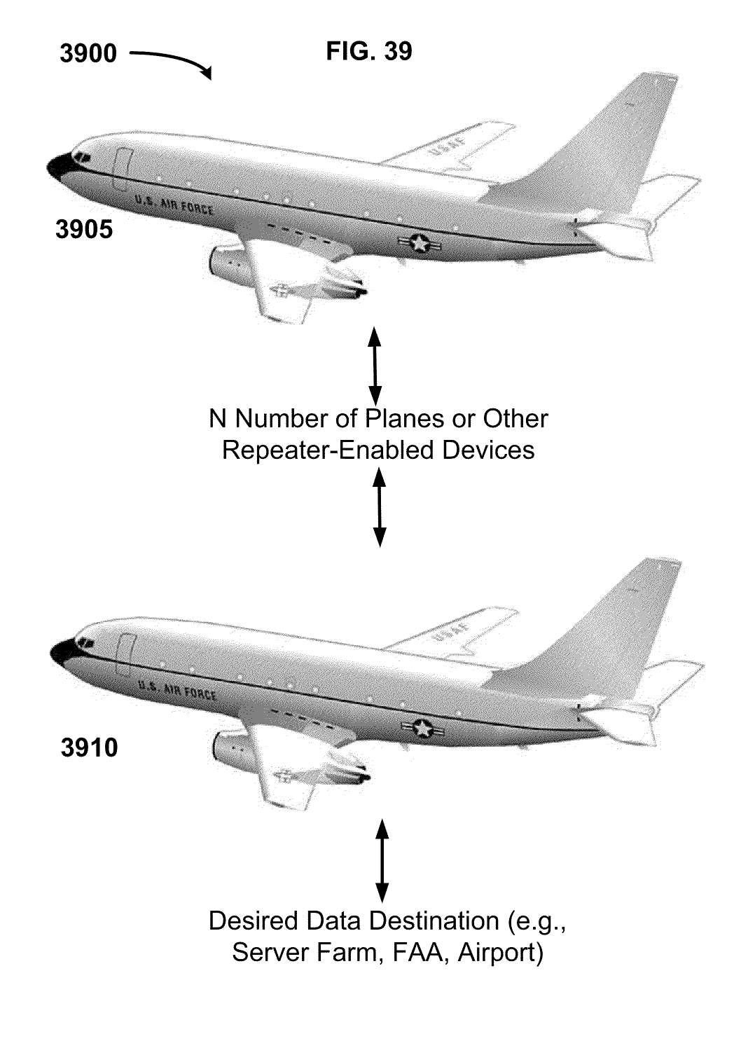

FIG. 39 graphically depicts data communications between airplanes in accordance with some embodiments of the present invention. Shown is a sample system 3900 that includes multiple planes 3905, 3910 and a desired data destination D. As illustrated, communication can occur between planes 3905, 3910. This enables, for example, plane 3905 to communicate with D via plane 3910. In some embodiments, there can be an N number of additional planes or other repeater enabled devices in a communication path. Thus, sample system 3900 can include many, many planes as necessary to form a communication path between a source and a destination. While not illustrated, it should be understood that a communication path from a source and destination may only include a single plane as a source and a desired destination with no intermediary planes. Also, reference herein may ascribe certain behaviors to planes 3905, 3910 and these behaviors also include communication equipment (e.g., client controllers, server controllers, transceivers) associated with or disposed within the planes 3905, 3910.

When contemplating data communication between planes, it can be useful to consider the planes as mobile communication nodes. In this manner, the communication nodes can communicate using the above described communication protocols. Data communications between airplanes can be done to communicate black box data from a source (e.g., an airplane sensor system or an airplane black box) to a destination (e.g., another airplane or a remote recording medium). This can aid in ensuring that black box data is not lost due to an airplane tragedy or a black box malfunction. Airplane flight data can be communicated from a source to a destination using aspects and features discussed above and below.

Given that the system 3900 involves using airplanes as communication nodes, the airplanes can be configured with RF communication equipment to enable data transmissions. Preferably the RF communication equipment (e.g., an RF transceiver) is coupled to a plane's black box (or other storage medium). As data is recorded and/or sensed, RF communication equipment can transmit data to an intended recipient, such as another airplane, repeater, or an intended destination. In some embodiments, a stationary repeater or destination can also serve as a server/controller node and monitor proximate mobile nodes. In other embodiments, mobile communication nodes (e.g., and airplane) can communicate with multiple server/controller modes during travel. In either of these manners, mobile communication nodes can continuously transmit or transmit as desired airplane black box data.

As mentioned above, the RF spectrum can be used as the means by which mobile airplane nodes communicate. The consideration here of spectrum is merely by way of example. A practical use of spectrum would be the ISM band 5.725-5.875 GHz. This band represents 150 contiguous megahertz of radio spectrum that would be ideal for CSMA/CA contention-based (wireless Ethernet) channel sharing protocols such as 802.11a.

Use of said spectrum would not only permit real-time one-way streaming of FDR and CVR to an ESS, but also would enable two way communication between an ESS and an aircraft. The 802.11a products operate at speeds of up to 54M bit/sec in the 5-GHz frequency band using orthogonal frequency division multiplexing (OFDM). This technology combats impairments such as multipath propagation, which can limit data rates. Wireless Interfaces in the ISM band can use “power control,” meaning they would not radiate any more power than required to maintain line of sight link to another node. Thus, when departing from or approaching land, an aircraft would not unduly interfere with terrestrial ISM transceivers in the 5.725-5.875 GHz band.

The theoretical advantages of routing TCP/IP packets from a given aircraft through a constellation of other in-flight aircraft to a ground-based server/gateway (ESS) and then to a recording server are many. The practical challenge, however, is to acquire and maintain a virtual circuit among a constellation of aircraft that take off, land, have varying velocities, and varying relative positions. Agile routing protocols as articulated herein enable an ESS to manage and oversee a network for planes used as mobile communication modes.

As currently contemplated, wireless interfaces of every aircraft and ESS shall have a TCP/IP address. The address may be assigned as a static address (either IPv4 or IPv6). Also, the address may be automatically assigned either via network address translation (NAT) or dynamic host control protocol (DHCP). As functions of time and cost, the location and number of ESSs may likely be phased in implementation. One key use for this invention in its earliest phase of implementation will be to prevent cost-effectively another Air France flight 447-type event where no one will ever know what caused the tragedy. A sample intelligent regulatory and business approach would be first to collocate ESSs at international airports that border large bodies of water.

Embodiments of the invention can be used and implemented in varying computer operating systems. For example, ESS and on-board processors may run the Linux operating system. The Linux OS can maintain routing tables as discussed above. In some embodiments, processors can run a non-Linux operating system (e.g., DOS) and use packet headers containing a route string in prefix notation as discussed above.

A key component in implementing embodiments of the invention used for wireless black boxes includes route discovery and route maintenance. As described in the '516 and '271 patents, client nodes and server nodes can implement a single transceiver and interface, or a single-wireless interface. One disadvantage of a single wireless interface may be a significant reduction in bandwidth per node in a transmission link. Specifically, transmitting data packets from a source node through one or more repeater nodes to a destination node may effectively reduce the bandwidth by one-half per node. As a consequence, for example, as applied to the widely used 802.11 interface, no more than three repeater nodes may be able to operate between a practical limit on the number of repeater nodes and, consequently, the number of hops between a source node and a destination node. So to enable maximum throughput, aircrafts are preferably be configured with dual wireless interfaces (as described in U.S. patent application Ser. No. 11/300,902).

To minimize possible single wireless interface limitation, servers and clients may, in some embodiments, implement dual wireless interfaces. Accordingly, at least some nodes may include a first source wireless interface and a second source wireless interface, one for receiving data packets and the other for simultaneously transmitting data packets. As indicated previously, a ‘node’ as used herein refers either to a client or a server. Where these nodes implement a hardware or software control that operates according to the conventions described below, this arrangement may allow a wireless network to achieve near 100% bandwidth through each repeater node. Accordingly, at least some examples of dual-wireless interfaces described herein may significantly reduce source node and destination node.

By definition, once an aircraft has taken off and is beyond a one-hop route with line of sight of to an ESS (if there had been one), then all newly discovered routes in said aircraft's network will be multi-hop until perhaps the aircraft approaches a landing runway. The route discovery solution is a fast, reliable and stable, process that is initiated by the aircraft after take-off, combined with a route maintenance process that is subsequently managed by Dynamic Forward Routing (“DFR”). Network operations will be described with reference to FIG. 39 and it should be understood that this description is only exemplary and done so to describe the agile routing protocols capable in wireless black box embodiments of the present invention.

At the beginning of flight, Aircraft 3905 issues an “I′m alive” packet (01) seeking in return an acknowledgement packet (02) from an ESS (such as Desired Data Destination D). If successful, Aircraft 3905 and the ESS can exchange one way response and confirmation packets (05 and 06) packets for authentication. The purpose of authentication is that payload data of the acknowledgment packet (05) from Aircraft 3905 to the ESS is that it is a seed that prompts the ESS to perform a one-way transformation to be returned in the payload data of a one-way confirmation packet (06). If successful, this enables a one-hop route between Aircraft 3905 and the ESS. Failure of this communication path, in some embodiments, can result in one or more retries or another desired number of retries.

If Aircraft 3905 does not establish communications with an ESS, Aircraft 3905 can issue an “I′m alive” packet (03) to neighboring aircraft (such as Aircraft 3910). The 03 packet seeks an acknowledgment packet (04) from a neighbor aircraft in flight. If successful, Aircraft 3905 and Aircraft 3910 can attempt to exchange one way response and confirmation packets (05 and 06) packets for authentication. The purpose of authenticating the payload data of the 05 packet from Aircraft 3910 is to provide a seed that prompts the ESS to perform a one-way transformation to be returned in the payload data of 06 packet, and, if successful, this enables a multi-hop route between Aircraft 3905 and an ESS (i.e., Aircraft 3905-Aircraft 3910-ESS).

It should be noted that with high-speed processors on board the respective aircraft and ESSs, new route discovery is fast enough such that the TCP/IP virtual circuit (the session) between a given aircraft and an ESS if already discovered remains unbroken. At this point in flight said aircraft has either a one-hop route to and ESS or a multi-hop mesh network route via DFR to an ESS through one or more neighboring aircrafts. Eventually as said aircraft approaches its destination it will have discovered successively shorter routes until it discovers a single-hop route to an ESS as it approaches its landing, it may perform a single-hop route discovery sub-routine at, and subsequently, if all is well, land and may exit the network.3

Embodiments of the present invention can also implement additional activities for network communication. For example, Aircraft 3905 can determine that it is in flight in order to begin transmitting black box or other recorded data. If in flight, Aircraft 3905 can examine headers of packets transmitted by neighboring aircraft and determines addresses of a sending aircraft neighbor. Monitoring Aircraft 3905 can look up a neighbor's sending aircraft's address in its table of neighbor aircraft. This lets the Aircraft 3905 determine the identify of its neighbors for data transmission.

If Aircraft 3905 determines it is not in flight, then it can continue to monitor flight status and at the appropriate time initiate protocol activity to enable a wireless black box communication system as described herein. During implementation of network activity, Aircraft 3905 periodically determines whether it remains in flight and if so, it continues to carry out network communication activity. In this manner, an aircraft can be configured to only carry out network communication during flight.

In wireless networks, a classic issue is the non-zero probability that a route between a client node and a server node may be broken. This necessitates a periodic hello from one node to another to obtain a meaningful response from the node receiving the hello. Periodically one node will issue said hello. The periodicity, N, is directionally proportional to the number of nodes in the network, so that the network is not flooded with hellos (as described below). The larger the number of nodes, the more likely any given node will confirm that its route is unbroken, as follows:
Aircraft 3905 initiates a hello cycle starting at 0 seconds for a period of N seconds.
Within said period Aircraft 3905 will probably receive a 08 packet from an ESS (e.g., Desired Data Destination D) in response to a 07 packet from Aircraft 3910 whose cycle is exhausted.
If successful, Aircraft 3905 effectively eavesdrops on a 08 packet initiated with a 07 packet from Aircraft 3910.
Aircraft 3905 issues a 09 packet to the address of the 08 packet that returns its route in prefix notation via the payload, data of a 10 packet to Aircraft 3910.
Aircraft 3905 adds its address as a sibling to the address in said 10 packet prefix notation and sends said prefix notation to said ESS along with an update command.
At this point in flight, Aircraft 3905 maintains a multi hop route to an ESS. It also has maintained a table of neighbor aircraft. After doing this, Aircraft 3905 determines whether or not it remains in flight as a precursor for carrying out any additional network activity.

If Aircraft 3905 fails to receive a packet from Aircraft 3910, for a variety of reasons, such as a neighbor aircraft on said aircraft's route landing and, thus, abandoning its routing function, or said aircraft losing line of sight to its default gateway routing neighbor aircraft, said aircraft may have ceased to maintain a route to an ESS. Accordingly, said cycle period progresses to N seconds and Aircraft 3905 issues a 07 packet. If Aircraft 3905 receives a 08 packet from an ESS or repeated from a neighbor aircraft, then Aircraft 3905 examines the prefix notation in the payload data of the 08 packet for its own address. If this communication is successful, Aircraft 3905 determines whether or not it remains in flight as a precursor for carrying out any additional network activity.

If this communication attempts is not successful, Aircraft 3905 converts its table of neighbor aircraft to an array, and sorts the array in order of the fewest number of hops between the respective addresses and associated ESSs. Aircraft 3905 indexes the array, and seeking an acknowledgement packet (10) sends a ping packet (09) to the next address. If Aircraft 3905 receives an acknowledgment packet from a neighbor, Aircraft 3905 adds the newly found neighbor aircraft as a sibling and also sends the updated information to the ESS. If Aircraft 3905 fails to receive an acknowledgement packet (10), then the next array address is queried and this action is continued until Aircraft 3905 receives a ping acknowledgement from a neighbor aircraft. Upon receiving update information from a Aircraft 3905, the ESS replaces in its routing tree the address of the acknowledged packet with sub-tree information. Then Aircraft 3905 converts its address array back to a table. Then Aircraft 3905 determine whether it is still in flight or not. If in flight, Aircraft 3905 continues network operations as described above and if not in flight, network operations cease until otherwise instructed to initiate again.

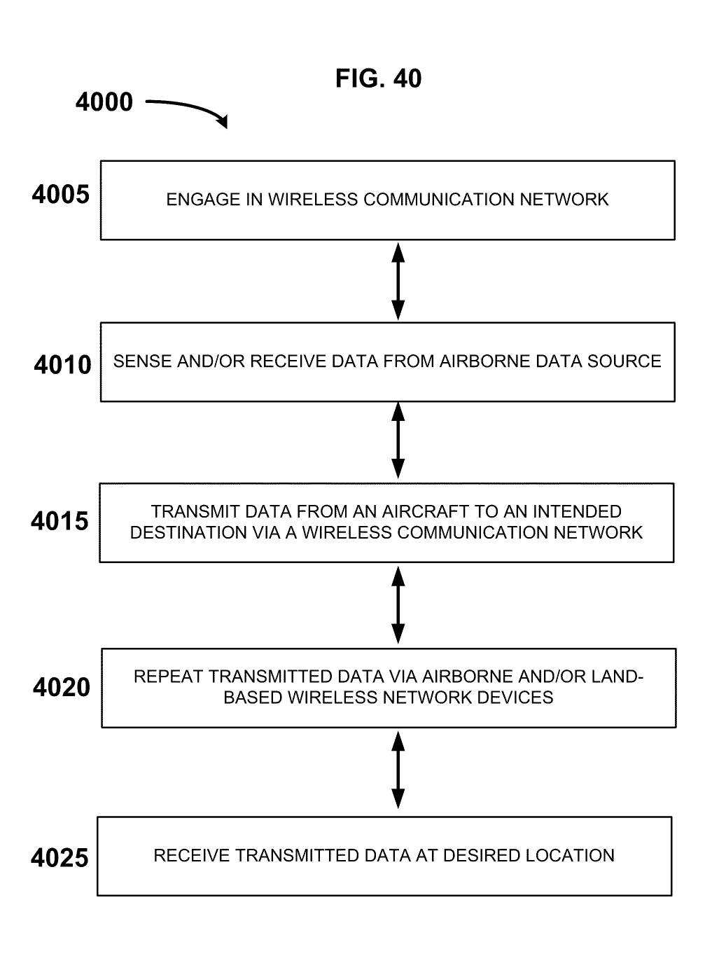

FIG. 40 illustrates a logical flow chart 40 that provides an algorithm/method 4000 of data communications between airplanes in accordance with some embodiments of the present invention. The method 4000 summarizes the above discussed cyclical protocol that embodiments of the present invention can implement. The method 4000 can be carried out by communications equipment and device situated within an airplane (or other moving vehicle). While currently preferred embodiments use a land-based server it may also be desired to have sea-based or mobile server nodes in some embodiments. In addition, some embodiments can include logic capable of implement the method shown in FIG. 40. The algorithm 4000 can initiates at 4005 with a plane engaging with or entering a wireless communication network. Typically, this may involve determining whether the plane is airborne or about to land. Once airborne, a plane can continue to monitor its airborne status to determine whether or not communication equipment should be monitoring for airborne neighbors to transmit black-box data to one or more intended recipients.

While airborne, the algorithm 4000 can sense and receive data from data sources, including airborne and non-airborne. The data can be sensed and received via dual wireless interfaces as discussed above. By receiving and transmitting data, airplanes can communicate with neighboring aircraft for the purpose of routing data to an intended recipient as shown at 4015. A plane receiving data intended for it can process the data as described above. A plane can also repeat transmitted data once it determines the date is intended for another recipient as shown at 4020. This multi-hop feature enables a plane located remote from an intended destination to transmit data to the intended destination so that data can received at desired locations as shown at 4025.

Other embodiments will be apparent to those skilled in the art from consideration of the specification and practice of the exemplary embodiments disclosed herein. It is intended that the specification and examples be considered as exemplary only, with a true scope and spirit of the invention being indicated by the following claims. In particular, the exemplary satellite-based wireless network routing system described herein may apply to several possible configurations or constellations and does not imply any requisite number or arrangement of satellites. Furthermore, though this disclosure seeks to provide, among other things, improved methods and systems for routing TCP/IP data packets, it may equally apply to other transmission protocols.

What is claimed is:

1. A wireless network system comprising:
an earth-station server configured to receive and transmit data packets to one or more of a plurality of mobile, airborne communication nodes, the plurality of mobile, airborne communication nodes comprising a first airborne client and a second airborne client;
at least one processor associated with at least one of the earth-station server, the first airborne client, the second airborne client, and the earth-station server, wherein the at least one processor is configured to:
establish one or more temporary communication routes between the first airborne client, the second airborne client, and the earth-station server, and as positions of the first airborne client and the second airborne client change, establish other temporary communication routes between the first airborne client, the second airborne client, and the earth-station server.

2. The system of claim 1, wherein the at least one processor is configured to determine a first alternative route via the plurality of satellite clients by exchanging in-memory routing tree link information.

3. The system of claim 1, wherein the at least one processor is configured to maintain a table of alternate routes comprising at least one newly discovered route.

4. The system of claim 1, wherein the at least one processor is configured to analyze at least one of the data packets to determine if the at least one data packet has been sent on a second alternative route unknown to a respective one of the first airborne client, the second airborne client, and the earth-station server.

5. The system of claim 1, wherein the at least one processor is configured to count a number of hops between a source node associated with the at least one data packet and a respective one of the first airborne client, the second airborne client, and the earth-station server.

6. The system of claim 1, wherein the at least one processor is configured to sort the table of alternate routes and replace the first alternative route with the second alternative route when a respective one of the first airborne client, the second airborne client, and the earth-station server loses the first alternative route.

7. The system of claim 1, wherein the first airborne client and the second airborne client are airplanes.

8. A wireless black-box flight recorder network system comprising:
an earth-station server configured to transmit and receive wireless data messages, the earth-station server coupled to a storage medium for storing data recorded about an aircraft;
and a plurality of aircraft based clients each comprising a device to receive aircraft data and each comprising a client controller configured to implement a client process, wherein the client process of at least one of the aircraft based clients selects a transmission path to the earth-station server that is an indirect link to the earth-station server through at least one of the other aircraft based clients, and wherein the indirect link is used to transmit aircraft data to the earth-station server for storing said data in the storage medium.

9. The system of claim 8, wherein the earth-station server comprises a digital controller configured to maintain a map of data packet transmission paths of the plurality of aircraft based clients.

10. The system of claim 8, wherein the aircraft-based clients and earth-station server are configured to perform wireless transmission of data using at least one of WiMAX, 4G, and CMDA.

11. The system of claim 8, wherein the client controller associated with at least one of the aircraft-based clients serves as an in-flight router configure to route data messages to the earth-station server and other of the aircraft-based clients.

12. A wireless network system for serving as a system to transmit, receive, and store data associated with aircraft client including data recorded on airplanes indicative of airplane performance and operation, the wireless network system comprising:
an earth station server comprising a first node controller and a first node transceiver, said first node controller implementing a first node process that includes controlling said first node transceiver, said first node process including receiving and transmitting data packets via said first node radio transceiver;
a plurality of mobile-airborne-second nodes each including a second node controller and a second node radio transceiver, said second node controller implementing a second node process that includes controlling of said second node radio transceiver, said second node process including receiving and transmitting data packets via said second node radio transceiver, wherein said second node process of each of said second nodes includes selecting a data transmission path to said earth station server that is direct or through at least one of the remainder of said plurality of mobile-airborne-second nodes; and
wherein said selected path to said earth station server utilizes the least number of other mobile-airborne-second nodes, such that said transmission path from each of said mobile-airborne-second nodes to said earth station server is optimized and the first node controller approves changes to the selected transmission path.

13. The wireless network system of claim 12, wherein each of the mobile-airborne-second nodes is disposed within an airplane and comprises a data device configured to receive data about airplane performance and operation and provide the data to the second node radio transceiver.

14. The wireless network system of claim 12, wherein each of the mobile-airborne-second nodes, when implementing said second node process, continues to determine whether the mobile-airborne-second node is airborne.

15. The wireless network system of claim 12, wherein the earth station server is located proximate a body of water and comprises a plurality of data servers for storing information about a plurality of planes.

16. A wireless network system for serving as a system to transmit, receive, and store data associated with aircraft client including data recorded on airplanes indicative of airplane performance and operation, the wireless network system comprising:
a first server node including a first node controller and a first node radio modem, said first node controller implementing a first node process that includes controlling of said first node radio modem, said first node process including receiving and transmitting data packets via said first node radio modem;
a plurality of second nodes each including a second node controller implementing a second node process that includes controlling a second node radio modem, said second node process including receiving and transmitting data packets via said second node radio modem, wherein said second node process of each of said second nodes includes initiating a radio transmission path to said first node that is a link to said first node through at least one of the remainder of said plurality of second nodes; and
wherein said first node process dynamically updates a second node link tree comprising second node link entries and dynamically modifies the second node link tree so that the data packet transmission from the first node is optimized.

17. The system of claim 16, wherein at least one of the second nodes is an airplane communication device and said first node process further comprises:
logic for comparing a selected link from one of the plurality of said second nodes to said first node to a current second node link entry in said second node link tree; and
logic for dynamically updating said second node link tree when said comparison meets predetermined conditions.

18. The system of claim 17, wherein said first node process further comprises:
logic for determining if one of the plurality of said second nodes is authentic;
logic for determining if one of the plurality of said second nodes is already in said second node link tree if one of the plurality of said second nodes is determined to be authentic; and
logic for inserting one of the plurality of said second nodes in said second node link tree if one of the plurality of said second nodes is authentic and is not already in said second node link tree.

19. A method for receiving and/or recording data about a plurality of airplanes to ensure that airplane operation and performance data is maintained, the method comprising:
providing an earth-station server node implementing a first node process including receiving and sending data packets via RF transmissions;
providing a plurality of second airborne-based nodes, each second airborne-based node providing a second node process including sending and receiving data packet via RF transmission, maintaining a send/receive data buffer in digital memory, and selecting a transmission path to said first node that is one of a direct link to said first node and an indirect link to said first node through at least one of the remainder of said plurality of second airborne-based nodes based upon path data determined through a pooning process; and
maintaining a second node link tree having second node link entries at one of the earth-station server node or second airborne-based node.

20. The method of claim 19, the first node process further comprising:
comparing a selected link from one of the plurality of said second airborne-based nodes to said earth-station server node to a second node link entry in said second node link tree; and
dynamically updating said second node link tree when said comparison meets at least one of several predetermined conditions.

21. The method of claim 19, the first node process further comprising:
determining if one of the plurality of said second airborne-based nodes is authentic;
deleting one of the plurality of said second airborne-based nodes from said second node link tree if one of the plurality of said second airborne-based nodes is already in said second node link tree; and
inserting one of the plurality of said second airborne-based nodes in said second node tree if said second node is authentic.

22. The method of claim 19, further configuring the earth-station server node as a gateway to transmit and receive data messages to another network enabling airplane operation and performance data to be transmitted via said another network.

23. An airplane-client node in a network, the network including an earth-station server node having a server radio modem and a server controller which implements a server process that includes controlling the server node to receive and transmit data packets via said server node to other nodes in the network, the airplane-client node comprising:
a client node radio modem; a client node controller;
said client node controller implementing a process including receiving and transmitting data packets via said client modem; and
selecting a radio transmission path to said server node that is one of a direct link to said server node and an indirect link to said server node through at least one other client node and;
implementing a process to update said radio transmission path in response to transmission path data and authorization to update the path received from said server node.

24. The airplane-client node of claim 23, wherein said transmission path data is chosen from the group comprising data identifying:
a path to said server node through the minimum number of client nodes;
a path to the server node through the most robust additional client nodes;
a path to the server node through the client node with the least amount of traffic; and
a path to the server node through the fastest client nodes.

25. The airplane-client node of claim 23, further comprising components to receive data about an airplane's operation and performance, said components coupled to the client node controller to enable the client node radio modem to transmit airplane related data to an intended recipient.
